(19) United States
(12) Patent Application Publication
(10) Pub. No.: US 2024/0262086 A1
(43) Pub. Date: Aug. 8, 2024

(54) INSULATED CONTAINER AND METHOD OF MAKING THE SAME

(71) Applicant: Berry Global, Inc., Evansville, IN (US)

(72) Inventors: Anvit GUPTA, Evansville, IN (US); John B. EULER, Evansville, IN (US); Christopher M. BOLEK, Evansville, IN (US)

(21) Appl. No.: 18/635,727

(22) Filed: Apr. 15, 2024

Related U.S. Application Data
(63) Continuation of application No. 17/410,386, filed on Aug. 24, 2021.
(60) Provisional application No. 63/070,361, filed on Aug. 26, 2020.

(51) Int. Cl. B32B 27/06; B32B 5/18; B32B 27/08; B32B 27/32

(52) U.S. Cl. CPC B32B 27/065; B32B 5/18; B32B 27/08; B32B 27/32; B32B 2250/03; B32B 2250/242; B32B 2266/025; B32B 2270/00; B32B 2272/00; B32B 2307/304; B32B 2307/4026; B32B 2439/02; B32B 2439/70

(57) ABSTRACT

A multi-layer sheet includes a polymeric foamed material, a polymeric-lamination layer, and a film. The polymer-lamination layer is extrusion laminated onto the polymeric foam.

### PRIORITY CLAIM

This application is a Continuation of U.S. patent application Ser. No. 17/410,386, filed Aug. 24, 2021, which claims priority under 35 U.S.C. § 119(e) to U.S. Provisional Application Ser. No. 63/070,361, filed Aug. 26, 2020, each of which is expressly incorporated by reference herein.

### BACKGROUND

The present disclosure relates to polymeric materials that can be formed to produce a container, and in particular, polymeric materials that insulate. More particularly, the present disclosure relates to polymer-based formulations that can be formed to produce an insulated non-aromatic polymeric material.

### SUMMARY

According to the present disclosure, a polymeric material comprises an insulative cellular non-aromatic material.

In illustrative embodiments, the polymeric material includes a polymeric lamination layer and a film layer. In some embodiments, the polymeric-lamination layer is extruded onto the insulative cellular non-aromatic polymeric material. In some embodiments, the polymeric material is formed by an extrusion lamination process.

In some embodiments, the polymeric material comprises a polyethylene. In some embodiments, each of the insulative cellular non-aromatic material, the polymeric-lamination layer, and the film layer comprise polyethylene.

In some embodiments, the polymeric material is used to form a container such as a beverage cup. In some embodiments, the cup gains minimal weight when filled with a cold liquid and subsequently exposed to a humid environment.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a diagrammatic and perspective view of a cup-forming process in accordance with the present disclosure showing that the cup-forming process includes, from left to right, extruding an insulative cellular non-aromatic polymeric material, extruding a polymeric-lamination layer between the insulative cellular non-aromatic polymeric and a film layer to form a multi-layer sheet, forming a cup blank from the multi-layer sheet, forming a cup from the cup blank, and regrinding the scrap from the blank-forming process to be used in the extruding step;

FIG. 2 is a diagrammatic and perspective view of a material-forming process in accordance with the present disclosure showing that the material-forming process includes, from left to right, a formulation of an insulative cellular non-aromatic polymeric material being placed into a hopper that is fed into a first extrusion zone of a first extruder where heat and pressure are applied to form molten resin and showing that a blowing agent is injected into the molten resin to form an extrusion resin mixture that is fed into a second extrusion zone of a second extruder where the extrusion resin mixture exits and expands to form an extrudate which is slit to form a strip of insulative cellular non-aromatic polymeric material;

FIGS. 3A-3B are diagrammatic views of a laminated sheet formed during the cup-forming process of FIG. 1;

FIG. 3A shows the film layer located between an ink layer and the polymer-lamination layer;

FIG. 3B shows the ink layer located between the film layer and the polymer-lamination layer;

FIGS. 4-10 are illustrative various processes in accordance with the present disclosure for forming an insulative cup made of a multi-layer sheet comprising a skin including artwork laminated onto a strip of insulative cellular non-aromatic material;

FIG. 4 is a perspective and diagrammatic view of a first embodiment of a container-manufacturing process in accordance with the present disclosure showing that process comprises the stages of extruding an insulative cellular non-aromatic polymeric sheet as suggested in detail in FIG. 2, extruding a film sheet, printing on the film sheet to form a printed-film sheet, laminating the printed-film sheet to the insulative cellular non-aromatic polymeric sheet to form a laminated sheet as suggested in detail in FIG. 5, and forming an insulated cup from the laminated sheet as suggested in detail in FIG. 7;

FIG. 5 is a perspective and diagrammatic view of the cup-forming stage of the cup-manufacturing process of FIG. 1 showing that the cup-forming stage includes the steps of providing a laminated roll of the sheet, forming an insulative cup as suggested in detail in FIGS. 5-8, and packaging stacks of insulative cups as suggested in detail in FIG. 9 and showing that forming an insulative cup includes the steps of forming a body blank as suggested in detail in FIG. 6, annealing the body blank, forming a cup base as suggested in detail in FIG. 7, and forming a rolled brim as suggested in detail in FIG. 8;

FIG. 6 is a perspective and diagrammatic view of the body blank forming step showing that the body blank forming step includes the steps of loading the laminated roll to provide the sheet, annealing the sheet, compressing the sheet to form a compressed sheet, cutting the compressed sheet to form body blanks and scrap, collecting scrap, and accumulating the body blanks to form body blank stacks;

FIG. 7 is a perspective and diagrammatic view of the cup-base forming step showing that the cup-base forming step includes the steps of loading body blank stacks, heating the body blank, wrapping the body blank around a mandrel, forming a body, loading another laminated roll to provide the laminated sheet, cutting the laminated sheet to provide floor blanks and scrap, shaping the floor blanks into a floor, heating the floor, heating the body, wrapping the body around the floor, and coupling the floor to the base to establish a cup body;

FIG. 8 is a perspective and diagrammatic view of the brim-forming step showing that the brim-forming step includes the steps of transferring the cup base to a brim-forming machine, optionally lubricating the top portion of the base, heating the top portion of the base, and curling the top portion of the base to form an insulative cup having a rolled brim;

FIG. 9 is a perspective and diagrammatic view of the cup-packaging step showing that the cup-packaging step includes the steps of inspecting the insulative cup for leaks, accumulating the good cups to form stacks of insulative cups, and packaging the stacks of insulative cups for storage and transportation;

FIG. 10 is a perspective and diagrammatic view of another embodiment of a strip-forming stage in accordance with the present disclosure showing the extruding stage in which two strips of insulative cellular non-aromatic polymeric material are formed using a tandem extrusion setup;

FIG. 11 is an enlarged sectional view of a first embodiment of a sheet in accordance with the present disclosure made using the process shown in FIGS. 4-9, showing that the sheet includes, from top to bottom, a skin including a film layer and an ink layer, a polymeric-lamination layer, and the strip of insulative cellular non-aromatic polymeric material;

FIG. 12 is a view similar to FIG. 11 showing another embodiment of a sheet in accordance with the present disclosure wherein the sheet includes, from top to bottom, an outer skin including an ink layer and a film layer, a polymeric-lamination layer, and a strip of insulative cellular non-aromatic polymeric material, and an inner skin including an ink layer and a film layer;

FIG. 13 is a perspective view of an insulative cup made from a strip of material including the insulative cellular non-aromatic polymeric material made using the cup-manufacturing process shown in FIGS. 4-9 showing that the insulative cup includes a body and a floor and showing that four regions of the body have been broken away to reveal localized areas of plastic deformation that provide for increased density in those areas while maintaining a predetermined insulative characteristic in the body;

FIG. 14 is an enlarged sectional view of a portion of a side wall included in the body of the insulative cup of FIG. 13 showing that the side wall is made from the sheet that includes, from left to right, the skin including the film layer and the ink layer, a polymeric-lamination layer, and the strip of insulative cellular non-aromatic polymeric material;

FIG. 15 is an exploded assembly view of the insulative cup of FIG. 13 showing that the insulative cup includes, from top to bottom, the floor and the body including a rolled brim, the side wall, and a floor mount configured to interconnect the floor and the side wall as shown in FIG. 13;

FIG. 16 is a sectional view taken along line 16-16 of FIG. 13 showing that the side wall included in the body of the insulative cup includes a generally uniform thickness and that the floor is coupled to the floor mount included in the body;

FIGS. 17-20 are a series views showing first, second, third, and fourth regions of the insulative cup of FIG. 13 and that each include localized plastic deformation;

FIG. 17 is a partial section view taken along line 16-16 of FIG. 13 showing the first region is in the side wall of the body;

FIG. 18 is a partial section view taken along line 16-16 of FIG. 13 showing the second region is in the rolled brim of the body;

FIG. 19 is a partial section view taken along line 16-16 of FIG. 13 showing the third region is in a connecting web included in the floor mount of the body;

FIG. 20 is a partial section view taken along line 16-16 of FIG. 13 showing the fourth region is in a web-support ring included in the floor mount of the body;

FIG. 21 is a diagrammatic and perspective view of a cup-forming process in accordance with the present disclosure showing that the cup-forming process includes, from left to right, extruding an insulative-cellular non-aromatic polymeric material, extruding a polymeric-lamination layer between the insulative-cellular non-aromatic polymeric and a film layer to form a multi-layer sheet, forming a cup blank from the multi-layer sheet, forming a cup from the cup blank, and regrinding the scrap from the blank forming process to be used in the extruding step;

FIG. 22 is a diagrammatic and perspective view of a material-forming process in accordance with the present disclosure showing that the material-forming process includes, from left to right, a formulation of insulative cellular non-aromatic polymeric material being placed into a hopper that is fed into a first extrusion zone of a first extruder where heat and pressure are applied to form molten resin and showing that a blowing agent is injected into the molten resin to form an extrusion resin mixture that is fed into a second extrusion zone of a second extruder where the extrusion resin mixture exits and expands to form an extrudate which is slit to form a strip of insulative cellular non-aromatic polymeric material;

FIGS. 23A-23B are diagrammatic views of a laminated sheet formed during the cup-forming process of FIG. 21;

FIG. 23A shows the film layer located between an ink layer and the polymer-lamination layer;

FIG. 23B shows the ink layer located between the film layer and the polymer-lamination layer;

FIG. 24 is a perspective view of an insulative cup in accordance with the present disclosure showing that the insulative cup includes a body and a floor and showing that four regions of the body include localized areas of plastic deformation that provide for increased density in those areas while maintaining a predetermined insulative characteristic in the body;

FIG. 24A is an enlarged sectional view of a portion of a side wall included in the body of the insulative cup of FIG. 24 showing that the side wall is made from a sheet that includes, from left to right, a skin comprising an ink layer and a film layer, a polymeric-lamination layer, and insulative cellular non-aromatic polymer material;

FIG. 25 is an exploded assembly view of the insulative cup of FIG. 24 showing that the insulative cup includes, from top to bottom, the floor and the body including a rolled brim, the side wall, and a support structure configured to mate with the floor as shown in FIG. 24;

FIG. 26 is a sectional view taken along line 26-26 of FIG. 24 showing that the side wall included in the body of the insulative cup includes a generally uniform thickness and showing that the floor is coupled to a floor mount included in the body;

FIGS. 27A-27D are a series of views showing first, second, third, and fourth regions of the insulative cup of FIG. 24 that each include localized plastic deformation;

FIG. 27A is a partial section view taken along line 26-26 of FIG. 24 showing the first region is in the side wall of the body;

FIG. 27B is a partial section view taken along line 26-26 of FIG. 24 showing the second region is in the rolled brim of the body;

FIG. 27C is a partial section view taken along line 26-26 of FIG. 24 showing the third region is in a connecting web included in the floor mount of the body;

FIG. 27D is a partial section view taken along line 26-26 of FIG. 24 showing the fourth region is in a web-support ring included in the floor mount of the body;

FIG. 28 is a dead section view taken along line 28-28 of FIG. 24 showing that the side wall of the insulative cup includes a C-shaped fence, an upright outer tab coupled to one end of the C-shaped fence, and an upright inner tab coupled to an opposite end of the C-shaped fence and suggesting that the first and second tabs are arranged to overlap one another to establish a bridge extending between the ends of the C-shaped fence to define the interior region therebetween;

FIG. 28A is an enlarged dead section view of a bridge in accordance with the present disclosure showing how the insulative cellular non-aromatic polymer material has been compressed in both the first and second tabs to produce a bridge having a reduced thickness that is similar to a thickness of the side wall in the C-shaped fence opposite the bridge;

FIG. 28B is an enlarged dead section view of a portion of the C-shaped fence of FIG. 60A showing that the insulative cellular non-aromatic polymer material has not been compressed;

FIG. 28C is an enlarged dead section view of the first and second tabs prior to mating to one another to establish the bridge;

FIG. 29 is an enlarged view similar to FIG. 60A taken from taken along line 29-29 of FIG. 24;

FIG. 30 is diagrammatic and dead section view of the rolled brim of FIGS. 24, 26, and 27B showing the second region of localized plastic deformation;

FIG. 31A is a partial sectional view of a combination of the insulative cup of FIG. 24 and a lid showing that the lid includes a rim that mates with the rolled brim of the insulative cup as suggested in FIG. 31B;

FIG. 31B is a partial sectional view of the lid and insulative cup of FIG. 31A with the lid mated to the cup so that the rim of the lid engages the rolled brim of the insulative cup to close a mouth opening into the interior region;

FIG. 32 is an enlarged partial elevation view of the insulative cup of FIGS. 24, 26, and 27C showing that the floor is coupled to the side wall by the floor mount and that the floor mount includes a web-support ring coupled to the side wall, a floor-retaining flange radially spaced-apart from the web-support ring, and a connecting web interconnecting the web-support ring and the floor-retaining flange;

FIG. 32A is a dead section view of a portion of an insulative cup in accordance with the present disclosure showing the third region of localized plastics deformation of the insulative cellular non-aromatic polymer material in the connecting web of the floor mount and showing melting of the insulative cellular non-aromatic polymer material along an interface between the floor-retaining flange and a portion of the floor;

FIG. 33 is an enlarged view similar to FIG. 32A;

FIG. 34 is an enlarged partial elevation view of the insulative cup of FIGS. 24, 26 and 27D showing the fourth region of localized plastic deformation is formed in the floor-retaining flange and includes channels formed between neighboring thick sections of the floor-retaining flange;

FIG. 34A is a view similar to FIG. 27D showing alternating thick and thin sections of the floor-retaining flange;

FIG. 34B is a dead section view of a portion of a floor-retaining flange in accordance with the present disclosure showing that a channel is formed between two neighboring thick sections of the floor-retaining flange;

FIG. 35 is an enlarged view similar to FIG. 34B;

FIG. 36 is an enlarged view of the channel of FIG. 35 showing that the insulative cellular non-aromatic polymeric material is formed to include cells filled with gas, that each cell is bounded by a cell wall that is shared with neighboring cells, and that the cell walls are deformed during a cup-forming process suggested in FIGS. 40-44 to cause density to be increased in the area of localized plastic deformation;

FIG. 37A is a plan view of a body blank used to make the body of FIG. 24 with portions broken away to reveal that the body blank is formed from a strip of insulative cellular non-aromatic polymeric material and a skin laminated to the strip of insulative cellular non-aromatic polymeric material and suggesting that during a blank forming process a web former compresses a portion of the body blank along an arcuate fold line to form the connecting web and a stave former compresses another portion of the body blank between the arcuate fold line and a lower arcuate edge to form a series of alternating thick and thin staves that extend between the arcuate fold line and the second lower arcuate edge;

FIG. 37B is a view similar to FIG. 37A after the blank forming process has been performed showing that both the connecting web and the staves have been formed in the body blank;

FIG. 37C is a plan view of another embodiment of a body blank in accordance with the present disclosure showing that the body blank is formed from a sheet that includes only insulative cellular non-aromatic polymeric material;

FIG. 38 is an enlarged partial plan view of the side-wall blank of FIG. 37B showing the arcuate fold line and alternating thick and thin staves which cooperate to define channels in the floor-retaining flange;

FIG. 39 is a dead section view taken along line 39-39 of FIG. 38 showing a number of channels formed between neighboring pairs of thick sections of a floor-retaining flange included in the side-wall blank;

FIG. 40 is a perspective and diagrammatic view of a cup-manufacturing process in accordance with the present disclosure showing that the cup-manufacturing process includes providing a laminated roll of laminated sheet, forming an insulative cup as suggested in detail in FIGS. 40-43, and packaging stacks of insulative cups as suggested in detail in FIG. 44 and showing that forming an insulative cup includes the steps of forming a body blank as suggested in detail in FIG. 41, annealing the body blank, forming a cup base as suggested in detail in FIG. 42, and forming a rolled brim as suggested in detail in FIG. 43;

FIG. 41 is a perspective and diagrammatic view of the body blank forming stage showing that the body blank forming stage includes the steps of loading the laminated roll to provide the laminated sheet, annealing the laminated sheet, compressing the laminated sheet to form a compressed sheet, cutting the compressed sheet to form body blanks and scrap, collecting scrap, and accumulating the body blanks to form body blank stacks;

FIG. 42 is a perspective and diagrammatic view of the cup-base forming stage showing that the cup-base forming stage includes the steps of loading body blank stacks, heating the body blank, wrapping the body blank around a mandrel, forming a body, loading another laminated roll to provide the laminated sheet, cutting the laminated sheet to provide floor blanks and scrap, shaping the floor blanks into a floor, heating the floor, heating the body, wrapping the body around the floor, and coupling the floor to the base to establish a cup body;

FIG. 43 is a perspective and diagrammatic view of the brim-forming stage showing that the brim-forming stage includes the steps of transferring the cup base to a brim-forming machine, optionally lubricating the top portion of the base, heating the top portion of the base, and rolling the top portion of the base to form an insulative cup having a rolled brim;

FIG. 44 is a perspective and diagrammatic view of the cup-packaging stage showing that the cup-packaging stage includes the steps of inspecting the insulative cup for leaks, accumulating the good cups to form stacks of insulative cups, and packaging the stacks of insulative cups for storage and transportation;

FIG. 45 is a plan view of another embodiment of a body blank in accordance with the present disclosure showing that the body blank includes a first upper arcuate edge, a second lower arcuate edge, an arcuate fold line therebetween, a series of spaced apart channels extending between the arcuate fold line and the second lower arcuate edge, and including brim tabs that are compressed to reduce the thickness of the insulative cellular non-aromatic polymeric material where portions of the body blank overlap to form a rolled brim;

FIG. 46 is a sectional view taken along line 46-46 of FIG. 45;

FIG. 47 is a plan view of yet another embodiment of a body blank in accordance with the present disclosure showing that the body blank includes a first upper arcuate edge, a second lower arcuate edge, an arcuate fold line therebetween, a series of spaced apart channels extending between the arcuate fold line and the second lower arcuate edge, and first and second tabs that have been compressed prior to body forming to reduce the thickness of the material where portions of the body blank overlap to form a bridge;

FIG. 48 is a sectional view taken along line 48-48 of FIG. 47;

FIG. 49 is a perspective view of another embodiment of an insulative cup in accordance with the present disclosure showing that the insulative cup includes a body including a rolled brim, a side wall, and a floor mount and a floor coupled to both the support structure and the bottom portion of the side wall and showing that portions of the side wall have been compressed to form a number of ribs extending outwardly away from the compressed portions of the side wall;

FIG. 50 is a plan view of the body blank used to form the body of the insulative cup shown in FIG. 49 showing that the body blank includes a first upper arcuate edge, a second lower arcuate edge, an arcuate fold line therebetween, a series of spaced apart channels extending between the arcuate fold line and the second lower arcuate edge, and compressed portions of the side wall that establish ribs therebetween to reduce the surface area of contact between the hand of a user and the outer surface of the cup;

FIG. 51 is a sectional view taken along line 51-51 of FIG. 50;

FIG. 52 is a perspective view of yet another embodiment of an insulative cup in accordance with the present disclosure showing that the insulative cup includes a body including a rolled brim, a side wall, and a floor mount and a floor coupled to both the support structure and the bottom portion of the side wall and showing a number of protruding ribs formed in the side wall as a result of displacing portions of the side wall;

FIG. 53 is a plan view of a body blank used to make the body of the insulative cup shown in FIG. 52 showing that the body blank includes a first upper arcuate edge, a second lower arcuate edge, an arcuate fold line therebetween, a series of spaced apart channels extending between the arcuate fold line and the second lower arcuate edge, and protruding ribs formed as a result of displacing material to form ribs that are used to reduce the surface area of contact between the hand of a user and the outer surface of the cup;

FIG. 54 is a sectional view taken along line 54-54 of FIG. 53;

FIG. 55 is an enlarged portion of FIG. 54 showing that material has been displaced in the side wall to form the rib;

FIG. 56 is a dead section view of another embodiment of a rolled brim in accordance with the present disclosure showing that the rolled brim has a generally constant thickness throughout;

FIG. 57 is a dead section view of yet another embodiment of a rolled brim in accordance with the present disclosure showing that the rolled brim includes a thickness that becomes relatively thinner toward a free end of the rolled brim;

FIG. 58 is a dead section view of yet another embodiment of a rolled brim in accordance with the present disclosure showing that the rolled brim has been rolled upon itself so that generally no space is formed in the rolled brim;

FIG. 59 is an enlarged partial elevation view of another embodiment of an insulative cup in accordance with the present disclosure showing a fourth region of localized plastic deformation in which channels are formed in an inner periphery of the floor-retaining flange so that the channels are hidden when the insulative cup is assembled;

FIG. 60 is an enlarged partial elevation view of the floor similar to FIG. 59 showing the floor mating with both a floor mount included in the insulative cup and that the channels are spaced apart from one another, the connecting web, and the floor;

FIG. 61 is a view similar to FIG. 24A showing an embodiment of a sheet that includes, from top to bottom, an ink layer, a film layer, a polymeric-lamination layer, and a strip of insulative cellular non-aromatic polymeric material; and

FIG. 62 is a view similar to FIG. 61 showing another embodiment of a sheet that includes, from top to bottom, an outer skin including an ink layer and a film layer, a polymeric-lamination layer, a strip of insulative cellular non-aromatic polymeric material, and an inner skin including a film layer and an ink layer.

### DETAILED DESCRIPTION

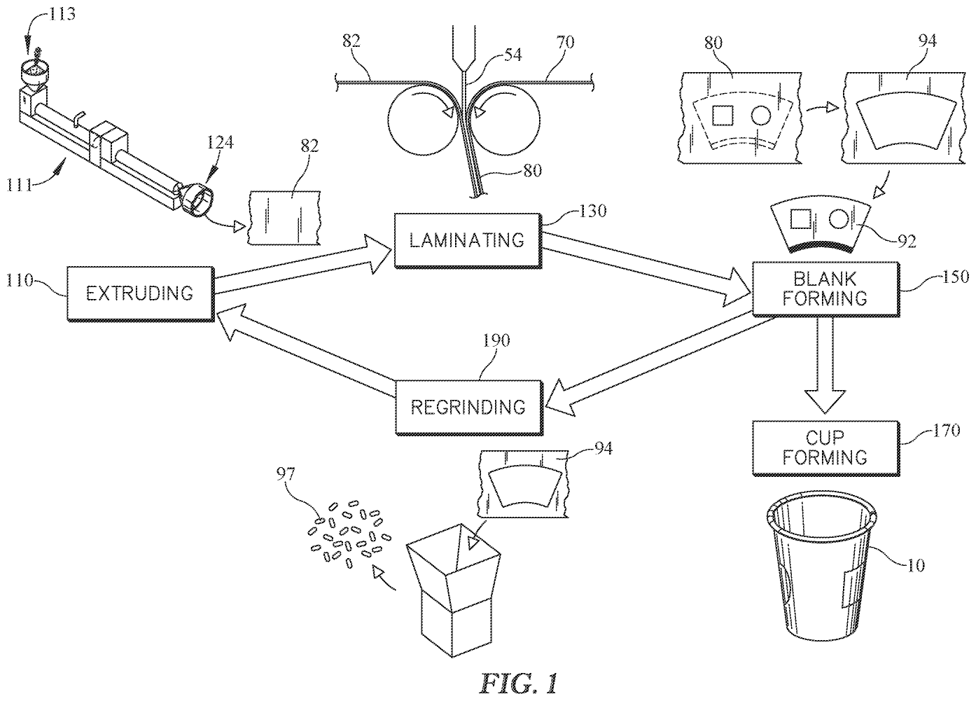

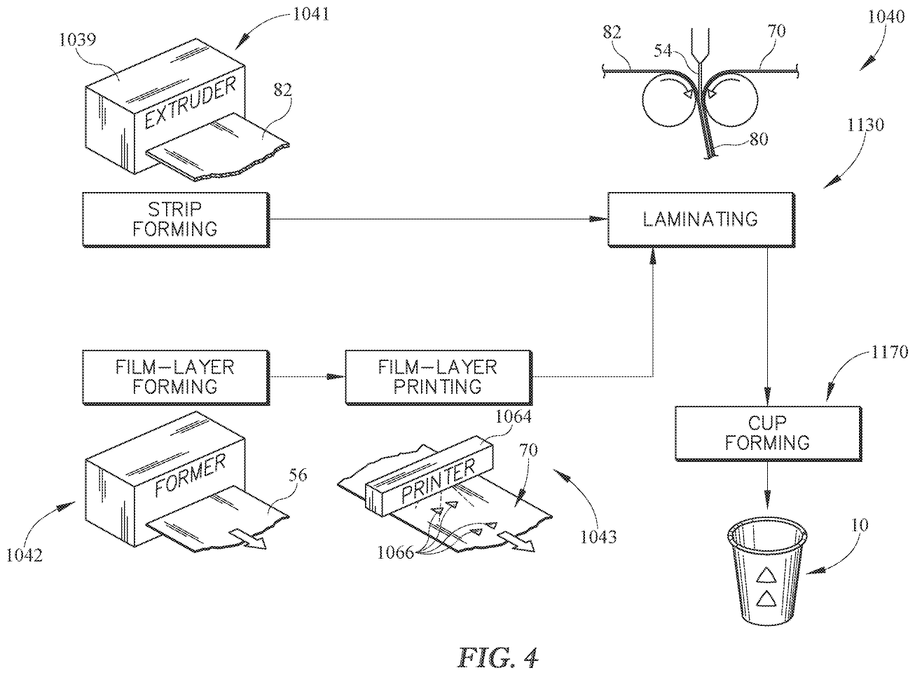

An insulative cup 10 in accordance with the present disclosure comprises an insulative cellular non-aromatic polymeric material 82, a printed film layer 70, and a polymeric-lamination layer 54, as shown in FIGS. 1-3. The cup 10 is formed by a cup formation process 100 that includes extruding polymeric-lamination layer 54 onto insulative cellular non-aromatic polymeric material 82 to couple the printed film layer 70 and form a multi-layer sheet 80, as shown in FIG. 4. Illustratively, the extrusion-lamination process of cup formation process 100 provides a multi-layer sheet having improved properties compared to an adhesively-laminated sheet of comparable materials. For example, multi-layer sheet 80 may provide increased rigidity and/or decreased condensation on cup 10 when cup 10 is filled with a cold liquid.

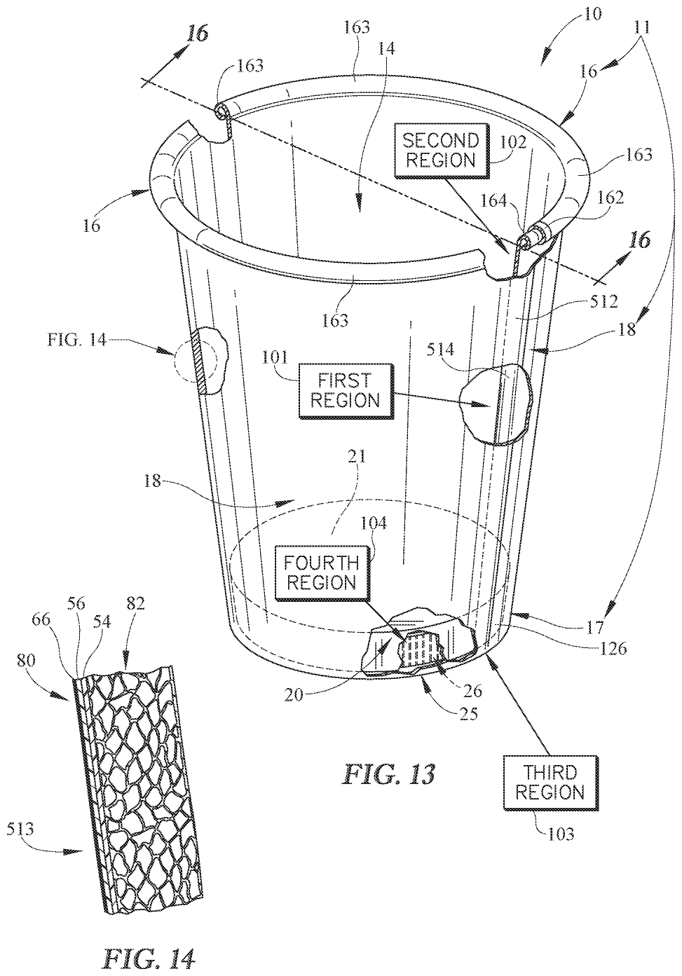

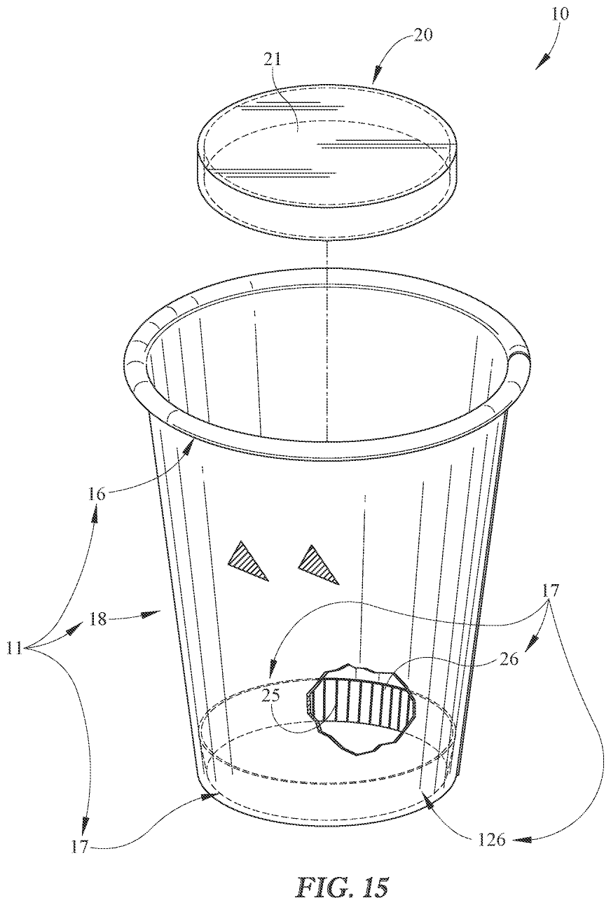

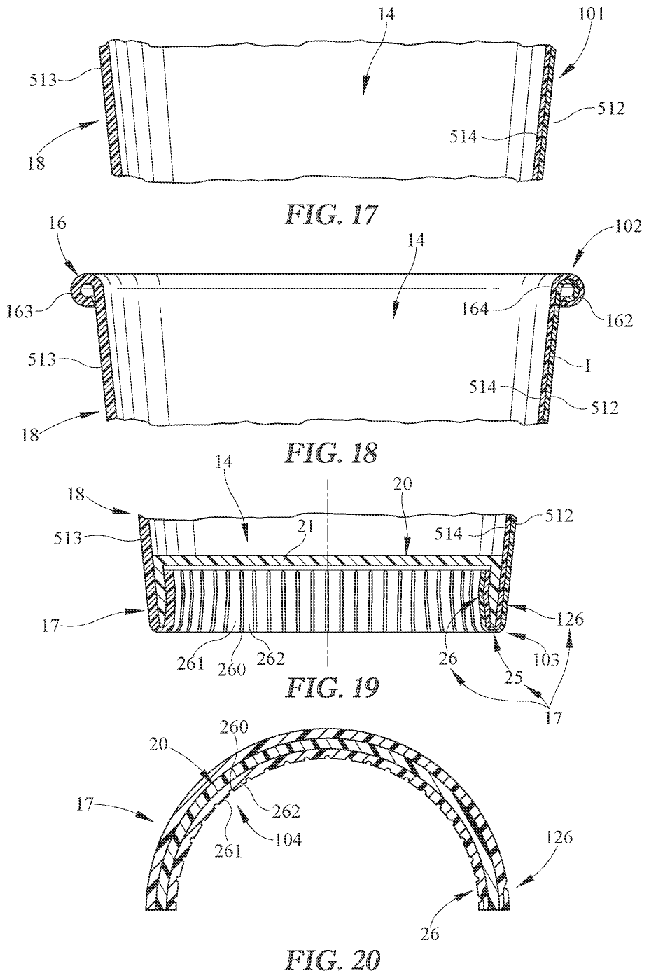

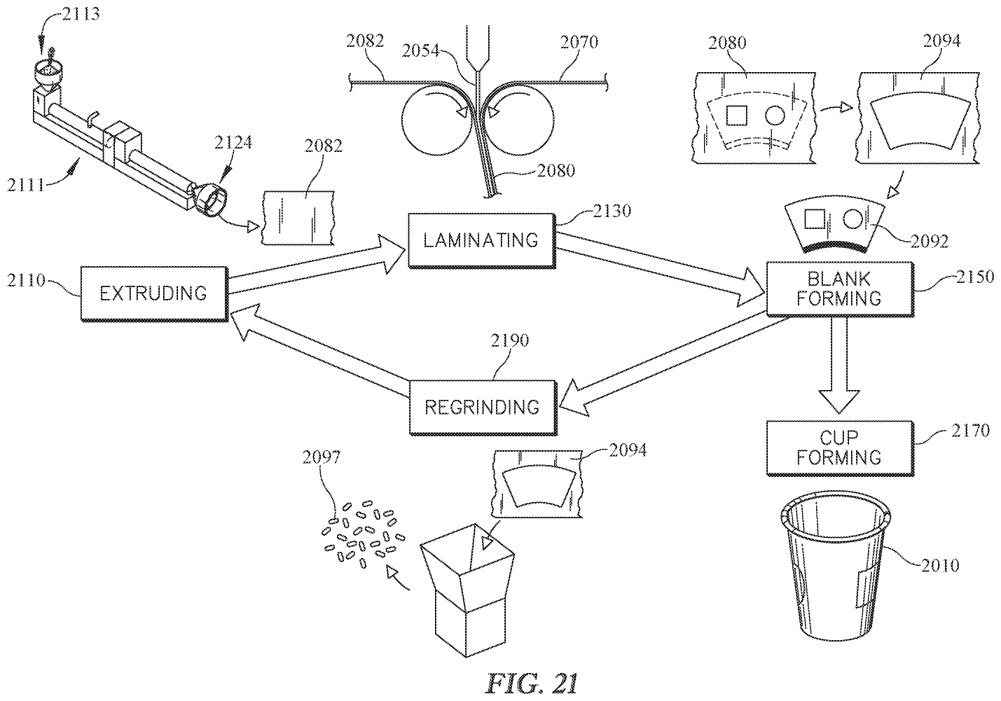

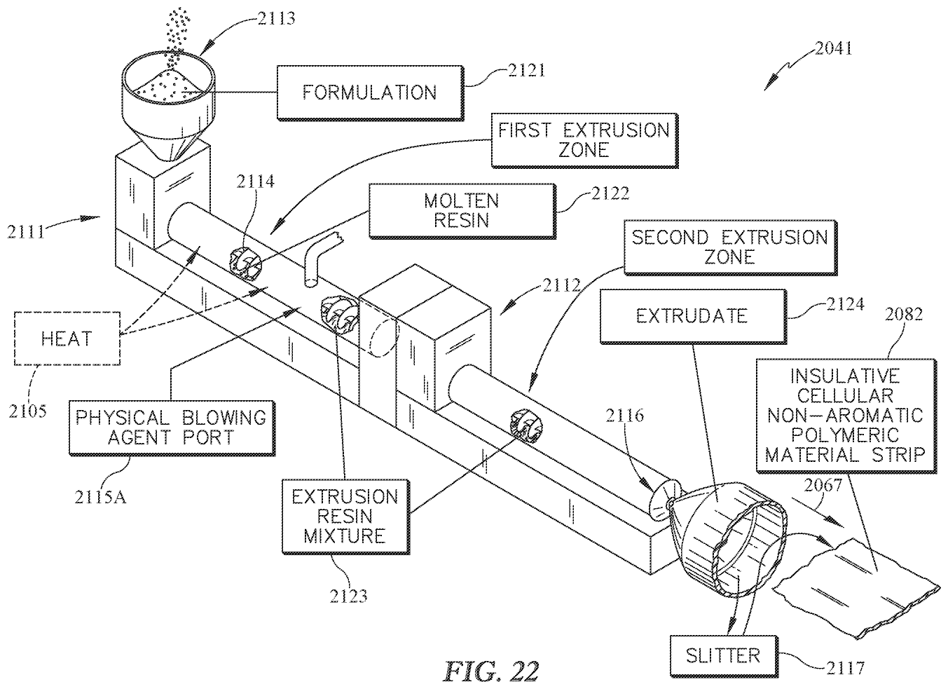

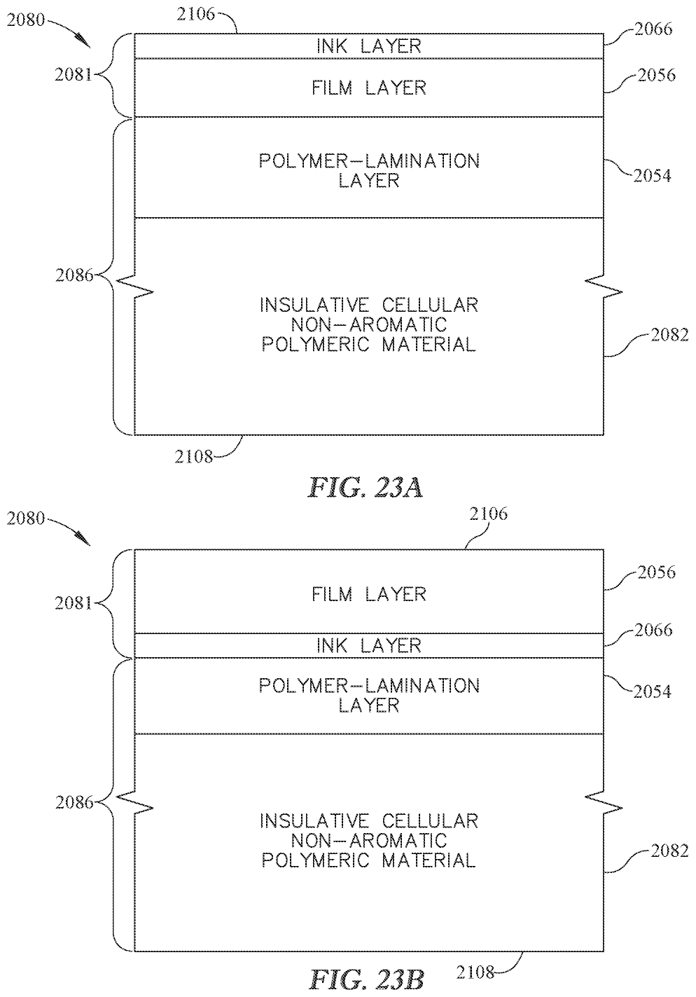

Insulative cup 10 includes, for example, a body 11 having a sleeve-shaped side wall 18 and a floor 20 as shown in FIGS. 13-20. Floor 20 is coupled to body 11 and cooperates with side wall 18 to form an interior region 14 therebetween for storing food, liquid, or any suitable product. Body 11 also includes a rolled brim 16 coupled to an upper end of side wall 18 and a floor mount 17 coupled to a lower end of side wall 18 and to floor 20 as shown in FIG. 15.

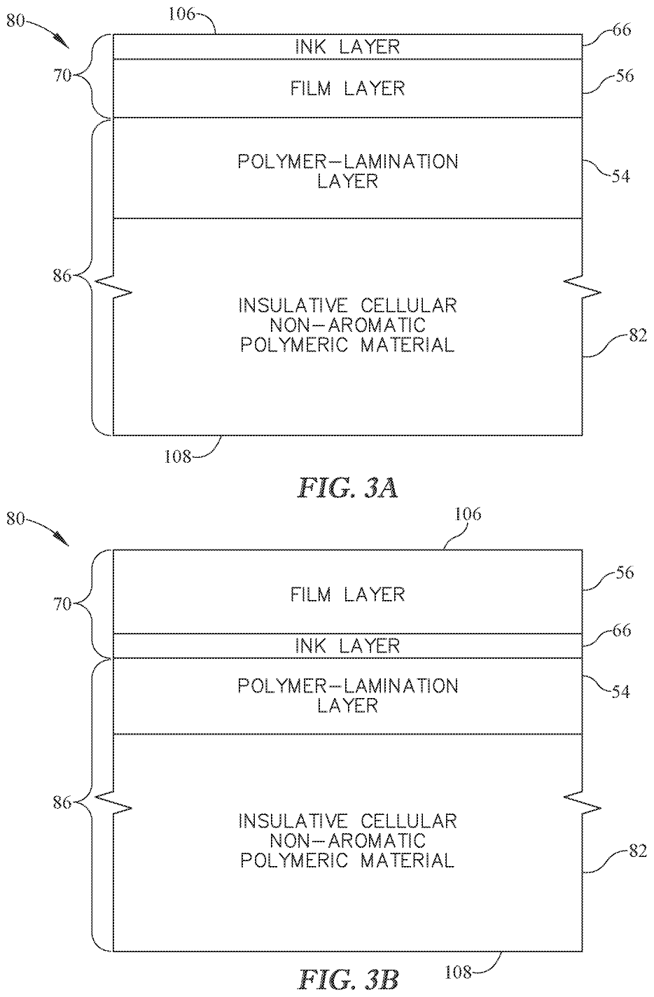

Multi-layer sheet 80 includes insulative cellular non-aromatic polymeric material 82, polymeric-lamination layer 54, and printed film layer 70, as shown in FIGS. 3A and B. Insulative cellular non-aromatic polymeric material 82 comprises a polymeric foam and is configured to reduce the density of multi-layer sheet 80. Polymeric-lamination layer 54 extends between and interconnects insulative cellular non-aromatic polymeric material 82 and printed film layer 70. Printed film layer 70 includes a film layer 56 and an ink layer 66 printed onto film layer 56.

Illustratively, multi-layer sheet 80 may be used to form a container. In some embodiments, the container is cup 10, as shown in FIG. 1. In some embodiments, multi-layer sheet 80 may have a particular rigidity so as to minimize the deformation of multi-layer sheet 80. Illustratively, rigidity can be measured at ambient temperatures, at elevated temperatures, or at decreased temperatures. In some embodiments, when multi-layer sheet 80 is used to form a container, the presence of a lid may improve the rigidity of multi-layer sheet 80. Illustratively, when multi-layer sheet 80 is used to form a container, the presence or absence of a liquid located within the container may affect the measured rigidity.

Illustratively, multi-layer sheet 80 has a particular thickness. In some embodiments, multi-layer sheet 80 is about 30 mils to about 70 mils thick. The thickness of multi-layer sheet 80 may be one of the following values: about 30 mils, about 32 mils, about 34 mils, about 36 mils, about 38 mils, about 40 mils, about 42 mils, about 44 mils, about 46 mils, about 48 mils, about 50 mils, about 51 mils, about 52 mils, about 53 mils, about 54 mils, about 55 mils, about 56 mils, about 58 mils, about 60 mils, about 62 mils, about 64 mils, about 66 mils, about 68 mils, or about 70 mils thick. The thickness of multi-layer sheet 80 may fall within one of many different ranges. In a first set of ranges, the thickness of multi-layer sheet 80 may be about 30 mils to about 70 mils, about 30 mils to about 60 mils, about 30 mils to about 58 mils, about 30 mils to about 56 mils, or about 30 mils to about 55 mils thick. In a second set of ranges, the thickness of multi-layer sheet 80 may be about 32 mils to about 70 mils, about 38 mils to about 70 mils, about 42 mils to about 70 mils, about 46 mils to about 70 mils, or about 50 mils to about 70 mils thick. In a third set of ranges, the thickness of multi-layer sheet 80 may be about 32 mils to about 68 mils, about 38 mils to about 68 mils, about 38 mils to about 62 mils, about 42 mils to about 62 mils, about 46 mils to about 62 mils, about 46 mils to about 60 mils, about 48 mils to about 60 mils, or about 50 mils to about 60 mils thick. In another exemplary embodiment, multi-layer sheet 80 is about 53 mils thick. In yet another exemplary embodiment, multi-layer sheet 80 is about 54 mils thick.

Illustratively, each of insulative cellular non-aromatic polymeric material 82, polymeric-lamination layer 54, and film layer 56 comprise a polymeric material. The polymeric material for each of insulative cellular non-aromatic polymeric material 82 and polymeric-lamination layer 54 can be made, for example, by extruding a polymeric formulation. It should be understood that many of the ranges described herein for the polymeric formulation apply with equal weight to the extruded polymeric material, except that in some examples the chemical nucleating agent will decompose upon heating. The decomposition of the chemical nucleating agent could cause the relative weight percentages of the remaining components to increase slightly.

As an example, a polymeric formulation for forming insulative cellular non-aromatic polymeric material 82 comprises a base resin blend comprising a high density polyethylene (HDPE), a low density polyethylene (LDPE), or a combination thereof. In some embodiments, the formulation may comprise cell-forming agents including a chemical nucleating agent, a physical blowing agent, or a combination thereof.

In some embodiments, the HDPE may be a homopolymer, a copolymer, an enhanced polyethylene, combinations thereof, or any suitable alternative. One exemplary HDPE described herein is DMDA 8007 by Dow Chemical.

In some embodiments, the LDPE may be a homopolymer. In another embodiment, the LDPE may be a copolymer. One exemplary LDPE described herein is LDPE 621i by Dow Chemical.

Process additives, such as slip agents, antiblock agents, or antistatic agents may be added to the formulations to improve the extrusion process and provide additional properties of multi-layer sheet 80. Colorants in the form of masterbatches may also be added the formulation for each of the layers.

### Foam Composition

In exemplary embodiments, a polymeric formulation comprises a base resin blend comprising at least two materials. In some embodiments, the base resin blend comprises a first polymer and a second polymer. In some embodiments, the first polymer is a polyethylene. In some embodiments, the second polymer is a polyethylene. In some embodiments, the first polymer is a first polyethylene and the second polymer is a second polyethylene. In one exemplary embodiment, the first polymer is an HDPE. In another exemplary embodiment, the second polymer is an LDPE. In some embodiments, the first polymer is an HDPE and the second polymer is an LDPE.

In some aspects, the amount of the first polymer in the polymeric formulation is generally the same as the amount of the first polymer in the extruded polymeric material. In some embodiments, the first polymer may be at least about 40%, at least about 50%, at least about 60%, or at least about 70% by weight of the formulation. In some embodiments, the first polymer may be about 40%, about 45%, about 50%, about 55%, about 60%, about 65%, about 70%, about 75%, about 80%, about 85%, about 90%, or about 95% by weight of the formulation. In some embodiments, the first polymer may be within a range of about 40% to about 100%, about 40% to about 90%, about 50% to about 90%, about 60% to about 90%, about 60% to about 85%, about 65% to about 85%, about 65% to about 80%, or about 70% to about 80% by weight of the formulation. Illustratively, these ranges apply equally when the first polymer is a polyethylene. Illustratively, these ranges apply equally when the first polymer is an HDPE.

In some aspects, the amount of the second polymer in the polymeric formulation is generally the same as the amount of the second polymer in the extruded polymeric material. In some embodiments, the second polymer may be at least about 5%, at least about 10%, at least about 15%, or at least about 20% by weight of the formulation. In some embodiments, the second polymer may be about 5%, about 10%, about 15%, about 20%, about 25%, about 30%, about 35%, about 40%, about 45%, or about 50% by weight of the formulation. In some embodiments, the second polymer may be within a range of 5% to about 50%, about 5% to about 45%, about 10% to about 45%, about 15% to about 45%, about 15% to about 35%, about 20% to about 35%, or about 20% to about 30% by weight of the formulation. Illustratively, these ranges apply equally when the second polymer is a polyethylene. Illustratively, these ranges apply equally when the second polymer is an LDPE.

In some embodiments, one or more nucleating agents are used to provide and control nucleation sites to promote the formation of cells, bubbles, or voids in the molten resin during the extrusion process. A nucleating agent can be a chemical blowing agent or a physical material that provides sites, i.e., nucleation sites, for cells to form in a molten resin mixture. When a suitable temperature is reached, the nucleating agent enables the formation of gas bubbles that create cells in the molten resin.

Suitable physical nucleating agents have a desirable particle size, aspect ratio, top-cut properties, shape, and surface compatibility. Examples include, but are not limited to, talc, CaCO₃, mica, kaolin clay, chitin, aluminosilicates, graphite, cellulose, and mixtures of at least two of the foregoing. The physical nucleating agent may be blended with the polymeric formulation that is introduced into hopper. Alternatively, the physical nucleating agent may be added to the molten resin mixture in an extruder.

As described herein, the polymeric formulation or the polymeric material may comprise a physical nucleating agent or may lack a physical nucleating agent. In some aspects, the amount of the physical nucleating agent in the polymeric formulation is generally the same as the amount of the physical nucleating agent in the polymeric material. In some embodiments, the physical nucleating agent is up to about 0.5%, up to about 0.4%, or up to about 0.3% by weight of the polymeric formulation. It is within the scope of the present disclosure to select an amount of a physical nucleating agent to be one of the following values: about 0.1%, about 0.15%, about 0.2%, about 0.25%, about 0.3%, about 0.35%, about 0.4%, about 0.45%, or about 0.5% by weight of the total formulation of the polymeric formulation. It is also within the scope of the present disclosure for the weight percentage (w/w) of a physical nucleating agent to fall within one of many different ranges. The weight percentage of a physical nucleating agent may fall within one of the following ranges: about 0.1% to about 0.5%, about 0.1% to about 0.4%, about 0.1% to about 0.35%, about 0.15% to about 0.35%, about 0.2% to about 0.35%, or about 0.2% to about 0.3% by weight of the polymeric formulation.

After decomposition, chemical blowing agents form small gas cells, which further serve as nucleation sites for larger cell growth from physical blowing agents or other types thereof. Chemical blowing agents may be endothermic or exothermic. Illustratively, chemical blowing agents may behave as chemical nucleating agents at particular concentrations. An illustrative example of a chemical blowing agent is citric acid or a citric acid-based material. One representative example is Hydrocerol™ CF-40E™ (available from Clariant Corporation), which contains citric acid and a crystal nucleating agent. Another representative example is Hydrocerol™ CF-05E™ (available from Clariant Corporation), which contains citric acid and a crystal nucleating agent. In illustrative embodiments, one or more catalysts or other reactants may be added to accelerate or facilitate the formation of cells. In some embodiments, the chemical blowing agent may be one or more materials selected from the group consisting of azodicarbonamide; azodiisobutyro-nitrile; benzenesulfonyl hydrazide; 4,4-oxybenzene sulfonylsemicarbazide; p-toluene sulfonyl semi-carbazide; barium azodicarboxylate; citric acid; N,N′-dimethyl-N,N′-dinitrosoterephthalamide; trihydrazino triazine; sodium bicarbonate; sodium carbonate; ammonium bicarbonate; ammonium carbonate; ammonium nitrite; N,N′-dinitrosopentamethylene tetramine; azobisisobutylonitrile; azocyclohexylnitrile; azodiaminobenzene; toluene sulfonyl hydrazide; p,p′-oxybis(benzene sulfonyl hydrazide); diphenyl sulfone-3,3′-disulfonyl hydrazide; calcium azide; 4,4′-diphenyl disulfonyl azide; p-toluene sulfonyl azide; and combinations thereof. In some embodiments, the formulation is substantially free of a chemical blowing agent.

The amount of a chemical blowing agent may be one of several different values or fall within one of several different ranges. In some embodiments, the polymeric formulation is substantially free of a chemical blowing agent. In some aspects, the amount of the chemical blowing agent in the polymeric formulation is generally greater than the amount of the chemical blowing agent in the polymeric material due to the decomposition of the chemical blowing agent. It is within the scope of the present disclosure to select an amount of a chemical blowing agent to be one of the following values: about 0.1%, about 0.2%, about 0.3%, about 0.4%, or about 0.5% by weight of the polymeric formulation. It is within the scope of the present disclosure for the amount of a chemical blowing agent in the formulation to fall within one of many different ranges. In a first set of ranges, the range of a chemical blowing agent is one of the following ranges: about 0.1% to about 0.5%, about 0.1% to about 0.4%, about 0.1% to about 0.3%, or about 0.2% to about 0.3% by weight of the polymeric formulation. In one aspect of the present disclosure, where a chemical blowing agent is used, the chemical blowing agent may be introduced into the material formulation that is added to the hopper. In some embodiments, the polymeric formulation may lack a chemical blowing agent.

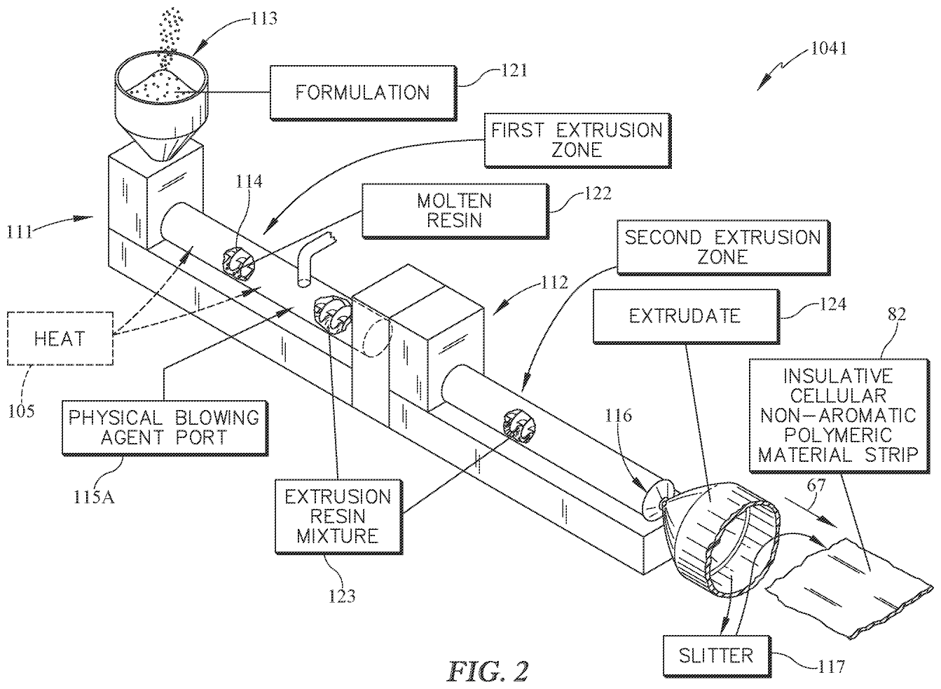

In exemplary embodiments, physical blowing agents are typically gasses that are introduced as liquids under pressure into the molten resin via a port in the extruder as suggested in FIG. 2. As the molten resin passes through the extruder and the die head, the pressure drops causing the physical blowing agent to change phase from a liquid to a gas, thereby creating cells in the extruded resin. Excess gas blows off after extrusion with the remaining gas being trapped in the cells in the extrudate.

Illustrative physical blowing agents include agents that are gasses. Representative examples of physical blowing agents include, but are not limited to, carbon dioxide, nitrogen, helium, argon, air, water vapor, pentane, butane, other alkane mixtures of the foregoing and the like. In certain exemplary embodiments, a processing aid may be added to the formulation to enhance the solubility of the physical blowing agent. Alternatively, the physical blowing agent may be a hydrofluorocarbon, such as 1,1,1,2-tetrafluoroethane, also known as R134a, a hydrofluoroolefin, such as, but not limited to, 1,3,3,3-tetrafluoropropene, also known as HFO-1234ze, or other haloalkane or haloalkane refrigerant.

One example of a physical blowing agent is carbon dioxide (CO₂). The CO₂ is pumped as a supercritical fluid into the molten formulation via a port in the extruder. The molten material with the CO₂ in suspension then exits the extruder via a die where a pressure drop occurs. As the pressure drop happens, CO₂ moves out of suspension toward the nucleation sites where cells grow. Excess gas blows off after extrusion with the remaining gas trapped in the cells formed in the extrudate. Other suitable examples of physical blowing agents include, but are not limited to, nitrogen (N₂), helium, argon, air, pentane, butane, or other alkane mixtures of the foregoing and the like.

In illustrative embodiments, a physical blowing agent is introduced into the molten formulation to decrease the density of the formulation. In some embodiments, the physical blowing agent is introduced at a rate of about 10 lbs/hour to about 20 lbs/hour. In some embodiments, the physical blowing agent is added to be about 0.5% to about 3%, about 1% to about 3%, or about 1% to about 2% by weight of the formulation. In illustrative embodiments, the physical blowing agent is added to be about 0.5%, about 1%, about 1.5%, about 2%, about 2.5%, or about 3% by weight of the formulation.

In one aspect of the present disclosure, at least one slip agent may be incorporated into the polymeric formulation to aid in increasing production rates. Slip agent (also known as a process aid) is a term used to describe a general class of materials, which are added to a polymeric formulation and provide surface lubrication to the polymer during and after conversion. Slip agents may also reduce or eliminate die drool. Representative examples of slip agent materials include amides of fats or fatty acids, such as, but not limited to, erucamide and oleamide. In one exemplary aspect, amides from oleyl (single unsaturated C-18) through erucyl (C-22 single unsaturated) may be used. Other representative examples of slip agent materials include low molecular weight amides and fluoroelastomers. Combinations of two or more slip agents can be used. Slip agents may be provided in a master batch pellet form and blended with the resin formulation.

The amount of a slip agent may be one of several different values or fall within one of several different ranges. In some aspects, the amount of slip agent in the polymeric formulation is generally the same as the amount of the slip agent in the polymeric material. It is within the scope of the present disclosure to select an amount of a slip agent to be one of the following values: about 0.1%, about 0.5%, about 1%, about 1.5%, about 2%, about 2.5%, or about 3% by weight of the polymeric formulation. It is within the scope of the present disclosure for the amount of a slip agent in the formulation to fall within one of many different ranges. In some embodiments, the slip agent may be within one of the following ranges about 0.1% to about 3%, about 0.5% to about 3%, about 0.5% to about 2%, or about 0.5% to about 1.5% by weight of the polymeric formulation. In some embodiments, the formulation lacks a slip agent.

One or more additional components and additives optionally may be incorporated, such as, but not limited to, impact modifiers, and colorants (such as, but not limited to, titanium dioxide).

In some embodiments, the polymeric formulation of the insulative cellular non-aromatic material comprises regrind. Illustratively, regrind may be reworked plastic, reprocessed plastic recovered during production of multi-layer sheet 80, or post-consume recycled plastic. Regrind may be formed by recovering the excess material, sometimes called a blank-carrier sheet 94, produced during a blank forming step 150, as shown in FIG. 1. Regrind can be processed during a regrinding step 190 that grinds blank-carrier sheet 94 into pellets 97. In some embodiments, pellets 97 can be melted and re-pelletized prior to being added to a polymeric formulation.

In some embodiments, regrind comprises ink. In some embodiments, the ink is from ink layer 66. In some embodiments, regrind is substantially free of ink. In some embodiments, the regrind may comprise a polypropylene, a polyethylene, a physical nucleating agent, a slip agent, or a combination thereof. In some embodiments, the regrind may comprise at least one polyethylene, a physical nucleating agent, a slip agent, or a combination thereof. Illustratively, regrind is substantially free of an adhesive. In some embodiments, regrind is substantially free of an epoxy. In some embodiments, regrind comprises a polyethylene and BOPP.

It is within the scope of the present disclosure to select an amount of regrind to be up to about 5%, up to about 10%, up to about 15%, up to about 20%, up to about 25%, up to about 30%, up to about 35%, up to about 40%, up to about 45%, up to about 50%, up to about 55%, up to about 60%, up to about 65%, up to about 75%, up to about 85%, or up to about 95% by weight of the polymeric formulation. The percentage by weight of regrind in the polymeric formulation may be about 0%, about 0.5%, about 1%, about 3%, about 4%, about 5%, about 7%, about 10%, about 15%, about 20%, about 25%, about 30%, about 35%, about 40%, about 45%, about 50%, about 55%, about 60%, about 65%, about 70%, about 755, about 80%, about 85%, about 90%, or about 95% by weight of the polymeric formulation. In a first set of ranges, the range of a regrind in the polymeric formulation is one of the following ranges: about 0.5% to about 95%, about 3% to about 95%, about 5% to about 95%, about 10% to about 95%, about 15% to about 95%, about 20% to about 95%, about 25% to about 95%, about 30% to about 40% to about 95%, about 50% to about 95%, about 60% to about 95%, about 75% to about 95%, or about 85% to about 95% by weight of the polymeric formulation. In a second set of ranges, the range of regrind in the polymeric formulation is one of the following ranges: about 0.5% to about 90%, about 0.5% to about 85%, about 0.5% to about 75%, about 0.5% to about 60%, about 0.5% to about 50%, about 0.5% to about 45%, about 0.5% to about 40%, about 0.5% to about 35%, about 0.5% to about 30%, about 0.5% to about 25%, about 0.5% to about 20%, about 0.5% to about 15%, or about 0.5% to about 10% by weight of the polymeric formulation. In a third set of ranges, the range of regrind in the polymeric formulation is one of the following ranges: about 1% to about 90%, about 1% to about 85%, about 1% to about 75%, about 1% to about 50%, about 3% to about 50%, about 3% to about 45%, about 5% to about 45%, about 5% to about 40%, about 5% to about 35%, about 10% to about 40%, about 10% to about 35%, about 10% to about 45%, about 20% to about 45%, about 5% to about 40%, about 5% to about 30%, about 15% to about 30%, or about 30% to about 40% by weight of the polymeric formulation.

### Foam Properties

In an embodiment, insulative cellular non-aromatic polymeric material 82 is about 30 mils to about 70 mils thick. Insulative cellular non-aromatic polymeric material 82 may be a particular thickness. The thickness of insulative cellular non-aromatic polymeric material 82 may be one of the following values: about 30 mils, about 32 mils, about 34 mils, about 36 mils, about 38 mils, about 40 mils, about 42 mils, about 44 mils, about 46 mils, about 48 mils, about 50 mils, about 51 mils, about 52 mils, about 53 mils, about 54 mils, about 55 mils, about 56 mils, about 58 mils, about 60 mils, about 62 mils, about 64 mils, about 66 mils, about 68 mils, or about 70 mils. The thickness of insulative cellular non-aromatic polymeric material 82 may fall within one of many different ranges.

In a first set of ranges, the thickness of insulative cellular non-aromatic polymeric material 82 is one of the following ranges: about 30 mils to about 70 mils, about 30 mils to about 60 mils, about 30 mils to about 58 mils, about 30 mils to about 56 mils or about 30 mils to about 55 mils. In a second set of ranges, the thickness of insulative cellular non-aromatic polymeric material 82 is one of the following ranges: about 32 mils to about 70 mils, about 38 mils to about 70 mils, about 42 mils to about 70 mils, about 46 mils to about 70 mils, or about 48 mils to about 70 mils. In a third set of ranges, the thickness of insulative cellular non-aromatic polymeric material 82 is one of the following ranges: about 32 mils to about 68 mils, about 38 mils to about 68 mils, about 38 mils to about 62 mils, about 42 mils to about 62 mils, about 46 mils to about 62 mils, about 46 mils to about 60 mils, about 46 mils to about 55 mils, or about 48 mils to about 55 mils. In another exemplary embodiment, insulative cellular non-aromatic polymeric material 82 is about 49 mils thick. In yet another exemplary embodiment, insulative cellular non-aromatic polymeric material 82 is about 50 mils thick.

In an embodiment, insulative cellular non-aromatic polymeric material 82 has a density between about 0.13 g/cm³ and about 0.25 g/cm³. Insulative cellular non-aromatic polymeric material 82 may be a particular density. The density of insulative cellular non-aromatic polymeric material 82 may be one of the following values: about 0.13 g/cm³, about 0.14 g/cm³, about 0.15 g/cm³, about 0.16 g/cm³, about 0.17 g/cm³, about 0.18 g/cm³, about 0.19 g/cm³, about 0.2 g/cm³, about 0.21 g/cm³, or about 0.22 g/cm³. The density of insulative cellular non-aromatic polymeric material 82 may fall within one of many different ranges. In first set of ranges, the density of insulative cellular non-aromatic polymeric material 82 is one of the following ranges: about 0.13 g/cm³ to about 0.22 g/cm³, about 0.14 g/cm³ to about 0.2 g/cm³, about 0.15 g/cm³ to about 0.2 g/cm³, about 0.16 g/cm³ to about 0.2 g/cm³, or about 0.17 g/cm³ to about 0.2 g/cm³. In a second set of ranges, the density of insulative cellular non-aromatic polymeric material 82 is one of the following ranges: about 0.13 g/cm³ to about 0.19 g/cm³, about 0.13 g/cm³ to about 0.18 g/cm³, or about 0.13 g/cm³ to about 0.17 g/cm³. In a third a set of ranges, the density of insulative cellular non-aromatic polymeric material 82 is one of the following ranges: about 0.14 g/cm³ to about 0.22 g/cm³, about 0.15 g/cm³ to about 0.21 g/cm³, about 0.16 g/cm³ to about 0.2 g/cm³, about 0.16 g/cm³ to about 0.19 g/cm³, or about 0.16 g/cm³ to about 0.18 g/cm³.

In some embodiments, insulative cellular non-aromatic polymeric material 82 has a certain percentage of closed cells, sometimes called a closed cell performance. In some illustrative embodiments, a higher percentage of closed cells may indicate improved resistance to wicking and/or improved insulative capabilities. In some embodiments, the percentage of closed cells is up to about 100%. In some embodiments, insulative cellular non-aromatic polymeric material 82 has at least about 75%, at least about 80%, or at least about 85% closed cells. In some embodiments, the percentage of closed cells in insulative cellular non-aromatic polymeric material 82 is about 75%, about 80%, about 83%, about 84%, about 85%, about 86%, about 87%, about 90%, about 95%, about 99%, or about 100%. The percentage of closed cells in insulative cellular non-aromatic polymeric material 82 may fall within one of the following ranges: about 75% to about 100%, about 75% to about 99%, about 75% to about 95%, about 80% to about 95%, or about 80% to about 90%. In some embodiments, insulative cellular non-aromatic polymeric material 82 has a closed cell performance of about 85%, about 89%, or about 91%.

Cell counting is a method to measure the number of cells in a given area of insulative cellular non-aromatic polymeric material 82. The cell density, or cell count, may be one of several different values or fall within one of several different ranges. It is within the scope of the present disclosure for the cell count to be at least about 0.7×10⁶ cells/in³, at least about 1×10⁶ cells/in³, at least about 1.4×10⁶ cells/in³, at least about 1.6×10⁶ cells/in³, or at least about 1.8×10⁶ cells/in³. It is within the scope of the present disclosure for the cell count to be one of the following values: about 0.7×10⁶ cells/in³, about 0.8×10⁶ cells/in³, about 1×10⁶ cells/in³, about 1.2×10⁶ cells/in³, about 1.4×10⁶ cells/in³, about 1.6×10⁶ cells/in³, about 1.7×10⁶ cells/in³, about 1.8×10⁶ cells/in³, about 1.9×10⁶ cells/in³, about 2×10⁶ cells/in³, about 2.1×10⁶ cells/in³, about 2.2×10⁶ cells/in³, about 2.3×10⁶ cells/in³, about 2.4×10⁶ cells/in³, about 2.5×10⁶ cells/in³, about 2.6×10⁶ cells/in³, about 2.7×10⁶ cells/in³, about 2.8×10⁶ cells/in³, about 2.9×10⁶ cells/in³, about 3×10⁶ cells/in³, about 3.1×10⁶ cells/in³, about 3.2×10⁶ cells/in³, or about 3.5×10⁶ cells/in³. It is within the scope of the present disclosure for the cell count to be within one of the following ranges: about 0.7×10⁶ cells/in³ to about 3.5×10⁶ cells/in³, about 1×10⁶ cells/in³ to about 3.5×10⁶ cells/in³, about 1×10⁶ cells/in³ to about 3.2×10⁶ cells/in³, about 1×10⁶ cells/in³ to about 3×10⁶ cells/in³, about 1.2×10⁶ cells/in³ to about 3×10⁶ cells/in³, about 1.2×10⁶ cells/in³ to about 2.8×10⁶ cells/in³, about 1.2×10⁶ cells/in³ to about 2.5×10⁶ cells/in³, and about 1.2×10⁶ cells/in³ to about 2.2×10⁶ cells/in³. It is within the scope of the present disclosure for the cell count to be within one of the following ranges: about 0.8×10⁶ cells/in³ to about 2.5×10⁶ cells/in³, about 0.8×10⁶ cells/in³ to about 2×10⁶ cells/in³, or about 1×10⁶ cells/in³ to about 2×10⁶ cells/in³.

Insulative cellular non-aromatic polymeric material 82 can have a particular aspect ratio as measured in the machine direction or in the transverse direction. In some embodiments, insulative cellular non-aromatic polymeric material 82 has an aspect ratio preferable for forming a cup, as described herein. In some embodiments, the aspect ratio is at least about 1.5 or at least about 2 in either the machine direction or the transverse direction. In some embodiments, the aspect ratio is about 1.5 to about 2.7 about 1.8 to about 2.7, or about 2.3 to about 2.7 in either the machine direction or the transverse direction.

### Lamination Layer

In some illustrative embodiments, polymeric-lamination layer 54 extends between and interconnects film layer 56 and insulative cellular non-aromatic polymeric material 82 as shown in FIGS. 3A and 11. Polymeric-lamination layer 54 is formed by extruding a polymeric formulation as shown in FIGS. 1, 4, and 6.

In some embodiments, polymeric-lamination layer 54 is substantially free of an adhesive. In some embodiments, polymeric-lamination layer 54 is substantially free of an epoxy. In some embodiments, polymeric-lamination layer 54 is substantially free of ink. In some other embodiments, polymeric-lamination layer 54 comprises ink. In some embodiments, polymeric-lamination layer 54 comprises regrind, a polypropylene, a polyethylene, a colorant, or a mixture or combination thereof. In some embodiments, polymeric-lamination layer 54 consists of or consists essentially of regrind. In some embodiments, polymeric-lamination layer 54 consists essentially of regrind and 1, 2, 3 or 4 additives.

Polymeric-lamination layer 54 is formed by extruding a polymeric formulation. Polymeric-lamination layer 54 extends between and interconnects strip 82 of insulative cellular non-aromatic polymeric material and film layer 56 as shown in FIG. 3A. It is within the scope of the present disclosure for polymeric-lamination layer to have a thickness. In some embodiments, the thickness of polymeric-lamination layer 54 is up to about 3 mils, up to about 2 mils, or up to about 1.5 mils. In some embodiments, the polymeric-lamination layer 54 may be about 0.2 mils, about 0.4 mils, about 0.6 mils, about 0.8 mils, about 0.9 mils, about 1 mil, about 1.1 mils, about 1.2 mils, about 1.4 mils, about 1.6 mils, about 1.8 mils, about 2 mils, about 2.2 mils, about 2.4 mils, about 2.6 mils, about 2.8 mils, or about 3 mils. In some embodiment, the thickness of the polymeric-lamination layer 54 fall within a range of about 0.2 mils to about 3 mils, about 0.2 mils to about 2 mils, about 0.2 mils to about 1.8 mils, about 0.4 mils to about 1.8 mils, about 0.6 mils to about 1.8 mils, about 0.6 mils to about 1.6 mils, or about 0.8 mils to about 1.4 mils.

In some embodiments, the polymeric formulation for polymeric-lamination layer 54 comprises a polyethylene. Illustratively, the polymeric-lamination layer 54 cooperates with the non-aromatic polymeric material to provide rigidity. In some embodiments, the polyethylene is a polyethylene homopolymer. In some embodiments, the polyethylene homopolymer is DMDA 8007 available from Dow Chemical. In some embodiments, the polymeric formulation for polymeric-lamination layer 65 comprises a blend of HDPE and LDPE. In some embodiments, the HDPE and LDPE are present at a ratio of 1:10 to 1:1 HDPE:LDPE.

It is within the scope of the present disclosure to select an amount of the polyethylene of the polymeric formulation for forming polymeric-lamination layer 54 to be up to about 40%, up to about 50%, up to about 60%, up to about 70%, up to about 75%, up to about 80%, up to about 85%, up to about 90%, up to about 95% by weight of the polymeric formulation, or up to about 99% by weight of the polymeric formulation. It is within the scope of the present disclosure to select an amount of the polyethylene of the polymeric formulation for forming polymeric-lamination layer 54 to be one of the following values: about 10%, about 20%, about 30%, about 40%, about 50%, about 55%, about 60%, about 65%, about 70%, about 75%, about 80%, about 85%, about 90%, about 91%, about 92%, about 93%, about 94%, about 95%, about 96%, about 97%, about 98%, or about 99% by weight of the polymeric formulation. It is within the present disclosure for the amount of the polyethylene of the polymeric formulation for forming polymeric-lamination layer 54 to fall within one of many different ranges. In some embodiments, the polyethylene may be with a range of about 10% to about 100%, about 10% to about 99%, about 25% to about 99%, about 35% to about 99%, about 45% to about 99%, about 50% to about 99%, about 60% to about 99%, about 70% to about 99%, about 70% to about 99%, about 80% to about 99%, about 85% to about 99%, or about 90% to about 95% by weight of the polymeric formulation. In some embodiments, the polymeric formulation is free of polyethylene.

In some embodiments, the polymeric formulation of the polymeric-lamination layer 54 comprises a colorant. The colorant in the polymeric formulation for forming polymeric-lamination layer 54 can be up to about 25%, up to about 20%, up to about 15%, up to about 10%, or up to about 5% by weight of the polymeric formulation. It is within the scope of the present disclosure to select an amount of the colorant of the polymeric formulation for forming polymeric-lamination layer 54 to be one of the following values: about 1%, about 2%, about 3%, about 4%, about 5%, about 6%, about 7%, about 8%, about 9%, about 10%, about 11%, about 12%, about 13%, about 14%, about 15%, about 20%, or about 25% by weight of the polymeric formulation. It is within the present disclosure for the amount of the colorant of the polymeric formulation for forming polymeric-lamination layer 54 to fall within one of many different ranges. In a set of ranges, the range of the colorant of the polymeric formulation for forming polymeric-lamination layer 54 is one of the following ranges: about 1% to about 25%, about 1% to about 15%, about 3% to about 15%, about 5% to about 15%, or about 5% to about 13% by weight of the polymeric formulation.

In some embodiments, the polymeric formulation for polymeric-lamination layer 54 comprises a polypropylene. In some embodiments, the polypropylene is a polypropylene homopolymer. In some embodiments, the polypropylene is virgin material. In some embodiments, the polypropylene homopolymer is ExxonMobil™ PP3155. In some embodiments, the polypropylene is Flint Hills P9H8M-015. In some embodiments, the melt mass-flow rate at 230° C. as measured using ASTM D1238 for the polypropylene is at least 25 g/10 min, at least 30 g/10 min, or at least 35 g/10 min. In some embodiments, the melt mass-flow rate at 230° C. for the polypropylene is less than 60 g/10 min, less than 50 g/10 min, less than about 45 g/10 min, or less than about 40 g/10 min. In some embodiments, the melt mass-flow rate is in a range of about 25 g/10 min to about 50 g/10 min, about 25 g/10 min to about 40 g/10 min, or about 30 g/10 min to about 40 g/10 min. In some embodiments, the melt mass-flow rate at 230° C. is about 36 g/10 min. In some embodiments, the melt mass-flow rate is in a range of about 25 g/10 min to about 60 g/10 min, about 30 g/10 min to about 60 g/10 min, or about 40 g/10 min to about 60 g/10 min. In some embodiments, the melt mass-flow rate at 230° C. is about 53 g/10 min.

It is within the scope of the present disclosure to select an amount of the polypropylene of the polymeric formulation for forming polymeric-lamination layer 54 to be up to about 40%, up to about 50%, up to about 60%, up to about 70%, up to about 75%, up to about 80%, up to about 85%, up to about 90%, or up to about 95% by weight of the polymeric formulation. It is within the scope of the present disclosure to select an amount of the polypropylene of the polymeric formulation for forming polymeric-lamination layer 54 to be one of the following values: about 10%, about 20%, about 30%, about 40%, about 42%, about 43%, about 44%, about 45%, about 46%, about 47%, about 48%, about 49%, about 50%, about 55%, about 60%, about 65%, about 70%, about 75%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, or about 99% by weight of the polymeric formulation. It is within the present disclosure for the amount of the polypropylene of the polypropylene of the polymeric formulation for forming polymeric-lamination layer 54 to fall within one of many different ranges. In a first set of ranges, the range of first polymer in the polymeric formulation for forming polymeric-lamination layer 54 is one of the following ranges: about 40% to about 99%, about 60% to about 99%, about 70% to about 99%, about 75% to about 99%, or about 80% to about 99% by weight of the polymeric formulation. In a second set of ranges, the of the polypropylene of the polymeric formulation for forming polymeric-lamination layer 54 is one of the following ranges: about 40% to about 97%, about 40% to about 95%, about 40% to about 92%, about 40% to about 90%, about 40% to about 70%, about 40% to about 60%, or about 40% to about 50%, by weight of the base resin blend. In a third set of ranges, the polypropylene of the polymeric formulation for forming polymeric-lamination layer 54 is one of the following ranges: about 50% to about 99%, about 50% to about 95%, about 60% to about 95%, about 65% to about 95%, about 65% to about 90%, about 70% to about 90%, about 75% to about 90%, or about 75% to about 85% by weight of the polymeric formulation.

In some embodiments, the polymeric formulation for polymeric-lamination layer 54 comprises a polyethylene. In some embodiments, the polyethylene is a low-density polyethylene or a high-density polyethylene. In some embodiments, the low-density polyethylene is Dow™ 4012 low-density polyethylene. In some embodiments, the high-density polyethylene is Dow DMDA 8007 HDPE. In some embodiments, the melt mass-flow rate at 190° C. as measured using ASTM D1238 for the polyethylene is at least 5 g/10 min, at least 10 g/10 min, or at least 12 g/10 min. In some embodiments, the melt mass-flow rate at 190° C. for the polyethylene is less than 30 g/10 min, less than about 25 g/10 min, or less than about 20 g/10 min. In some embodiments, the melt mass-flow rate for the polyethylene is in a range of about 5 g/10 min to about 30 g/10 min, about 5 g/10 min to about 25 g/10 min, or about 5 g/10 min to about 20 g/10 min. In some embodiments, the melt mass-flow rate for the polyethylene at 190° C. is about 12 g/10 min. In some embodiments, the polymeric formulation for polymeric-lamination layer 54 is substantially free of polyethylene.

It is within the scope of the present disclosure to select an amount of the polyethylene of the polymeric formulation for forming polymeric-lamination layer 54 to be up to about 100%, up to about 98%, up to about 95%, up to about 90%, up to about 80%, up to about 70%, up to about 60%, up to about 50%, up to about 40%, up to about 35%, up to about 30%, up to about 25%, up to about 20%, or up to about 15% by weight of the polymeric formulation. It is within the scope of the present disclosure to select an amount of the polyethylene of the polymeric formulation for forming polymeric-lamination layer 54 to be one of the following values: about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 25%, about 30%, about 35%, about 40%, about 45%, about 50%, about 55%, about 60%, about 70%, about 75%, about 80%, about 85%, about 90%, about 95%, about 99%, or about 100% by weight of the polymeric formulation. It is within the present disclosure for the amount of the polyethylene of the polymeric formulation for forming polymeric-lamination layer 54 to fall within one of many different ranges. In a first set of ranges, the range of the polyethylene of the polymeric formulation for forming polymeric-lamination layer 54 is one of the following ranges: about 1% to about 100%, about 70% to about 100%, about 80% to about 100%, about 90% to about 100%, or about 90% to about 95% by weight of the polymeric formulation. In another set of ranges, the polyethylene may be about 1% to about 60%, about 3% to about 60%, about 3% to about 60%, about 5% to about 60%, or about 10% to about 60% by weight of the polymeric formulation. In a second set of ranges, the range of the polyethylene of the polymeric formulation for forming polymeric-lamination layer 54 is one of the following ranges: about 1% to about 55%, about 1% to about 50%, about 1% to about 40%, about 1% to about 30%, or about 10% to about 20% by weight of the polymeric formulation. In a third set of ranges, the range of the polyethylene of the polymeric formulation for forming polymeric-lamination layer 54 is one of the following ranges: about 2% to about 60%, about 2% to about 50%, about 2 to about 40%, about 2% to about 30%, about 5% to about 30%, about 5% to about 25%, about 10% to about 25%, or about 10% to about 20% by weight of the polymeric formulation.

In some embodiments, the polymeric formulation for forming polymeric-lamination layer 54 comprises a colorant. The colorant in the polymeric formulation for forming polymeric-lamination layer 54 can be up to about 25%, up to about 20%, up to about 15%, up to about 10%, or up to about 5% by weight of the polymeric formulation. It is within the scope of the present disclosure to select an amount of the colorant of the polymeric formulation for forming polymeric-lamination layer 54 to be one of the following values: about 1%, about 2%, about 3%, about 4%, about 5%, about 6%, about 7%, about 8%, about 9%, about 10%, about 11%, about 12%, about 13%, about 14%, about 15%, about 20%, or about 25% by weight of the polymeric formulation. It is within the present disclosure for the amount of the colorant of the polymeric formulation for forming polymeric-lamination layer 54 to fall within one of many different ranges. In a set of ranges, the range of the colorant of the polymeric formulation for forming polymeric-lamination layer 54 is one of the following ranges: about 1% to about 25%, about 1% to about 15%, about 3% to about 15%, about 3% to about 10%, about 5% to about 15%, or about 5% to about 13% by weight of the polymeric formulation.

In some embodiments, the polymeric formulation comprises regrind as described herein. Regrind may comprise post-consumer recycled products. Regrind may be formed by recovering the excess material, sometimes called a blank-carrier sheet 94, produced during a blank forming step 150, as shown in FIG. 1. Regrind can be processed during a regrinding step 190 that grinds blank-carrier sheet 94 into pellets 97. In some embodiments, pellets 97 can be melted and re-pelletized prior to being added to a polymeric formulation. In some embodiments, the regrind is regrind polypropylene, polyethylene, or a combination thereof. In some illustrative embodiments, the regrind comprises post-consumer regrind.

In some embodiments, the polymeric formulation for forming polymeric-lamination layer 54 comprises regrind. The regrind in the polymeric formulation for forming polymeric-lamination layer 54 can be up to about 25%, up to about 45%, up to about 60%, up to about 80%, up to about 90%, or up to about 99% by weight of the polymeric formulation. It is within the scope of the present disclosure to select an amount of regrind of the polymeric formulation for forming polymeric-lamination layer 54 to be one of the following values: about 1%, about 5%, about 10%, about 15%, about 20%, about 25%, about 30%, about 35%, about 40%, about 41%, about 42%, about 43%, about 44%, about 45%, about 46%, about 47%, about 48%, about 49%, about 50%, about 55%, about 60%, about 65%, about 70%, about 75%, about 80%, about 85%, about 90%, about 95%, about 96%, or about 99% by weight of the polymeric formulation. It is within the present disclosure for the amount of regrind of the polymeric formulation for forming polymeric-lamination layer 54 to fall within one of many different ranges. In a set of ranges, the range of regrind of the polymeric formulation for forming polymeric-lamination layer 54 is one of the following ranges: about 1% to about 99%, about 5% to about 99%, about 5% to about 75%, about 15% to about 75%, about 20% to about 70%, about 25% to about 70%, about 25% to about 60%, about 35% to about 60% or about 35% to about 55% by weight of the polymeric formulation. In another set of ranges, the regrind maybe about 80% to about 100%, about 85% to about 100%, about 85% to about 98%, or about 90% to about 98% by weight of the formulation. In some embodiments, the ratio of regrind and virgin polymeric resin is about 1:1.

In some embodiments, regrind comprises ink. In some embodiments, the ink is from ink layer 66. In some embodiments, regrind is substantially free of ink. In some embodiments, the regrind may comprise polypropylene, polyethylene, a physical nucleating agent, a slip agent, or a combination thereof. In some embodiments, the regrind may comprise at least one polyethylene, a physical nucleating agent, a slip agent, or a combination thereof. Illustratively, regrind is substantially free of an adhesive. In some embodiments, regrind is substantially free of an epoxy. In some embodiments, regrind comprises a polyethylene and BOPP.

In some embodiments, the polymeric formulation for forming polymeric-lamination layer 54 comprises an additive. The additive may improve the processability of the performance of the polymeric-lamination layer. In some embodiments, the additive is present up to about 10% or up to about 5% by weight of the formulation. Illustrative additives include crystallinity modifiers such as Milliken Ultrabalance 1001.

### Film Layer

Film layer 56 is laminated onto polymeric-lamination layer 54 as shown in FIGS. 3A and B. In some embodiments, film layer 56 comprises a polymeric film. Illustratively, a suitable polymeric film will be a film that cooperates with and couples with polymeric-lamination layer 54. In some embodiments, the film comprises a polypropylene, a polyethylene, or a mixture thereof. In some embodiments, the film comprises a polypropylene. In some embodiments, the polypropylene is a bi-axially oriented polypropylene (BOPP). In some embodiments, the film is a single layer film. In some embodiments, the film is a multi-layer film. In some embodiments, the film comprises a polyethylene or consists of polyethylene. In some embodiments, the film comprises Elite 5960G available from Dow Chemical.

It is within the scope of the present disclosure for film layer 56 to have a thickness. In some embodiments, the thickness of film layer 56 is up to about 3 mils, up to about 2 mils, or up to about 1.5 mils. In some embodiments, the film layer 56 may be about 0.2 mils, about 0.4 mils, about 0.6 mils, about 0.8 mils, about 0.9 mils, about 1 mil, about 1.1 mils, about 1.2 mils, about 1.4 mils, about 1.6 mils, about 1.8 mils, about 2 mils, about 2.2 mils, about 2.4 mils, about 2.6 mils, about 2.8 mils, or about 3 mils. In some embodiment, the thickness of the film layer 56 fall within a range of about 0.2 mils to about 3 mils, about 0.2 mils to about 2 mils, about 0.2 mils to about 1.8 mils, about 0.4 mils to about 1.8 mils, about 0.6 mils to about 1.8 mils, about 0.6 mils to about 1.6 mils, or about 0.8 mils to about 1.4 mils.

In some embodiments, film layer 56 has been printed on. In some embodiments, the print comprises ink. In some embodiments, the ink is located between film layer 56 and polymeric-lamination layer 54. In some embodiments, the ink is located on an outward surface 106 of multi-layer sheet 80.

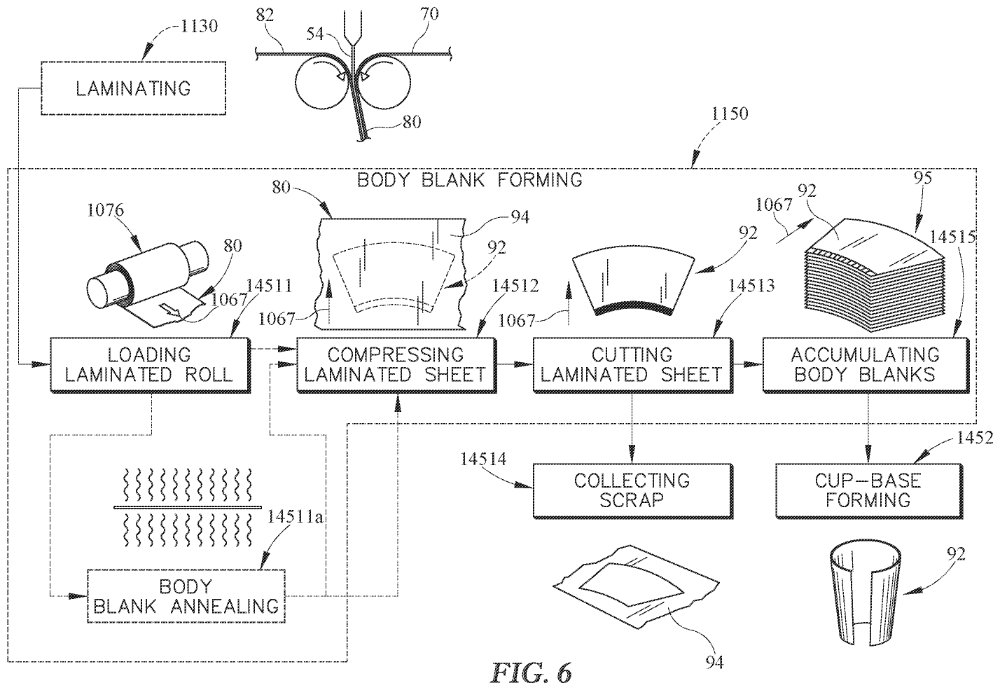

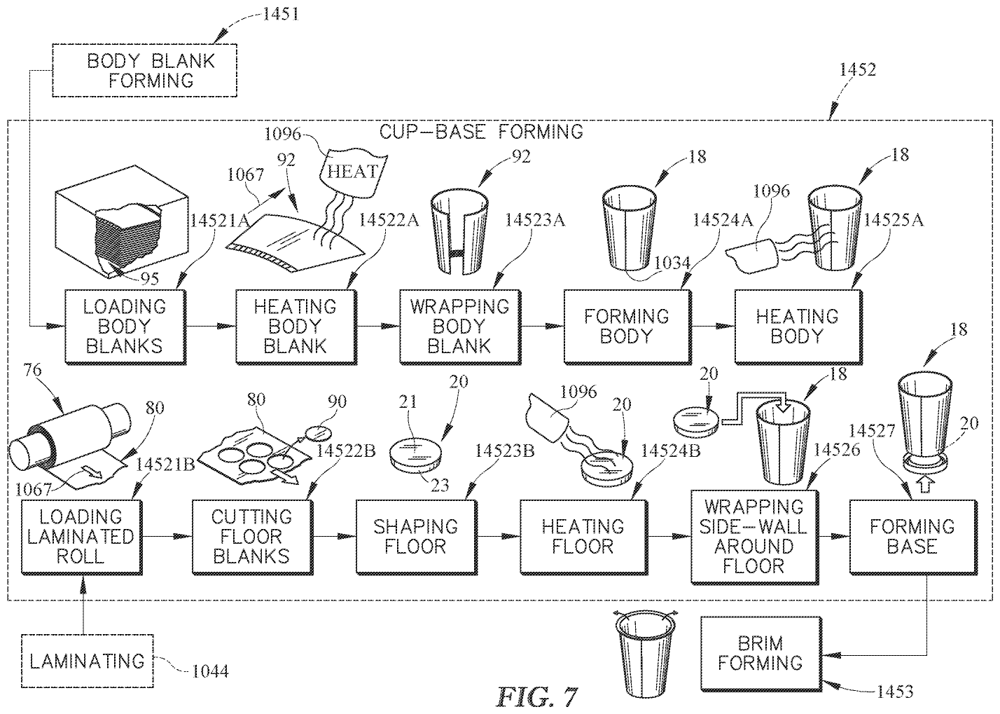

In some embodiments, multi-layer sheet 80 may be used to form insulative cup 10 as shown in FIG. 1. Insulative cup 10 includes a body 11 having a sleeve-shaped side wall 18 and a floor 20 as shown in FIGS. 4 and 6. Floor 20 is coupled to body 11 and cooperates with side wall 18 to form an interior region 14 therebetween for storing food, liquid, or any suitable product. Body 11 also includes a rolled brim 16 coupled to an upper end of side wall 18 and a floor mount 17 interconnecting a lower end of side wall 18 and floor 20 as shown in FIG. 7.

Insulative cellular non-aromatic polymeric material 82 is configured in accordance with the present disclosure to provide means for enabling localized plastic deformation in at least one selected region of body 11 (e.g., side wall 18, rolled brim 16, floor mount 17, and a floor-retaining flange 26 included in floor mount 17) to provide (1) a plastically deformed first material segment having a first density in a first portion of the selected region of body 11 and (2) a second material segment having a relatively lower second density in an adjacent second portion of the selected region of body 11 as suggested, for example, in FIGS. 4 and 6-11. In illustrative embodiments, the first material segment is thinner than the second material segment.

One aspect of the present disclosure provides a formulation for manufacturing an insulative cellular non-aromatic polymeric material 82. As referred to herein, an insulative cellular non-aromatic polymeric material 82 refers to an extruded structure having cells formed therein and has desirable insulative properties at given thicknesses. Another aspect of the present disclosure provides a polymeric formulation for manufacturing an extruded structure of insulative cellular non-aromatic polymeric material. Still another aspect of the present disclosure provides an extrudate comprising an insulative cellular non-aromatic polymeric material. Yet another aspect of the present disclosure provides a structure of material formed from an insulative cellular non-aromatic polymeric material. A further aspect of the present disclosure provides a container formed from an insulative cellular non-aromatic polymeric material.

Illustratively, each of insulative cellular non-aromatic polymeric material 82, polymeric-lamination layer 54, and film layer 56 comprise a polymeric material. The polymeric material for each of insulative cellular non-aromatic polymeric material 82, polymeric-lamination layer 54, and film layer 56 can be made, for example, by extruding a formulation. It should be understood that many of the ranges described herein for the formulation apply with equal weight to the extruded polymeric material, except that in some examples the chemical nucleating agent will decompose upon heating. The decomposition of the chemical nucleating agent could cause the relative weight percentages of the remaining components to increase slightly.

### Cup Forming Process

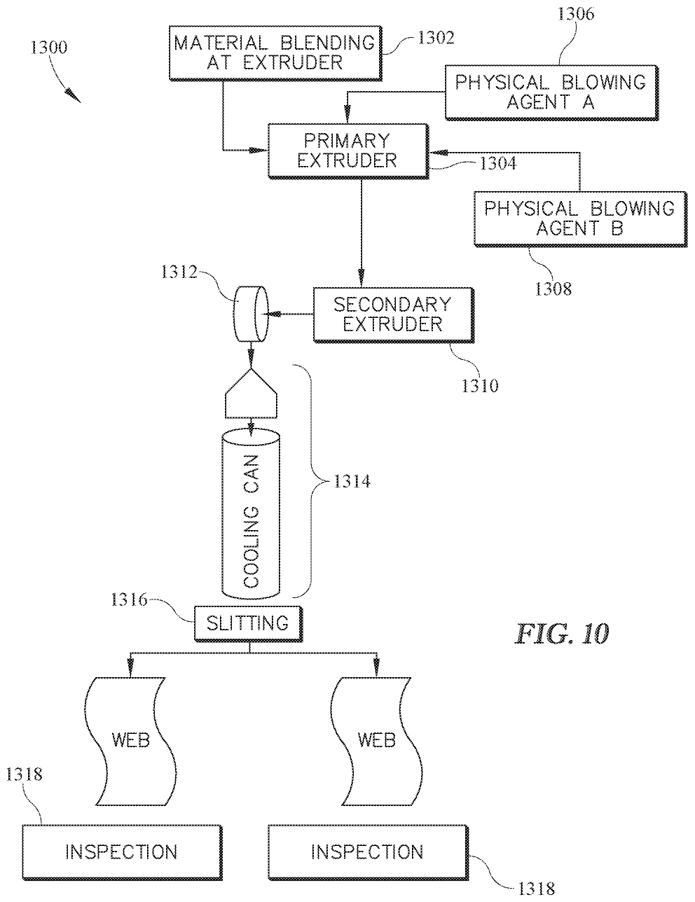

A cup-manufacturing process 1040 comprising a process for forming an insulative cup 10 having artwork on a skin 70 laminated onto a insulative cellular non-aromatic polymeric material 82 in accordance with the present disclosure is shown, for example, in FIGS. 4-9. An insulative cup 10 in accordance with the present disclosure is shown, for example, in FIGS. 1, 5, and 13. Insulative cup 10 is made from a multi-layer sheet 80 formed during cup-manufacturing process 1040 as suggested in FIGS. 4-9. As an example, multi-layer sheet 80 includes a skin 70, a polymeric-lamination layer 54, and a strip 82 of insulative cellular non-aromatic polymeric material as shown in FIGS. 3A, B. Another embodiment of a multi-layer sheet 180 in accordance with the present disclosure is shown in FIG. 10. Two embodiments of a strip-formation stage are shown, for example, in FIGS. 4 and 10.

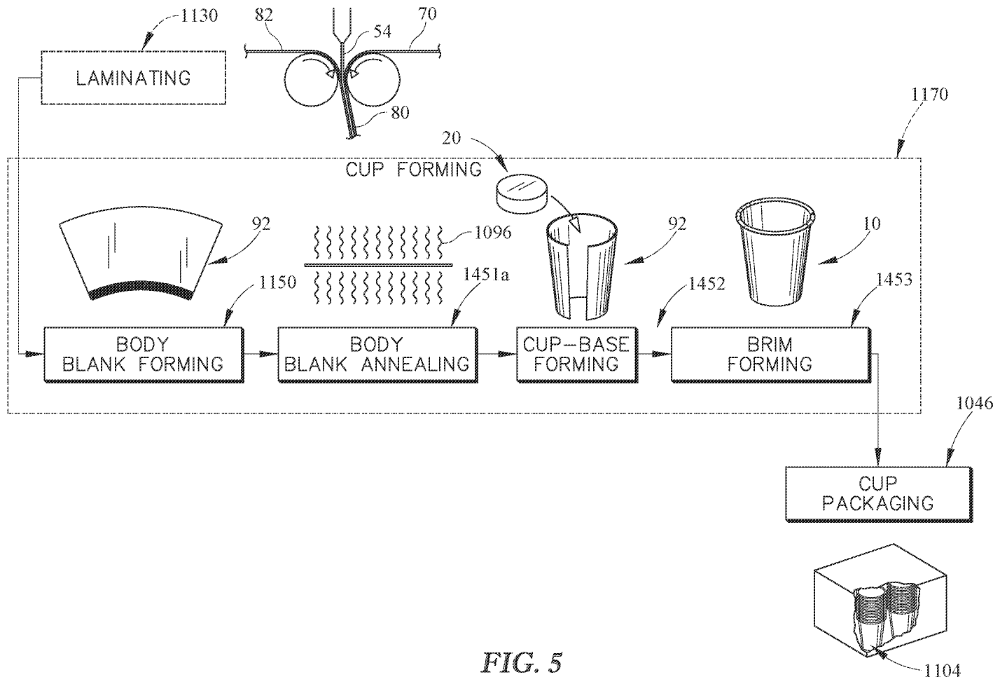

Cup-manufacturing process 1040 includes a strip-forming stage 1041, a film-layer forming stage 1042, a film-layer printing stage 1043, a laminating stage 1130, and a cup-forming stage 1170 as shown, for example, in FIG. 5. Strip-forming stage 1041 forms and provides a strip 82 of insulative cellular non-aromatic polymeric material as suggested in FIG. 5. Film-layer forming stage 1042 forms and provides a film layer 56. Film-layer printing stage 1043 prints graphics and text 1066 on film layer 56 to provide a printed film 70 as shown in FIG. 5. Laminating stage 1130 laminates printed film 70 to strip 82 of insulative cellular non-aromatic polymeric material to form a multi-layer sheet 80. Cup-forming stage 1170, also called a converting step, forms insulative cup 10 from sheet 80 as shown for example in FIGS. 6-9.

Insulative cup 10 includes, for example, a body 11 having a sleeve-shaped side wall 18 and a floor 20 as shown in FIGS. 13-20. Floor 20 is coupled to body 11 and cooperates with side wall 18 to form an interior region 14 therebetween for storing food, liquid, or any suitable product. Body 11 also includes a rolled brim 16 coupled to an upper end of side wall 18 and a floor mount 17 coupled to a lower end of side wall 18 and to floor 20 as shown in FIG. 15.

Insulative cellular non-aromatic polymeric material is configured in accordance with the present disclosure to provide means for enabling localized plastic deformation in at least one selected region of body 11 (e.g., side wall 18, rolled brim 16, floor mount 17, and a floor-retaining flange 26 included in floor mount 17) to provide (1) a plastically deformed first material segment having a first density in a first portion of the selected region of body 11 and (2) a second material segment having a relatively lower second density in an adjacent second portion of the selected region of body 11 as suggested, for example, in FIGS. 13 and 17-20. In illustrative embodiments, the first material segment is thinner than the second material segment.

Insulative cup 10 is made of a multi-layer sheet 80 as suggested in FIG. 1. Sheet 80 comprises a strip 82 of insulative cellular non-aromatic polymeric material 82 laminated with a skin 70 having film layer 56 and ink layer 66 printed on film layer 56 to provide a cup having high-quality graphics as suggested, for example, in FIG. 4.

Film layer 56 is formed and provided by film-layer forming stage 1042 as shown in FIG. 4. Film layer 56 is then printed with an ink layer 66 during film-layer printing stage 1043. As an example, ink layer 66 includes graphics and the graphics are shown on insulative cup 10 as a pair of triangles in FIG. 4. However, graphics may be another suitable graphic such as, but not limited to, symbols, text, photographs, images, combinations thereof, and the like, and may be in black and white or in color.

Film-layer printing stage 1043 uses a printer 1064 to print ink layer 66 on film layer 56 to provide printed film 70 as shown in FIG. 4. Printing may be done using conventional flexography, which is a form of printing that uses flexible rubber relief plates and highly volatile, fast-drying inks to print on a variety of substrates, including films of the type used as film layer 56. In particular, printing may be done using an in-line, central impression flexographic printing station. Alternatively, printing processes such as rotogravure may be used.

Central impression presses use a large-diameter common impression cylinder to carry the web around to each color station. The advantage of such a press is the ease of maintaining proper registration. The use of larger impression cylinders (i.e., up to 83 inches in diameter) has, in the past, led to an increase in press speed, but as drying methods have improved there is no longer a strict correlation between larger impression cylinders and increased speed. In-line presses are a type of multi-color press in which separate color stations are mounted in a horizontal line from front to back. They can handle a wider variety of web widths than can stack presses, and can also make use of turning bars to flip the web over, allowing easy reverse printing.

Two examples of the type of in-line, central impression flexographic printing stations which may be used in film-layer printing stage 1043 are the XD and XG series of presses available from the Flexotecnica division of North American Cerutti Corporation in Milwaukee, WI. Standard press widths are available from 32-60 inches (800-1525 mm) wide. Standard repeats are available at 30 (760), 33 (840) and 43(1100) inches (mm). Extra large or Mega models of presses are available up to 83 inches (2100 mm) wide with 75 inch (1900 mm) repeats. Line speeds are available up to 1600 fpm (500 mpm), and they may be equipped with an in-line vision for registration. They may include up to ten color stations.

The highly volatile, fast-drying inks, which may be used in the printing of graphics, are radiation-curing inks that dry or set with the application of ultraviolet light. ultraviolet curing ink vehicles are typically composed of fluid oligomers (i.e., small polymers), monomers (i.e., light-weight molecules that bind together to form polymers), and initiators that, when exposed to ultraviolet radiation, release free radicals (i.e., extremely reactive atoms or molecules that can destabilize other atoms or molecules and start rapid chain reactions) that cause the polymerization of the vehicle, which hardens to a dry ink film containing the pigment.

The most common configuration of ultraviolet curing equipment is a mercury vapor lamp. Within a quartz glass tube containing charged mercury, energy is added, and the mercury is vaporized and ionized. As a result of the vaporization and ionization, the high-energy free-for-all of mercury atoms, ions, and free electrons results in excited states of many of the mercury atoms and ions. As they settle back down to their ground state, radiation is emitted. By controlling the pressure that exists in the lamp, the wavelength of the radiation that is emitted can be somewhat accurately controlled, the goal being to ensure that much of the radiation that is emitted falls in the ultraviolet portion of the spectrum, and at wavelengths that will be effective for ink curing. Ultraviolet radiation with wavelengths of 365 to 366 nanometers provides the proper amount of penetration into the wet ink film to effect drying. Another variation of radiation-curing inks, which may be used in the printing of graphics, are electron-beam curing inks. The formulation of such inks is less expensive than ultraviolet curing inks, but the electronic-beam curing equipment is more expensive.

Printed film 70 is produced by film-layer printing stage 1043 and provided to laminating stage 1130 as shown, for example, in FIG. 4. During laminating stage 1130, a polymeric-lamination layer 54 is extruded between strip of insulative cellular non-aromatic polymeric material 82 and printed film layer 70 to form sheet 80 as suggested in FIGS. 1, 5, and 6. As an example, sheet 80 is wound to form a roll 78, which is stored for use later in cup-forming stage 1170. However, sheet 80 may be fed directly without storage to cup-forming stage 1170.

An insulative cellular non-aromatic polymeric material produced in accordance with the present disclosure can be formed to produce an insulative cup 10 as suggested in FIGS. 5-9. As an example, the insulative cellular non-aromatic polymeric material comprises base resin blend an HDPE, an LDPE, and cell-forming agents including at least one physical nucleating agent and a physical blowing agent such as carbon dioxide. As a further example, the insulative cellular non-aromatic polymeric material further comprises a slip agent.

Insulative cellular non-aromatic material is used during cup-manufacturing process 1040 to make insulative cup 2010 as suggested in FIGS. 5-9. Reference is hereby made to U.S. application Ser. No. 13/491,007 filed Jun. 7, 2012, and titled INSULATED CONTAINER for disclosure relating to an insulative container made from an insulative cellular non-aromatic polymeric material, which application is hereby incorporated in its entirety herein.

Insulative cup 10 is formed using strip 82 of insulative cellular non-aromatic polymeric material in cup-manufacturing process 1040 as shown in FIGS. 4-9. Insulative cup 10 includes, for example, body 11 having sleeve-shaped side wall 2018 and a floor 20 coupled to body 11 to cooperate with the side wall 18 to form an interior region 14 for storing food, liquid, or any suitable product as shown in FIG. 1. Body 11 also includes a rolled brim 16 coupled to an upper end of side wall 18 and a floor mount 17 coupled to a lower end of side wall 18 and to the floor 20 as illustrated in FIGS. 13 and 15.

In some illustrative embodiments, polymeric-lamination layer 54 extends between and interconnects film layer 56 and insulative cellular non-aromatic polymeric material 82 as shown in FIGS. 3A and 11. Polymeric-lamination layer 54 is formed by extruding a polymeric formulation as shown in FIGS. 1 and 4-6.

Strip-forming stage 1041 of cup-manufacturing process 1040 provides strip 82 of insulative cellular non-aromatic polymeric material as shown in FIG. 2. In one illustrative example, strip-forming stage 1041 uses a polyethylene-based formulation in accordance with the present disclosure to produce strip 82 of insulative cellular non-aromatic polymeric material as shown in FIG. 2. Formulation 121 is heated and extruded in two stages to produce a tubular extrudate 124 that can be slit to provide strip 82 of insulative cellular non-aromatic polymeric material as illustrated, for example, in FIG. 2. A blowing agent in the form of a liquefied inert gas is introduced into a molten resin 122 in the first extrusion zone. As an example, strip-forming stage 1041 uses a tandem-extrusion technique in which a first extruder 111 and a second extruder 112 cooperate to extrude strip 82 of insulative cellular non-aromatic polymeric material.

Strip-forming stage 1041 of cup-manufacturing process 1040 provides strip 82 of insulative cellular non-aromatic polymeric material as shown in FIG. 5. As shown in FIG. 5, a formulation 121 of insulative cellular non-aromatic polymeric material is loaded into a hopper 113 that is coupled to first extruder 111. Formulation 121 of insulative cellular non-aromatic polymeric material is moved from hopper 113 by a screw 114 included in first extruder 111. Formulation 121 is transformed into a molten resin 122 in a first extrusion zone of first extruder 111 by application of heat 105 and pressure from screw 114 as suggested in FIG. 5.

In exemplary embodiments, a physical blowing agent may be introduced and mixed into molten resin 122 after molten resin 122 is established. In exemplary embodiments, as discussed further herein, the physical blowing agent may be a gas introduced as a pressurized liquid via a port 115A and mixed with molten resin 122 to form a molten extrusion resin mixture 123, as shown in FIG. 5.

Extrusion resin mixture 123 is conveyed by screw 114 into a second extrusion zone included in second extruder 112 as shown in FIG. 5. There, extrusion resin mixture 123 is further processed by second extruder 112 before being expelled through an extrusion die 116 coupled to an end of second extruder 112 to form an extrudate 124. As extrusion resin mixture 123 passes through extrusion die 116, gas comes out of solution in extrusion resin mixture 123 and begins to form cells and expand so that extrudate 124 is established. As an example, strip-forming stage 1041 uses a tandem-extrusion technique in which first and second extruders 111, 112 cooperate to extrude strip 2082 of insulative cellular non-aromatic polymeric material.

As an exemplary embodiment shown in FIG. 5, the extrudate 124 may be formed by an annular extrusion die 116 to form a tubular extrudate 124. A slitter 117 then cuts extrudate 124 to establish strip 82 of insulative cellular non-aromatic polymeric material as shown in FIG. 5.

Extrudate means the material that exits an extrusion die. The extrudate material may be in a form such as, but not limited to, a sheet, strip, tube, thread, pellet, granule or other structure that is the result of extrusion of a polymer-based formulation as described herein through an extruder die. For the purposes of illustration only, a sheet will be referred to as a representative extrudate structure that may be formed but is intended to include the structures discussed herein. The extrudate may be further formed into any of a variety of final products, such as, but not limited to, cups, containers, trays, wraps, wound rolls of strips of insulative cellular non-aromatic polymeric material, or the like.

As an example, strip 82 of insulative cellular non-aromatic polymeric material is wound to form a roll of insulative cellular non-aromatic polymeric material and stored for later use either in a cup-forming process. However, it is within the scope of the present disclosure for strip 82 of insulative cellular non-aromatic polymeric material to be used in-line with the cup-forming process.

As shown in FIGS. 3A, B, multi-layer sheet 80 is a composite formed of strip 82 of insulative cellular non-aromatic polymeric material onto which skin 70 is laminated at a laminating stage 1130. Polymeric-lamination layer 54 is extruded between strip 82 of insulative cellular non-aromatic material and film layer 56 to couple the layers together and form multi-layer sheet 80. In some embodiments, film layer 56 is bonded to polymeric-lamination layer 54 when polymeric-lamination layer 54 is about 400° F.

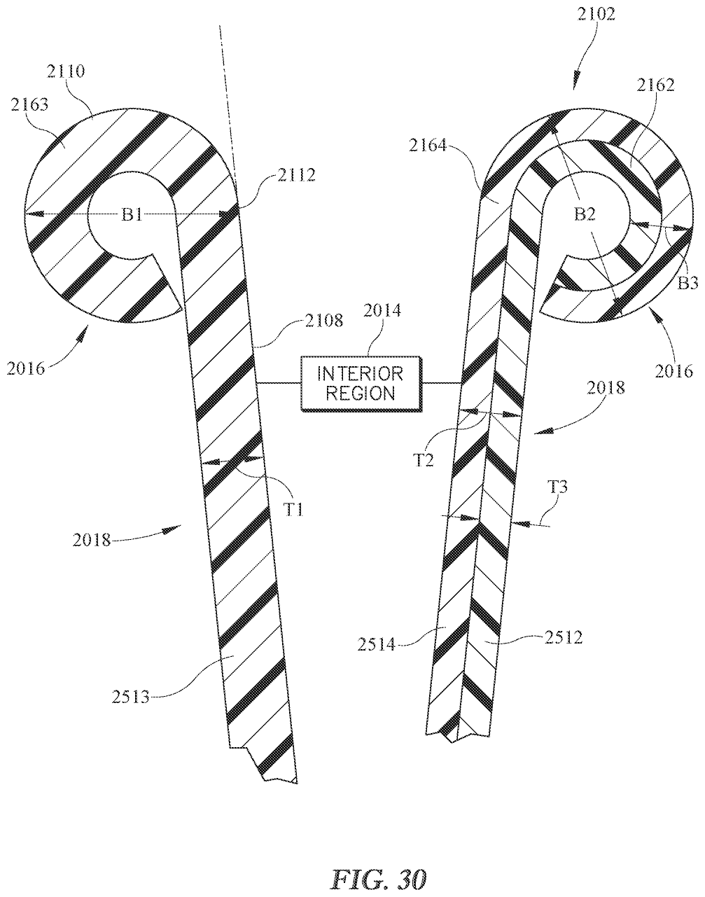

As an example, multi-layer sheet 80 is fed from roll 78 to the cup-forming stage 1170 as suggested in FIG. 4 and shown in FIG. 5. Cup-forming stage 1170 illustratively includes a body blank forming step 1150, an optional body blank annealing step 1451a, a cup-base forming step 1452, and a brim-forming step 1453 as shown in FIG. 5. Body blank forming step 1150 uses laminated sheet 80 to make a body blank 92 as shown in FIG. 6. Cup-base forming step 1452 uses body blanks 92 along with another laminated sheet 80 provided by another laminated roll 1076 to form a floor blank 90, form side wall 18, and join side wall 18 to floor 20 to establish base 12 as suggested in FIG. 7. Brim-forming step 1453 rolls top portion 22 of base 12 to form rolled brim 16 on base 12 as suggested in FIG. 30.

Body blank forming step 1150 includes a laminated-roll loading step 14511, an optional annealing step 14511a, a compressing step 21512, a cutting step 14513, a collecting scrap step 14514, and an accumulating blanks step 14515 as shown in FIG. 6. Laminated-roll loading step 14511 loads laminated roll 1076 onto a cutting machine such as a die cutting machine or metal-on-metal stamping machine. As a result, laminated sheet 80 is drawn into the cutting machine for processing in machine direction 1067. The optional annealing step 14511a heats laminated sheet 80 as it moves to the cutting machine so that stresses in the non-aromatic polymer structure of laminated sheet 80 are released to reduce creasing and wrinkling in surfaces 106 and 108 of insulative cup 10. In some embodiments, collecting scrap step 5414 includes repelletizing the scrap to form regrind.

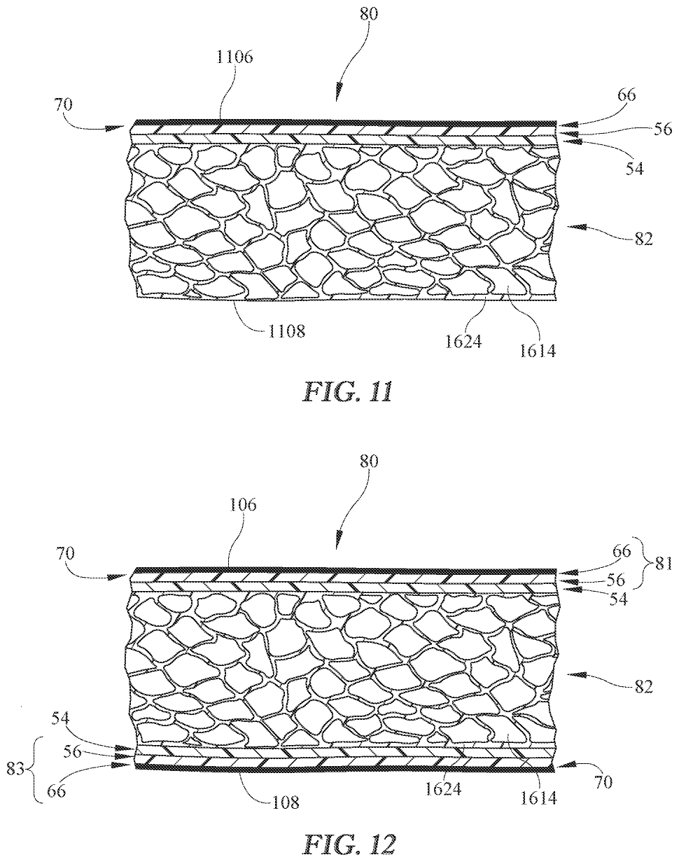

An unexpected property of sheet 80 including strip 82 of insulative cellular non-aromatic polymeric material is its ability to form noticeably smooth, crease, and wrinkle free surfaces when bent to form a round article, such as insulative cup 10. Surface 106 is smooth and wrinkle free as is surface 108 as shown in FIGS. 11 and 12. The smoothness of the surfaces 106 and 108 of the present disclosure is such that the depth of creases or wrinkles naturally occurring when subjected to extension and compression forces during cup-manufacturing process 1040 is less than about 100 microns and even less than about 5 microns in most instances. At less than about 10 microns, the creases or wrinkles are not visible to the naked eye.

One possible reason for greater compressibility of an extruded strip with cells having aspect ratio below about 2.5 or about 2 in the direction of cup circumference, such as in the cross direction, could be due to lower stress concentration for cells with a larger radius. Another possible reason may be that the higher aspect ratio of cells might mean a higher slenderness ratio of the cell wall, which is inversely proportional to buckling strength. Folding of the strip into wrinkles in the compression mode could be approximated as buckling of cell walls. For cell walls with a longer length, the slenderness ratio (length to diameter) may be higher. Yet another possible factor in relieving compression stress might be a more favorable polymer chain packing in cell walls in the cross direction allowing polymer chain re-arrangements under compression force. Polymer chains are expected to be preferably oriented and more tightly packed in machine direction 1067.

It has been found during development of the present disclosure that if the circumference of insulative cup 10 is aligned with the machine direction 1067 of strip 82 of insulative cellular non-aromatic polymeric material, deep creases with a depth in excess of about 200 microns are typically formed on surface 108. Unexpectedly, it has been determined that if the circumference of insulative cup 10 is aligned generally perpendicular to machine direction 67, no deep creases are formed on surface 108, indicating that the cross-direction to machine direction 1067 of extruded insulative cellular non-aromatic polymeric material is resistant to compression forces during formation of insulative cup 10. It is believed that this is a result of the orientation of the polymer chains of extruded insulative cellular non-aromatic polymeric material, which are oriented and more tightly packed in machine direction 1067.

As an example, equipment may be arranged such that rolled brim 16 of insulative cup 10 is arranged to be the cross direction during body blank forming step 1150. After sheet 80 is provided, compressing step 14512 compresses portions of sheet 1080 to form a compressed sheet, as shown in FIG. 6. Cutting step 14513 cuts compressed sheet to cause body blank 92 to be cut from a blank-carrier sheet 94. Collecting scrap step 14514 collects blank-carrier sheet 94 after cutting step 14513 is complete so that blank-carrier sheet 94 may be recycled. Accumulating blanks step 14515 accumulates each body blank 92 to form a body blank stack 95 for use in cup-base forming step 1452 as shown in FIG. 6. As another example, compressing step 14512 and cutting step 14513 may be combined such that they are performed generally at the same time by the same piece of equipment.

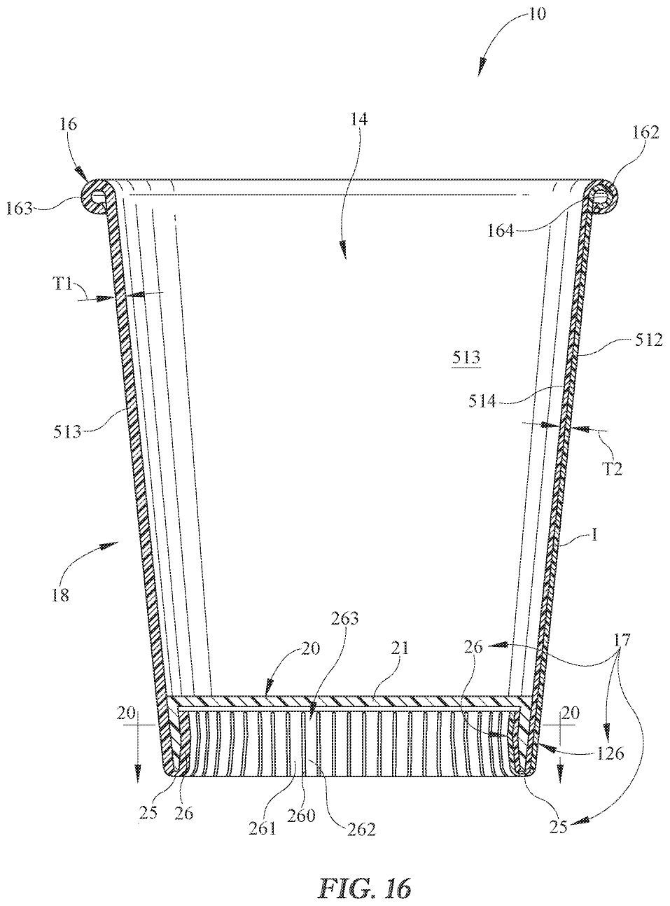

Cup-base forming step 1452 includes a body blanks loading step 14521A, a heating body blank step 14522A, a wrapping body blank step 14523A, a forming body step 14524A, a laminated-roll loading step 14521B, a cutting floor blanks step 14522B, a shaping floor step 14523B, a heating floor step 14524B, a heating body step 14525A, a wrapping body step 14526, and a floor-seam forming step 14527 as shown in FIG. 7. Body blanks loading step 14521A loads body blank stack 95 into a cup-forming machine for further processing. Heating body blank step 14522A applies heat 1096 to body blank 92. Wrapping body blank step 14523A wraps heated body blank 92 around a mandrel included in the cup-forming machine. Forming body step 14524A forms body 11 by compressing portions of side wall 18 using primary and auxiliary seam clamps included in the cup-forming machine. Primary and auxiliary seam clamps provide localize compression, which results in a portion of side wall 18 having thickness T2 and another portion having thickness T1 as shown in FIG. 16. As an example, thickness T2 is about equal to thickness T1.

Laminated-roll loading step 14521B loads another laminated roll 76 onto the cup-forming machine to cause laminated sheet 80 to be drawn into the cup-forming machine for processing, as shown in FIG. 7. Cutting floor blanks step 14522B cuts laminated sheet 80 to cause floor blank 90 to be cut from a blank-carrier sheet 94. Blank-carrier sheet 94 may then be collected and recycled, as shown in FIG. 6. Shaping floor step 14523B forms floor 20 by inserting floor blank 90 into the mandrel of the cup-forming machine. Heating floor step 14524B applies heat 1096 to floor 20 at the same time heating body step 14525A applies heat 1096 to side wall 18. Wrapping body 14526 wraps support structure 1019 around platform-support member 23 of floor 20. Floor-seam forming step 14527 compresses floor 20 and side wall 18 to establish a floor seam or seal between floor 20 and side wall 18 to establish base 12 which is then ready for brim-forming step 1453 as shown in FIG. 7.

Cup-base forming step 1452 maintains the thickness T1 of the side wall 18 as compared to a thermoforming process. Rather than heating an insulative cellular non-aromatic polymeric material and working it over a mandrel in the thermoforming process, subjecting portions of the wall of the resulting cup to thinning and potentially reducing the insulative and structural properties thereof, cup-base forming step 1452 is an assembly process that does not require most of the entire side wall 18 to be subjected to melting temperatures. This provides the advantage of maintaining consistency in thickness T1 of side wall 18 and, thereby, consistent and maximized insulating properties as compared to vessels subjected to a deep draw thermoforming process.

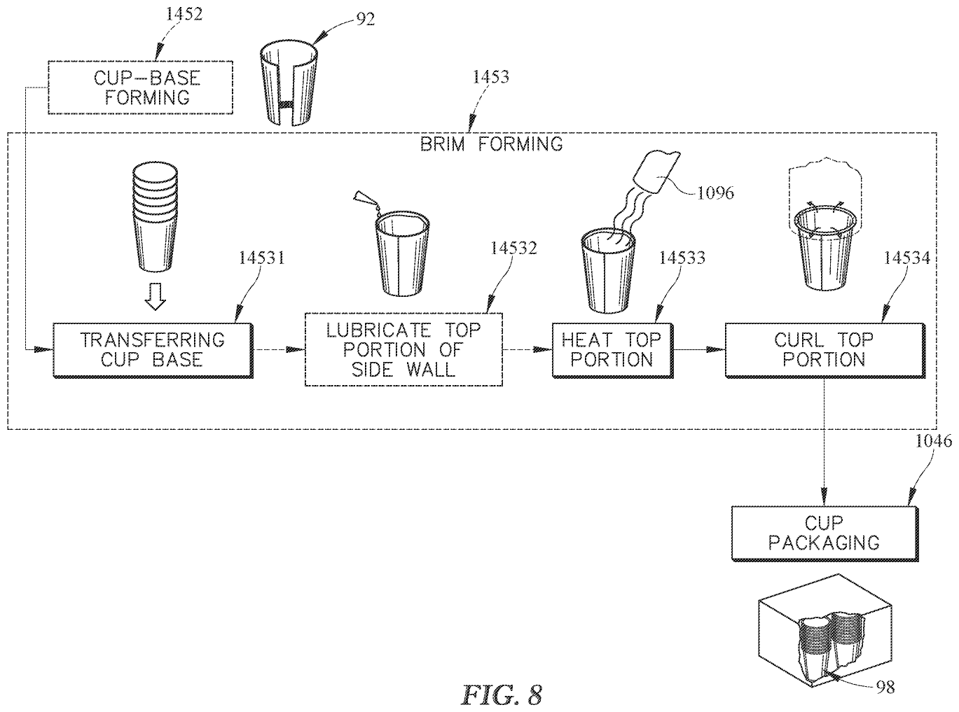

Brim-forming step 1453 includes a transferring cup-base step 14531, an optional lubricating top-portion step 14532, heating top-portion step 14533, and rolling top-portion step 14534 as shown in FIG. 8. Transferring cup-base step 14531 transfers base 12 from a cup-base forming station to a brim-forming station. Lubricating top-portion step 14532 lubricates top portion 22 of base 12. Heating top-portion step 14533 applies heat 1096 to top portion 22 of base 12. Curling top-portion step 14534 curls top portion 20, 22 away from interior region 14 to establish rolled brim 16 and form insulative cup 10.

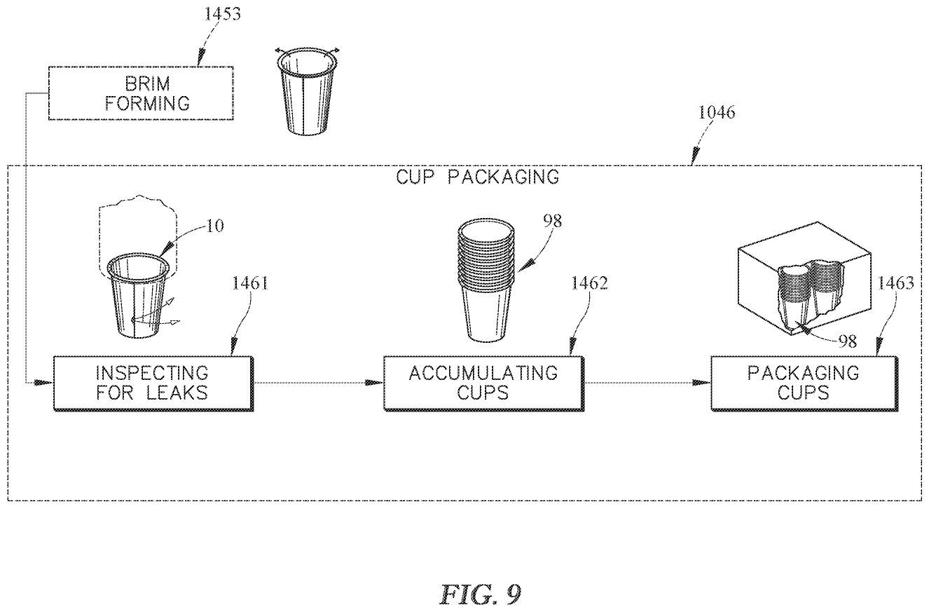

Cup-packaging stage 1046 includes a leak inspecting step 1461, an accumulating cups step 1462, and a packaging cups step 1463 as shown in FIG. 9. Leak inspecting step 1461 inspects each insulative cup 10 formed during brim-forming step 1453 for leaks. Those cups failing the leak inspection are collected and recycled or reprocessed owing to the formation of those cups from the insulative cellular non-aromatic polymeric material. Those cups passing the leak inspection are accumulated in accumulating cups step 1462 to form a stack 98 of insulative cups. Packaging cups step 1463 stores stack 98 of insulative cups for storage, use, or transportation as shown in FIG. 9.

Another embodiment of a strip-forming stage 1300 is shown for example in FIG. 10. Strip-forming stage 1300 incorporates a blender 1302 for material blending of the resin. Resin is fed into a primary extruder 1304. In this example, a first physical blowing agent A 1306 and a second physical blowing agent B 1308 are introduced to expand the resin to reduce density. As an example, first physical blowing agent A 1306 may be CO₂, N₂, or any other suitable alternative. Second physical blowing agent B 1308 may be, for example, R134a as an example. The material exits the primary extruder 1304 and is introduced into the secondary extruder 1310. The two extruders 1304 and 1310 act as tandem extruders to promote material dispersion and homogeneity.

An annular die 1312 is used to form a tube of material, as shown in FIG. 10. A cooling can nose 1314 uses air to promote the formation of bubbles. The surface temperature of the cooling can nose is regulated. In one exemplary embodiment, opposing knives 1316 are positioned preferably opposite each other (for example, at 3 and 9 o'clock) to slit the extrudate into two strips. Alternatively, a single knife can be used. Alternatively, the extrudate need not be slit at all. The extrudate thus formed can be inspected, for example by a laser thickness sensor 1318 to ensure proper and uniform thickness.

A gas, such as, but not limited to, carbon dioxide, nitrogen, other relatively inert gas, a mixture of gasses or the like, is introduced into the molten resin mixture to expand the polypropylene and reduce density by forming cells in the molten polypropylene. R134a or other haloalkane refrigerant may be used with the gas.

Other adjustments may be made to ensure a sufficiently small cell size and, thereby, facilitate a smoother surface. In illustrative embodiments, relatively greater amounts of carbon dioxide, nitrogen, other relatively inert gas, a mixture of gasses or the like, may be introduced into the molten resin mixture to expand the polypropylene and further reduce its density by forming smaller cells in the molten polypropylene. Moreover, relatively greater amounts of the chemical nucleating agent may be added to the resin mix. Furthermore, adjustments may be made to the temperature of the cooling can during the extrusion stage. Still further, the tandem extruder arrangement shown in FIG. 2 may be replaced with a co-extrusion foaming die, which can facilitate putting a cap on one side of the strip.

As discussed above, cup-manufacturing process 1040 is used to form a sheet 80 for use in forming insulative cup 10. Sheet 80 includes a skin 70 laminated to strip 82 of insulative cellular non-aromatic polymeric material as shown in FIG. 11. Skin 70 includes a film or film layer 56, and an ink layer 66. As an example, ink layer 66 may be printed on film 56 prior to coupling the skin to strip 82 of insulative cellular non-aromatic polymeric material. In the illustrative embodiment of FIG. 11, film 56 comprises HDPE.

Another embodiment of sheet 180 in accordance with the present disclosure is shown in FIG. 12. Sheet 180 includes outer skin 181, strip 82 of insulative cellular non-aromatic polymeric material, and an inner skin 2083 as shown in FIG. 12. Inner skin 183 is similar to outer skin 181 in that inner skin 183 also includes ink layer 66, and film layer 56. As a result, skin layers 181, 283 are arranged on both sides of strip 82 of insulative cellular non-aromatic polymeric material. In other embodiments, ink layer(s) 66 may be omitted on one or both sides.

An insulative cup 10 is formed using strip 82 of insulative cellular non-aromatic polymeric material in cup-manufacturing process 1040 as shown in FIGS. 4-9. Insulative cup 10 includes, for example, body 11 having sleeve-shaped side wall 18 and floor 20 coupled to body 11 to cooperate with the side wall 18 to form an interior region 14 for storing food, liquid, or any suitable product as shown in FIG. 13. Body 11 also includes a rolled brim 16 coupled to an upper end of side wall 18 and a floor mount 17 coupled to a lower end of side wall 18 and to the floor 20 as illustrated in FIGS. 13 and 15.

Body 11 is formed from multi-layer sheet 80 of insulative cellular non-aromatic polymeric material as disclosed herein. In accordance with the present disclosure, multi-layer sheet 80 of insulative cellular non-aromatic polymeric material is configured through application of pressure and heat (though in exemplary embodiments configuration may be without application of heat) to provide means for enabling localized plastic deformation in at least one selected region of body 11 to provide a plastically deformed first sheet segment having a first density located in a first portion of the selected region of body 11 and a second sheet segment having a second density lower than the first density located in an adjacent second portion of the selected region of body 11 without fracturing the sheet of insulative cellular non-aromatic polymeric material so that a predetermined insulative characteristic is maintained in body 11.

A first 101 of the selected regions of body 11 in which localized plastic deformation is enabled by the insulative cellular non-aromatic polymeric material is in sleeve-shaped side wall 18 as suggested in FIGS. 13 and 15. Sleeve-shaped side wall 18 includes an upright inner tab 514, an upright outer tab 512, and an upright fence 513 as suggested in FIG. 16. Upright inner tab 514 is arranged to extend upwardly from floor 20 and configured to provide the first sheet segment having the first density in the first 101 of the selected regions of body 11. Upright outer tab 512 is arranged to extend upwardly from floor 20 and to mate with upright inner tab 514 along an interface I therebetween as suggested in FIG. 19. Upright fence 513 is arranged to interconnect upright inner and outer tabs 514, 512 and surround interior region 14. Upright fence 513 is configured to provide the second sheet segment having the second density in the first 101 of the selected regions of body 11 and cooperate with upright inner and outer tabs 514, 513 to form sleeve-shaped side wall 18 as suggested in FIGS. 16-19.

A second 102 of the selected regions of body 11 in which localized plastic deformation is enabled by multi-layer sheet 80 is in rolled brim 16 included in body 11 as suggested in FIGS. 13 and 18. Rolled brim 16 is coupled to an upper end of sleeve-shaped side wall 18 to lie in spaced-apart relation to floor 20 and to frame an opening into interior region 14. Rolled brim 16 includes an inner rolled tab 164, an outer rolled tab 162, and a rolled lip 163 as suggested in FIGS. 13, 16, and 18. Inner rolled tab 164 is configured to provide the first sheet segment in the second 102 of the selected regions of body 11. Inner rolled tab 164 coupled to an upper end of upright outer tab 512 included in sleeve-shaped side wall 18. Outer rolled tab 162 is coupled to an upper end of upright inner tab 514 included in sleeve-shaped side wall 18 and to an outwardly facing exterior surface of inner rolled tab 164. Rolled lip 163 is arranged to interconnect oppositely facing side edges of each of inner and outer rolled tabs 164, 162. Rolled lip 163 is configured to provide the second sheet segment having the second density in the second 102 of the selected region of body 11 and cooperate with inner and outer rolled tabs 164, 162 to form rolled brim 16 as suggested in FIG. 16.

A third 103 of the selected regions of body 11 in which localized plastic deformation is enabled by the sheet of insulative cellular non-aromatic polymeric material is in a floor mount included in body 2011 as suggested in FIGS. 13 and 19. Floor mount 17 is coupled to a lower end of sleeve-shaped side wall 18 to lie in spaced-apart relation to rolled brim 16 and to floor 20 to support floor 20 in a stationary position relative to sleeve-shaped side wall 18 to form interior region 14. Floor mount 17 includes a web-support ring 126, a floor-retaining flange 26, and a web 25. Web-support ring 126 is coupled to the lower end of sleeve-shaped side wall 18 and configured to provide the second sheet segment having the second density in the third 103 of the selected regions of body 2011. Floor-retaining flange 26 is coupled to floor 20 and arranged to be surrounded by web-support ring 126. Web 25 is arranged to interconnect floor-retaining flange 26 and web-support ring 126. Web 25 is configured to provide the first sheet segment having the first density in the third 103 of the selected regions of body 11.

A fourth 104 of the selected regions of body 11 in which localized plastic deformation is enabled by multi-layer sheet 80 is in floor-retaining flange of floor mount 17 as suggested in FIGS. 13, 15, and 20. Floor-retaining flange 26 includes an alternating series of upright thick and thin staves arranged in side-to-side relation to extend upwardly from web 25 toward interior region 14 bounded by sleeve-shaped side wall 18 and floor 20. A first 261 of the upright thick staves is configured to include a right side edge extending upwardly from web 25 toward interior region 14. A second 2262 of the upright thick staves is configured to include a left side edge arranged to extend upwardly from web 25 toward interior region 14 and lie in spaced-apart confronting relation to right side edge of the first 261 of the upright thick staves. A first 260 of the upright thin staves is arranged to interconnect left side edge of the first 261 of the upright thick staves and right side edge of the second 262 of the upright thick staves and to cooperate with left and right side edges to define therebetween a vertical channel 263 opening inwardly into a lower interior region bounded by floor-retaining flange 26 and a horizontal platform 21 included in floor 20 and located above floor-retaining flange 26. The first 260 of the upright thin staves is configured to provide the first sheet segment in the fourth 104 of the selected regions of body 11. The first 261 of the upright thick staves is configured to provide the second sheet segment in the fourth 104 of the selected regions of the body 11.

The compressibility of multi-layer sheet 80 used to produce insulative cup 10 allows the insulative cellular non-aromatic polymeric material to be prepared for the mechanical assembly of insulative cup 10, without limitations experienced by other non-aromatic polymeric materials. The cellular nature of the material provides insulative characteristics as discussed below, while susceptibility to plastic deformation permits yielding of the material without fracture. The plastic deformation experienced when the insulative cellular non-aromatic polymeric material is subjected to a pressure load is used to form a permanent set in the insulative cellular non-aromatic polymeric material after the pressure load has been removed. In some locations, the locations of the permanent set are positioned to provide a controlled gathering of the sheet of insulative cellular non-aromatic polymeric material.

The plastic deformation may also be used to create fold lines in the sheet to control deformation of the sheet when being worked during the assembly process. When deformation is present, the absence of material in the voids formed by the deformation provides relief to allow the material to be easily folded at the locations of deformation.

Insulative cup 10 of the present disclosure satisfies a long-felt need for a vessel that includes many if not all the features of insulative performance, ready for recyclability, high-quality graphics, chemical resistance, puncture resistance, frangibility resistance, stain resistance, and resistance to leaching undesirable substances into products stored in the interior region of the drink cup as discussed above. Others have failed to provide a vessel that achieves combinations of these features as reflected in the appended claims. This failure is a result of the many features being associated with competitive design choices. As an example, others have created vessels that based on design choices are insulated but suffer from poor puncture resistance, and leech undesirable substances into products stored in the interior region. In comparison, insulative cup 10 overcomes the failures of others by using an insulative cellular non-aromatic polymeric material.

A potential feature of a cup formed of insulative cellular non-aromatic polymeric material according to exemplary embodiments of the present disclosure is that the cup has low material loss.

Another potential feature of a cup formed of the insulative cellular non-aromatic polymeric material according to the present disclosure is that the cup can be placed in and go through a conventional residential or commercial dishwasher cleaning cycle (top rack) without noticeable structural or material breakdown or adverse effect on material properties. This is in comparison to beaded expanded polystyrene cups or containers, which can break down under similar cleaning processes. Accordingly, a cup made according to one aspect of the present disclosure can be cleaned and reused.

Another potential feature of an article formed of the insulative cellular non-aromatic polymeric material according to various aspects of the present disclosure is that the article can be recycled. Recyclable means that a material can be added (such as regrind) back into an extrusion or other formation processes without segregation of components of the material, i.e., an article formed of the material does not have to be manipulated to remove one or more materials or components prior to re-entering the extrusion process. For example, a cup having a printed film layer laminated to the exterior of the cup may be recyclable if one does not need to separate out the film layer prior to the cup being ground into particles. In contrast, a paper-wrapped expanded polystyrene cup may not be recyclable because the polystyrene material could not practicably be used as material in forming an expanded polystyrene cup, even though the cup material may possibly be formed into another product. As a further example, a cup formed from a non-expanded polystyrene material having a layer of non-styrene printed film adhered thereto may be considered non-recyclable because it would require the segregation of the polystyrene cup material from the non-styrene film layer, which would not be desirable to introduce as part of the regrind into the extrusion process.

Recyclability of articles formed from the insulative cellular non-aromatic polymeric material of the present disclosure minimizes the amount of disposable waste created. In comparison, beaded expanded polystyrene cups that break up into beads and thus ordinarily cannot easily be reused in a manufacturing process with the same material from which the article was formed. In addition, paper cups that typically have an extrusion coated plastic layer or a plastic lamination for liquid resistance ordinarily cannot be recycled because the different materials (paper, adhesive, film, plastic) normally cannot be practicably separated in commercial recycling operations.

A potential feature of a cup formed of the insulative cellular non-aromatic polymeric material according to one aspect of the present disclosure is that it possesses unexpected strength as measured by rigidity. Rigidity is a measurement done at room temperature, at an elevated temperature (e.g., by filling the cup with a hot liquid), and a decreased temperature (e.g., by filling the cup with a cold liquid) and measuring the rigidity of the material. The strength of the cup material is important to reduce the potential for the cup being deformed by a user and the lid popping off or the lid or sidewall seal leaking.

A potential feature of a cup formed of the insulative cellular non-aromatic polymeric material according to the present disclosure is that the cup is resistant to puncture, such as by a straw, fork, spoon, fingernail, or the like, as measured by standard impact testing, as described hereinbelow. Test materials demonstrated substantially higher impact resistance when compared to a beaded expanded polystyrene cup. Accordingly, a cup formed one aspect as described herein can reduce the likelihood of puncture and leakage of hot liquid onto a user.

A feature of a cup with a compressed brim and seam formed of the material according to one aspect as described herein is that a greater number of such cups can be nested in a given sleeve length because the seam is thinner and the side wall angle can be minimized (i.e., more approaching 90° with respect to the cup bottom) while providing a sufficient air gap to permit easy de-nesting. Conventionally seam-formed cups having a seam substantially thicker than the side wall requires a greater side wall angle (and air gap) to allow for de-nesting, resulting in fewer cups being able to be nested in a given sleeve length.

A feature of a cup formed of the material according to one aspect of the present disclosure is that the brim may have a cross-section profile of less than about 0.170 inches (4.318 mm) which may be due to localized cell deformation and compression. Such a small profile is more aesthetically pleasing than a larger profile.

A feature of a cup formed of the material according to one aspect of the present disclosure is that the rolled brim diameter can be the same for cups of different volumes, enabling one lid size to be used for different cup sizes, assuming the cup rims outside diameters are the same. As a result, the number of different size lids in inventory and at the point of use may be reduced.

The material formulation may have properties that allow multi-layer sheet 80 to be compressed without fracturing.

The insulative cellular non-aromatic polymeric material of the present disclosure may be formed into a strip, which can be wrapped around other structures. For example, a strip of the material according to one aspect of the present disclosure that can be used as a wrapping material may be formed and wrapped around a pipe, conduit, or other structure to provide improved insulation. The sheet or strip 80 may have a layer of adhesive, such as a pressure sensitive adhesive, applied to one or both faces. The strip may be wound onto a roll. Optionally, the strip may have a release liner associated therewith to make unwinding the strip from the roll easier. The polymer formulation may be adapted to provide the requisite flexibility to form a wrap or windable strip, for example, by using one or more polypropylene or other polyolefin materials that have sufficient flexibility to enable the extruded sheet to be flexible enough to be wound onto a roll. The insulative cellular non-aromatic polymeric material may be formed into a sleeve that can be inserted over a cup to provide additional insulation.

In exemplary embodiments, sheets formed from the insulative cellular non-aromatic polymeric material of the present disclosure may be cut at the die or be flaked and used as a bulk insulator.

The formulation and insulative cellular non-aromatic polymeric material of the present disclosure satisfies a long-felt need for a material that can be formed into an article, such as a cup, that includes many if not all of the features of insulative performance, ready for recyclability, puncture resistance, frangibility resistance, and other features as discussed herein. Others have failed to provide a material that achieves combinations of these features as reflected in the appended claims. This failure is a result of the features being associated with competitive design choices. As an example, others have created materials and structures therefrom that based on design choices are insulated but suffer from poor puncture resistance, inability to effectively be recyclable. In comparison, the formulations and materials disclosed herein overcome the failures of others by using an insulative cellular non-aromatic polymeric material.

The cup may be formed from an extruded sheet of material by any of the extrusion processes suggested in FIGS. 2, 4, and 5 and described hereinabove. The material of the present disclosure may also be formed into a deformable sheet, which can be wrapped around other structures. For example, a sheet of the present material may be formed and wrapped around a pipe, conduit, or other structure to provide improved insulation.

### Cup

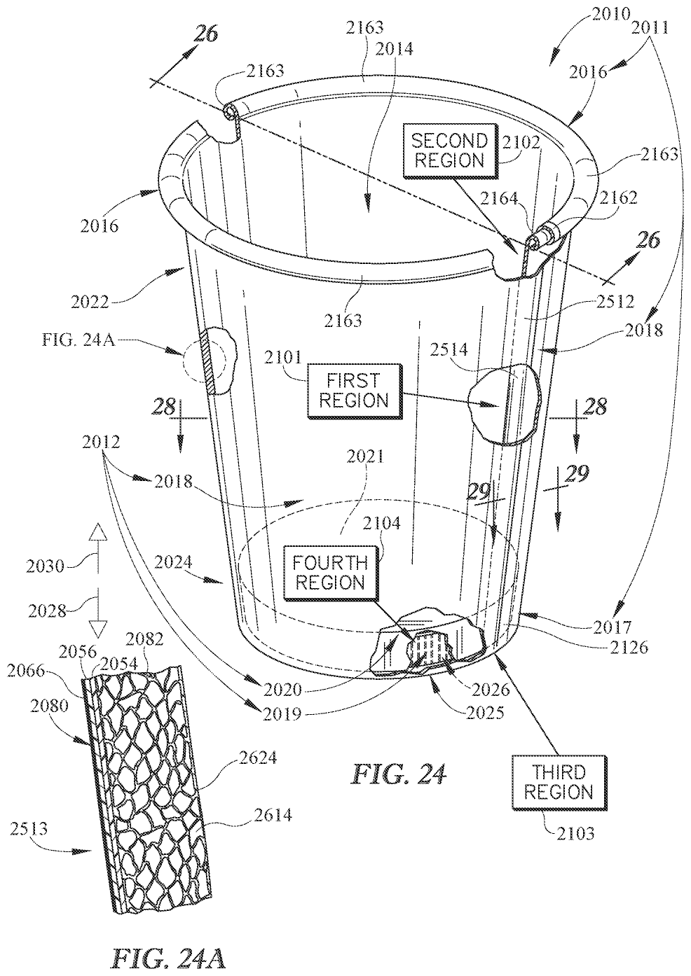

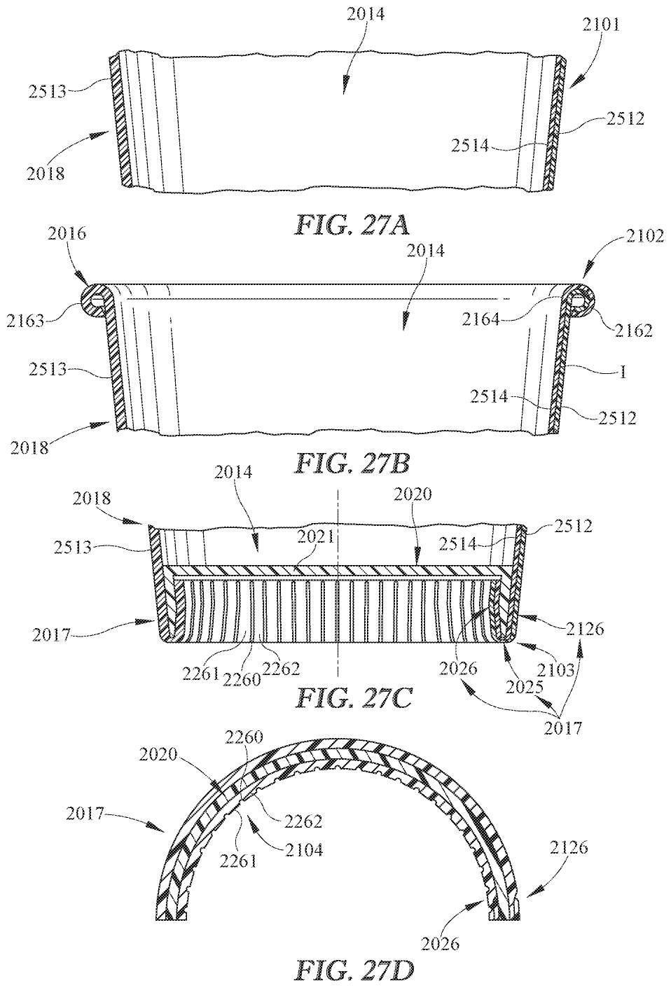

An insulative cup 2010 in accordance with the present disclosure can be formed during a cup forming process. Localized plastic deformation is provided in accordance with the present disclosure in, for example, four regions 2101, 2102, 2103, and 2104 of a body 2011 of insulative cup 2010 comprising an insulative cellular non-aromatic polymeric material as suggested in FIGS. 24, and 27A-D. A material has been plastically deformed, for example, when it has changed shape to take on a permanent set in response to exposure to an external compression load and remains in that new shape after the load has been removed. Insulative cup 2010 disclosed herein is not a paper cup but rather a cup made of a cellular non-aromatic polymeric material with insulative qualities suitable for holding hot and cold contents, preferably cold contents. Illustratively, cup 2010 is configured to minimize condensation that may accumulate on cup 2010 when cup 2010 is filled with cold contents.

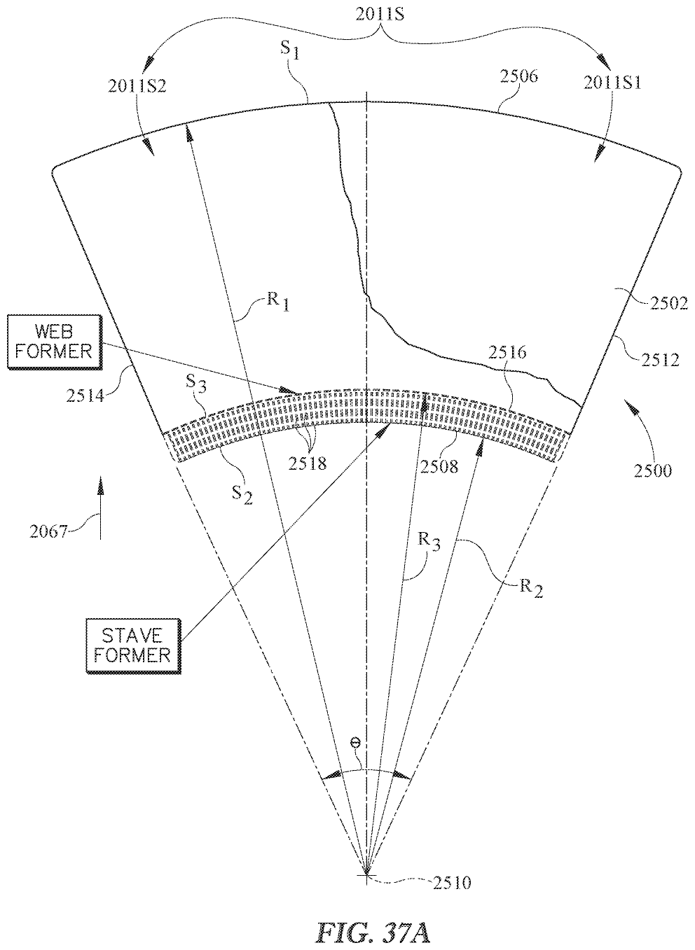

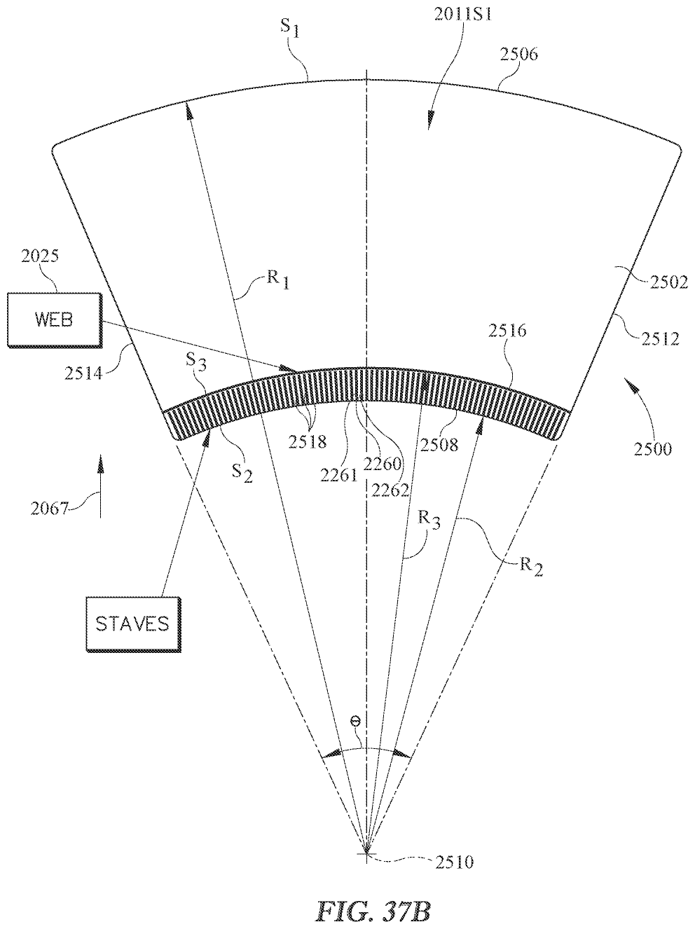

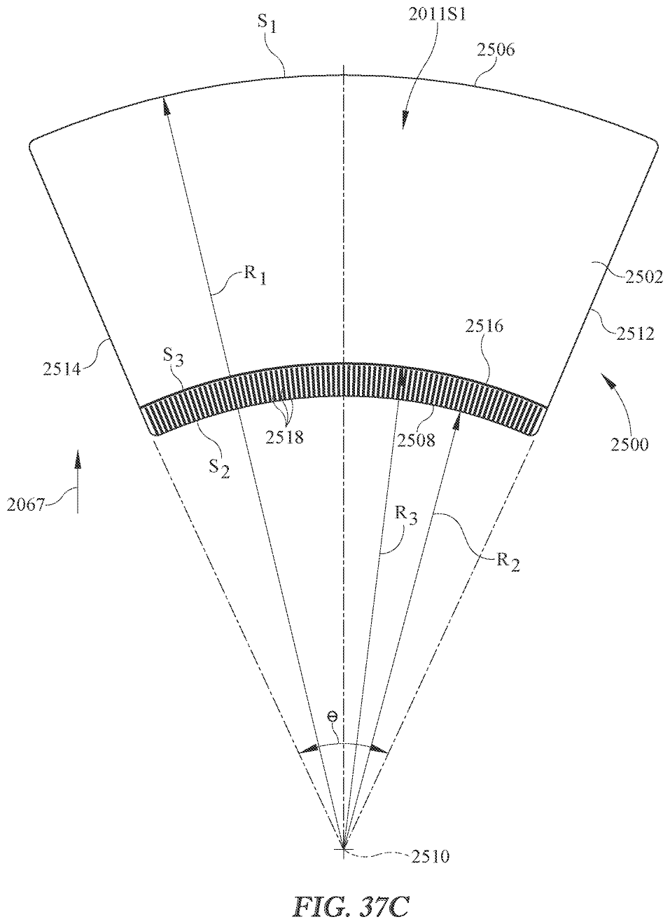

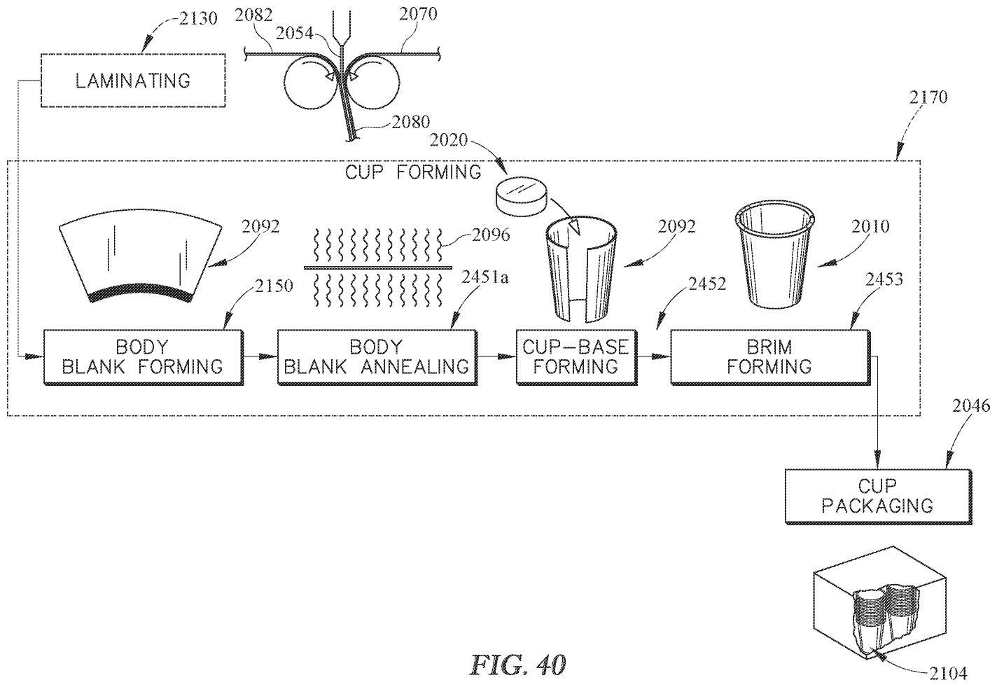

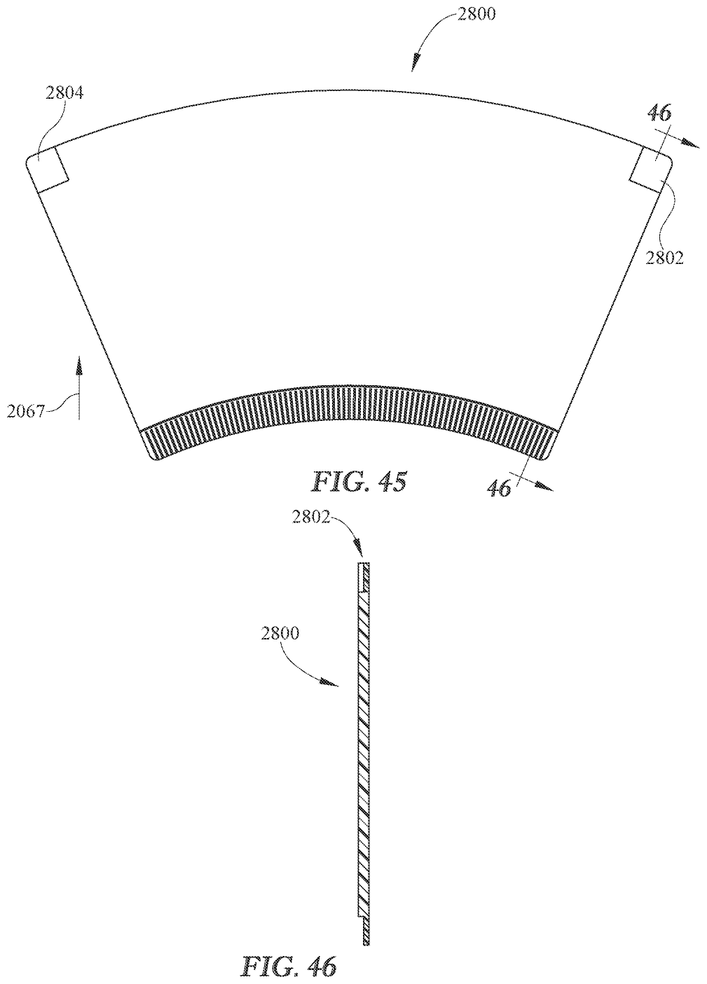

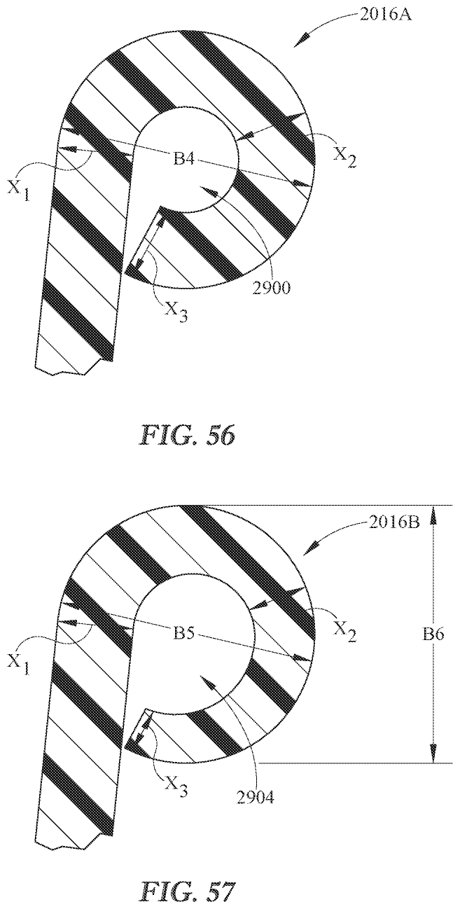

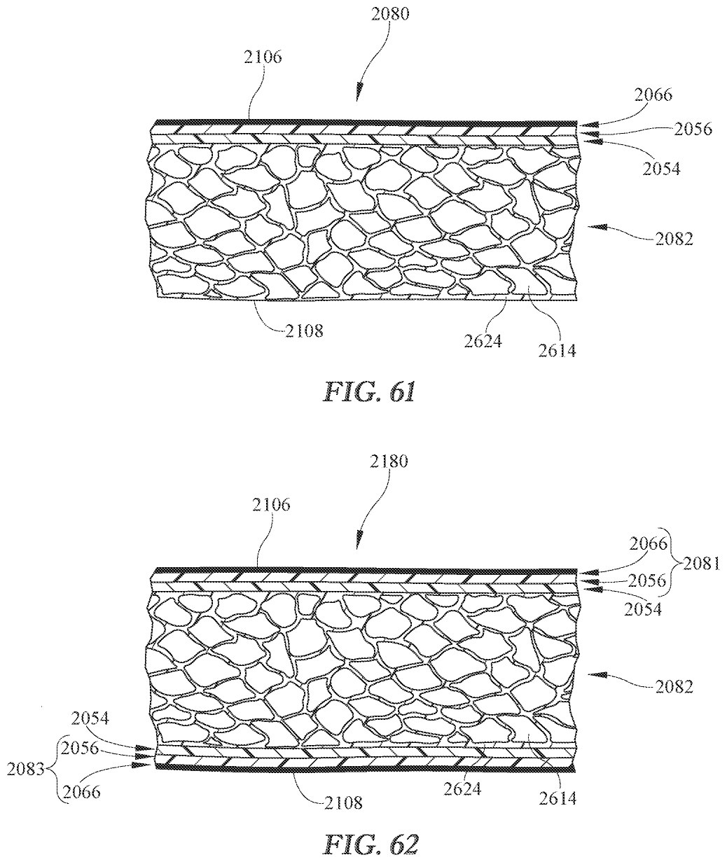

A first embodiment of an insulative cup 2010 having four regions 2101-2104 where localized plastic deformation provides segments of insulative cup 2010 that exhibit higher material density than neighboring segments of insulative cup 2010 in accordance with the present disclosure is shown in FIGS. 24 and 25-36. As an example, insulative cup 2010 is made using an illustrative body blank 2500 shown in FIGS. 37A-39. A cup-manufacturing process 2040 that makes body blank 2500 and insulative cup 2010 is shown in FIGS. 40-44. Other embodiments of body blanks 2800, 2820, 2836, and 2856 in accordance with the present disclosure that may be used to form insulative cups are illustrated in FIGS. 45-55. Rolled brims 2016A, 2016B, 2016C that may be used with various insulative cups are illustrated in FIGS. 56-58. A first embodiment of multi-layer sheet used to form insulative cup 2010 is shown in FIGS. 24A and 61. Another embodiment of multi-layer sheet in accordance with the present disclosure is shown in FIG. 62.

An insulative cup 2010 comprises a body 2011 including a sleeve-shaped side wall 2018 and a floor 2020 coupled to body 2011 to define an interior region 2014 bounded by sleeve-shaped side wall 2018 and floor 2020 as shown, for example, in FIG. 24. Body 2011 further includes a rolled brim 2016 coupled to an upper end of side wall 2018 and a floor mount 2017 coupled to a lower end of side wall 2018 as suggested in FIGS. 24-26.

Body 2011 is formed from a strip a multi-layer sheet 2080 as disclosed herein. In accordance with the present disclosure, multi-layer sheet 2080 comprises insulative cellular non-aromatic polymeric material 2082 configured (by application of pressure—with or without application of heat) to provide means for enabling localized plastic deformation in at least one selected region (for example, regions 2101-2104) of body 2011 to provide a plastically deformed first material segment having a first density located in a first portion of the selected region of body 2011 and a second material segment having a second density lower than the first density located in an adjacent second portion of the selected region of body 2011 without fracturing the insulative cellular non-aromatic polymeric material so that a predetermined insulative characteristic is maintained in body 2011.

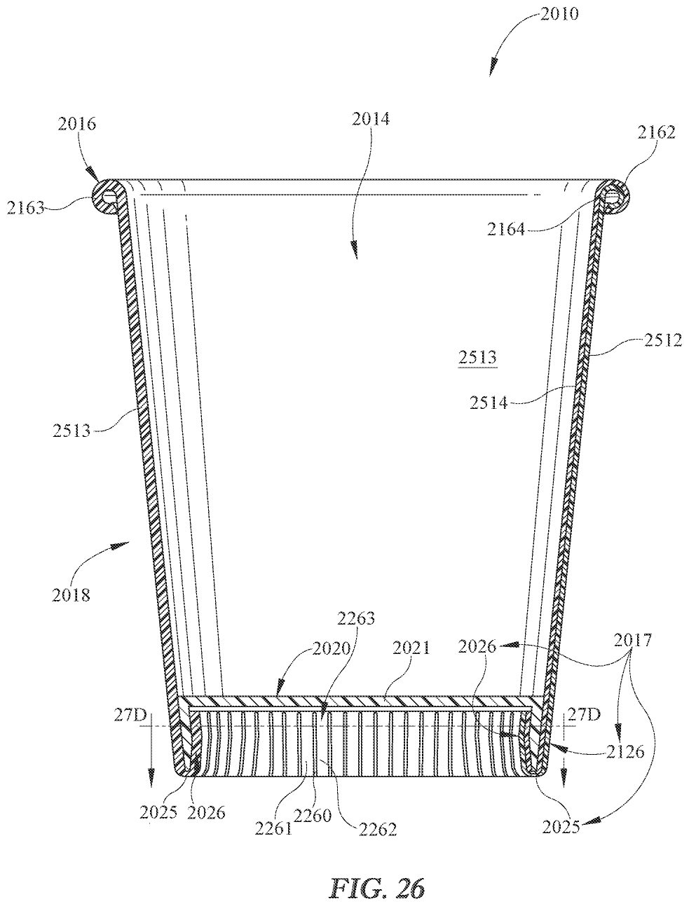

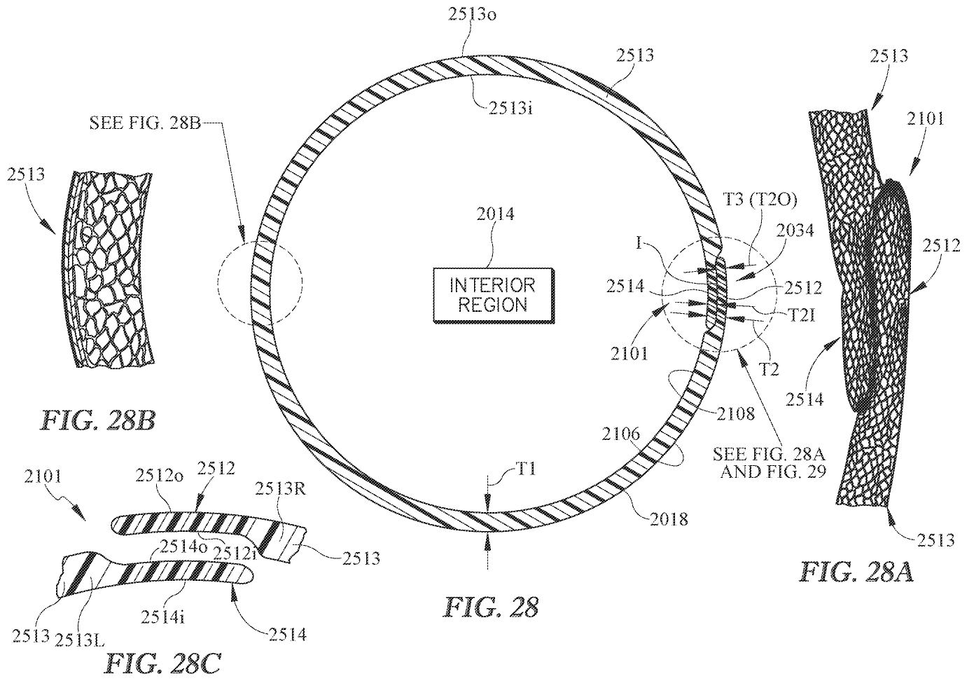

A first region 101 of the selected regions of body 2011 in which localized plastic deformation is enabled by the insulative cellular non-aromatic polymeric material is in sleeve-shaped side wall 2018 as suggested in FIGS. 24, 27A, and 28. Sleeve-shaped side wall 2018 includes an upright inner tab 2514, an upright outer tab 2512, and an upright fence 2513 extending between inner and outer tabs 2514, 2512 as suggested in FIGS. 24, 26, and 28. Upright inner tab 2514 is arranged to extend upwardly from floor 2020 and configured to provide the first material segment having the higher first density in the first region 2101 of the selected regions of body 2011. Upright outer tab 2512 is arranged to extend upwardly from floor 2020 and to mate with upright inner tab 2514 along an interface I therebetween as suggested in FIG. 28. Upright fence 2513 is arranged to interconnect upright inner and outer tabs 2514, 2512 and surround interior region 2014. Upright fence 2513 is configured to provide the second material segment having the lower second density in the first region 2101 of the selected regions of body 2011 and cooperate with upright inner and outer tabs 2514, 2512 to form sleeve-shaped side wall 2018 as suggested in FIGS. 26 and 28.

A second region 2102 of the selected regions of body 2011 in which localized plastic deformation is enabled by the insulative cellular non-aromatic polymeric material is in a rolled brim 2016 included in body 2011 as suggested in FIGS. 24, 27B, and 30. Rolled brim 2016 is coupled to an upper end of sleeve-shaped side wall 2018 to lie in spaced-apart relation to floor 2020 and to frame an opening into interior region 2014. Rolled brim 2016 includes an inner rolled tab 2164, an outer rolled tab 2162, and a rolled lip 2163 as suggested in FIGS. 24, 26, and 30. Inner rolled tab 2164 is configured to provide the first material segment having the higher first density in the second region 2102 of the selected regions of body 2011. Inner rolled tab 2164 is coupled to an upper end of upright outer tab 2512 included in sleeve-shaped side wall 2018. Outer rolled tab 2162 is coupled to an upper end of upright inner tab 2514 included in sleeve-shaped side wall 2018 and to an outwardly facing exterior surface of inner rolled tab 2164. Rolled lip 2163 is arranged to interconnect oppositely facing side edges of each of inner and outer rolled tabs 2164, 2162. Rolled lip 2163 is configured to provide the second material segment having the lower second density in the second 2102 of the selected region of body 2011 and cooperate with inner and outer rolled tabs 2164, 2162 to form rolled brim 2016 as suggested in FIG. 24.

A third region 2103 of the selected regions of body 2011 in which localized plastic deformation is enabled by the insulative cellular non-aromatic polymeric material is in a floor mount 2017 included in body 2011 as suggested in FIGS. 24, 25C, 32, and 32A. Floor mount 2017 is coupled to a lower end of sleeve-shaped side wall 2018 to lie in spaced-apart relation to rolled brim 2016 and to floor 2020 to support floor 2020 in a stationary position relative to sleeve-shaped side wall 2018 to form interior region 2014. Floor mount 2017 includes a web-support ring 2126, a floor-retaining flange 2026, and a connecting web 2025 extending between web-support ring 2126 and floor-retaining flange 2026 as suggested in FIG. 26. Web-support ring 2126 is coupled to the lower end of sleeve-shaped side wall 2018 and configured to provide the second material segment having the lower second density in the third region 2103 of the selected regions of body 2011. Floor-retaining flange 2026 is coupled to floor 2020 and arranged to be surrounded by web-support ring 2126 as suggested in FIG. 26. Connecting web 2025 is arranged to interconnect floor-retaining flange 2026 and web-support ring 2126. Connecting web 2025 is configured to provide the first material segment having the higher first density in the third region 2103 of the selected regions of body 2011. Connecting web 2025 is preformed in a body blank 2500 in an illustrative embodiment before body blank 2500 is formed to define insulative cup 2010 as suggested in FIGS. 40-44.

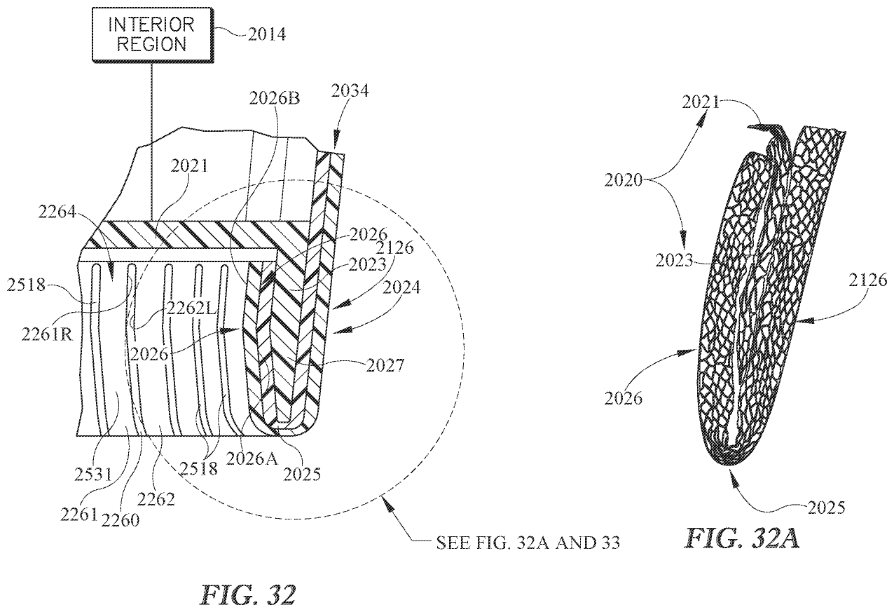

A fourth region 2104 of the selected regions of body 2011 in which localized plastic deformation is enabled by the insulative cellular non-aromatic polymeric material is in floor-retaining flange 2026 of floor mount 2017 as suggested in FIGS. 24, 27D, 34, 34A, and 34B. Floor-retaining flange 2026 includes an alternating series of upright thick and thin staves arranged in side-to-side relation to extend upwardly from connecting web 2305 toward interior region 2014 bounded by sleeve-shaped side wall 2018 and floor 2020. This alternating series of thick and thin staves is preformed in a body blank 2500 in an illustrative embodiment before body blank 2500 is formed to define insulative cup 2010 as suggested in FIGS. 40-44. As suggested in FIG. 32, a first 2261 of the upright thick staves is configured to include a right side edge 2261R extending upwardly from web 2025 toward interior region 2014. A second 2262 of the upright thick staves is configured to include a left side edge 2262L arranged to extend upwardly from web 2025 toward interior region 2014 and lie in spaced-apart confronting relation to right side edge 2261R of the first 2261 of the upright thick staves. A first 2260 of the upright thin staves is arranged to interconnect right side edge 2261R of the first 2261 of the upright thick staves and left side edge 2262L of the second 2262 of the upright thick staves and to cooperate with left and right side edges 2262L, 2261R to define therebetween a vertical channel 2263 opening inwardly into a lower interior region 2264 bounded by floor-retaining flange 2026 and a horizontal platform 2021 included in floor 2020 and located above floor-retaining flange 2026 as suggested in FIG. 32. The first 2260 of the upright thin staves is configured to provide the first material segment having the higher first density in the fourth region 2104 of the selected regions of body 2011. The first 2261 of the upright thick staves is configured to provide the second material segment having the lower second density in the fourth region 2104 of the selected regions of the body 2011.

Sleeve-shaped side wall 2018 of body 2011 includes a pair of tabs 2514, 2512 that mate to provide side wall 2018 with a frustoconical shape in the illustrative embodiment shown in FIGS. 24, 26, 27A, and 28. Upright inner tab 2514 of side wall 2018 includes an inner surface 2514i bounding a portion of interior region 2014 and an outer surface 25140 facing toward upright outer tab 2512 as shown in FIGS. 28 and 28C. Upright outer tab 2512 includes an inner surface 2512i facing toward interior region 2014 and mating with outer surface 25140 of upright inner tab 2514 to define the interface I between upright inner and outer tabs 2514, 2512. Upright outer tab 2512 further includes an outer face 25120 facing away from upright inner tab 2514. Each of inner and outer surfaces of upright inner and outer tabs 2514, 2512 has an arcuate shape in a horizontal cross-section as suggested in FIG. 28C and subtends an acute angle of less than 20°.

Upright fence 2513 of side wall 2018 is C-shaped in a horizontal cross-section and each of upright inner and outer tabs 2514, 2512 has an arcuate shape in a horizontal cross-section as suggested in FIG. 28. Upright fence 2513 includes an upright left side edge 2513L and an upright right side edge 2513R that is arranged to lie in spaced-apart confronting relation to upright left side edge 2513L in FIG. 28C. Upright outer tab 2512 is configured to have the higher first density and mate with upright inner tab 2514 also characterized by the higher first density to establish a bridge 2512, 2514 arranged to interconnect upright left and right side edges 2513L, 2513R of upright fence 2513. Bridge 2512, 2514 is formed of a plastically deformed material having the higher first density.

Upright fence 2513 of side wall 2018 has an inner surface 2513i bounding a portion of interior region 2014 and an outer surface 25130 facing away from interior region 2014 and surrounding inner surface 2513i of upright fence 2513 as shown, for example, in FIG. 28. Outer surface 25130 cooperates with inner surface 2513i of upright fence 2513 to define a first thickness T1 therebetween. Upright inner tab 2514 includes an inner surface 2514i bounding a portion of interior region 2014 and an outer surface 25140 facing toward upright outer tab 2512. Upright outer tab 2512 includes an inner surface 2512i facing toward interior region 2014 and mating with outer surface 25140 of upright inner tab 2514 to define the interface I between upright inner and outer tabs 2514, 2512. Upright outer tab 2512 further includes an outer face 25120 facing away from upright inner tab 2514. Inner and outer surfaces of upright inner tab 2514 cooperate to define a second thickness T2I therebetween that is less than the first thickness T1. Inner and outer surfaces of upright outer tab 2512 cooperate to define a third thickness T2O that is less than the first thickness T1.

Rolled brim 2016 of body 2011 is coupled to an upper end of sleeve-shaped side wall 2018 to lie in spaced-apart relation to floor 2020 and to frame an opening into interior region 2014 as suggested in FIGS. 24 and 27B. Inner rolled tab 2164 of rolled brim 2016 is configured to provide the plastically deformed first material segment having the higher first density and to include oppositely facing left and right side edges. Rolled lip 2163 of rolled brim 2016 is arranged to interconnect the oppositely facing left and right side edges of inner rolled tab 2164 and configured to provide the second material segment having the lower second density. Outer rolled tab 2162 of rolled brim 2016 is coupled to an outwardly facing surface of inner rolled tab 2164 as suggested in FIG. 24 to provide an outer shell covering inner rolled tab 2164 and formed of a plastically deformed material having the higher first density. Outer rolled tab 2162 includes oppositely facing left and right side edges. Rolled lip 2163 is arranged to interconnect the oppositely facing left and right side edges of outer rolled tab 2162. Rolled lip 2163 is C-shaped in horizontal cross-section. Each of inner and outer rolled tabs 2164, 2162 has an arcuate shape between the oppositely facing left and right side edges thereof to provide rolled brim 2016 with an annular shape.

Floor mount 2017 of body 2011 is coupled to a lower end of sleeve-shaped side wall 2018 and to floor 2020 to support floor 2020 in a stationary position relative to sleeve-shaped side wall 2018 to form interior region 2014 as suggested in FIGS. 24-26 and 27C. Floor mount 2017 includes a floor-retaining flange 2026 coupled to floor 2020, a web-support ring 2126 coupled to the lower end of sleeve-shaped side wall 2018 and arranged to surround floor-retaining flange 2026, and a connecting web 2025 arranged to interconnect floor-retaining flange 2026 and web-support ring 2126 as suggested in FIG. 27C. Connecting web 2025 is configured to provide the first material segment having the higher first density. Connecting web-support ring 2126 is configured to provide the second material segment having the lower second density. Each of connecting web 2025 and web-support ring 2126 has an annular shape. Floor-retaining flange 2026 has an annular shape. Each of floor-retaining flange 2026, connecting web 2025, and web-support ring 2126 includes an inner layer having an interior surface mating with floor 2020 and an overlapping outer layer mating with an exterior surface of an inner layer as suggested in FIGS. 26 and 32.

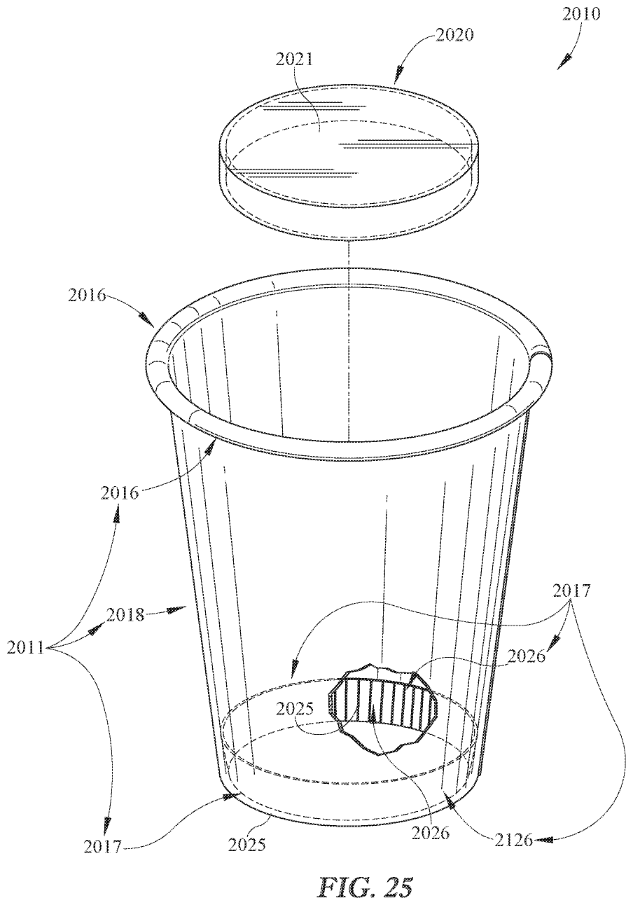

Floor 2020 of insulative cup 2010 includes a horizontal platform 2021 bounding a portion of interior region 2014 and a platform-support member 2023 coupled to horizontal platform 2021 as shown, for example, in FIGS. 25 and 27C. Platform-support member 2023 is ring-shaped and arranged to extend downwardly away from horizontal platform 2021 and interior region 2014 into a space 2027 provided between floor-retaining flange 2026 and the web-support ring 2126 surrounding floor-retaining flange 2026 to mate with each of floor-retaining flange 2026 and web-support ring 2126 as suggested in FIGS. 27 and 32.

Platform-support member 2023 of floor 2020 has an annular shape and is arranged to surround floor-retaining flange 2026 and lie in an annular space provided between horizontal platform 2021 and connecting web 2025 as suggested in FIGS. 26, 27C, and 27D. Each of floor-retaining flange 2026, connecting web 2025, and web-support ring 2126 includes an inner layer having an interior surface mating with floor 2020 and an overlapping outer layer mating with an exterior surface of the inner layer as suggested in FIGS. 26 and 30. The inner layer of each of floor-retaining flange 2026, web 2025, and web-support ring 2126 is arranged to mate with platform-support member 2023 as suggested in FIG. 27C.

Floor-retaining flange 2026 of floor mount 2017 is arranged to lie in a stationary position relative to sleeve-shaped side wall 2018 and coupled to floor 2020 to retain floor 2020 in a stationary position relative to sleeve-shaped side wall 2018 as suggested in FIGS. 26, 27C, and 32. Horizontal platform 2021 of floor 2020 has a perimeter edge mating with an inner surface of sleeve-shaped side wall 18 and an upwardly facing top side bounding a portion of interior region 2014 as suggested in FIGS. 26 and 27C.

Floor-retaining flange 2026 of floor mount 2017 is ring-shaped and includes an alternating series of upright thick and thin staves arranged to lie in side-to-side relation to one another to extend upwardly toward a downwardly facing underside of horizontal platform 2021. A first 2261 of the upright thick staves is configured to include a right side edge 2261R extending upwardly toward the underside of horizontal platform 2021. A second 2262 of the upright thick staves is configured to include a left side edge 2262L arranged to extend upwardly toward underside of horizontal platform 2021 and lie in spaced-apart confronting relation to right side edge 2261R of the first 2261 of the upright thick staves. A first 2260 of the upright thin staves is arranged to interconnect left and right side edges 2262L, 2261R and cooperate with left and right side edges 2262L, 2261R to define therebetween a vertical channel 2263 opening inwardly into a lower interior region 3264 bounded by horizontal platform 2021 and floor-retaining flange 2026 as suggested in FIGS. 27D, 32, and 34. The first 3260 of the thin staves is configured to provide the first material segment having the higher first density. The first 2261 of the thick staves is configured to provide the second material segment having the lower second density.

Floor-retaining flange 2026 of floor mount 2017 has an annular shape and is arranged to surround a vertically extending central axis CA intercepting a center point of horizontal platform 2021 as suggested in FIGS. 27C and 27D. The first 2260 of the thin staves has an inner wall facing toward a portion of the vertically extending central axis CA passing through the lower interior region. Platform-support member 2023 is arranged to surround floor-retaining flange 2026 and cooperate with horizontal platform 2021 to form a downwardly opening floor chamber 2020C containing the alternating series of upright thick and thin staves therein.

Each first material segment in the insulative cellular non-aromatic polymeric material has a relatively thin first thickness. Each companion second material segment in the insulative cellular non-aromatic polymeric material has a relatively thicker second thickness.

Body 2011 is formed from a sheet 2011S of insulative cellular non-aromatic polymeric material that includes, for example, a strip of insulative cellular non-aromatic polymeric material 2011S1 and a skin 2011S2 coupled to one side of the strip of insulative cellular non-aromatic polymeric material 11S1 as shown in FIG. 37A. In one embodiment of the present disclosure, text and artwork or both can be printed on a film included in skin 2011S2. Skin 2011S2 may further comprise an ink layer applied to the film to locate the ink layer between the film and strip of insulative cellular non-aromatic polymeric material 2082. In another embodiment, skin 2011S2 may further comprise an ink layer applied to the film to locate the film layer between the ink layer and strip of insulative cellular non-aromatic polymeric material 2082. In another example, the skin and the ink layer are laminated to strip of insulative cellular non-aromatic polymeric material by a polymeric-lamination layer arranged to lie between the skin and insulative cellular non-aromatic polymer material 2082. As an example, the film layer may comprise polyethylene.

As an example, a polymeric formulation for forming insulative cellular non-aromatic polymeric material comprises a base resin blend comprising a high density polyethylene (HDPE), a low density polyethylene (LDPE), or a combination thereof. In some embodiments, the formulation may comprise cell-forming agents including a chemical nucleating agent, a physical blowing agent, or a combination thereof.

In some embodiments, the HDPE may be a homopolymer, a copolymer, an enhanced polyethylene, combinations thereof, or any suitable alternative. One exemplary HDPE described herein is DMDA 8007 by Dow Chemical.

In some embodiments, the LDPE may be a homopolymer. In another embodiment, the LDPE may be a copolymer. One exemplary LDPE described herein is LDPE 621i by Dow Chemical.

Process additives, such as slip agents, antiblock agents, or antistatic agents may be added to the formulations to improve the extrusion process and provide additional properties of multi-layer sheet 80. Colorants in the form of masterbatches may also be added the formulation for each of the layers.

An insulative cup 2010 in accordance with one exemplary embodiment of the present disclosure includes a base 2012 formed to include an interior region 2014 and a rolled brim 2016 coupled to base 2012 as shown, for example, in FIG. 24. Base 2012 includes a side wall 2018, a support structure 2019, and a floor 2020 as shown in FIGS. 24, 25, 27C, and 34. Floor 2020 is coupled to support structure 2019 and side wall 2018 to define interior region 2014. Base 2012 illustratively comprises an insulative cellular non-aromatic polymeric material that is configured (by application of pressure—with or without application of heat) to provide means for insulating a beverage or food placed in interior region 2014, forming a structure having sufficient mechanical characteristics to support the beverage or food, and providing resistance to deformation and puncture. As shown for example in FIGS. 40-44, insulative cup 2010 is formed in an illustrative cup-manufacturing process 2040.

Side wall 2018 extends between rolled brim 2016 and support structure 2019 as shown in FIG. 26. Side wall 2018 includes a top portion 2022 of base 2012 that is coupled to rolled brim 2016 and a bottom portion 2024 that is coupled to support structure 2019. Support structure 2019 is arranged to interconnect floor 2020 and bottom portion 2024 of side wall 2018. In the illustrative embodiment, brim 2016, side wall 2018, and support structure 2019 are formed from a unitary body blank 2500 shown in FIGS. 37A-C. Insulative cup 2010 is an assembly comprising the body blank 2500 and the floor 2020. As an example, floor 2020 is mated with bottom portion 2024 during cup-manufacturing process 2040 to form a primary seal therebetween. A secondary seal may also be established between support structure 2019 and floor 2020. An insulative container may be formed with only the primary seal, only the secondary seal, or both the primary and secondary seals.

Referring again to FIG. 24, top portion 2022 of side wall 2018 is arranged to extend in a downward direction 2028 toward floor 2020 and is coupled to bottom portion 2024. Bottom portion 2024 is arranged to extend in an opposite upward direction 2030 toward rolled brim 2016. Top portion 2022 is curled during cup-manufacturing process 2040 to form rolled brim 2016. Rolled brim 2016 and top portion 2022 cooperate to form a mouth 2032 that is arranged to open into interior region 2014.

Support structure 2019 includes a floor-retaining flange 2026 and a connecting web 2025 as shown in FIG. 26. Connecting web 2025 is coupled to bottom portion 2024 of side wall 2018 and arranged to extend radially away from bottom portion 2024 toward interior region 2014. Floor-retaining flange 2026 is coupled to connecting web 2025 and is arranged to extend in upward direction 2030 toward floor 2020 and interior region 2014. Together, floor-retaining flange 2026, connecting web 2025, and bottom portion 2024 cooperate to define receiving well 2027 therebetween. As suggested in FIG. 26, a portion of floor 2020 is arranged to extend downwardly into receiving well 2027 and be retained between floor-retaining flange 2026 and bottom portion 2024. In the illustrative embodiment of FIG. 26, platform-support member 2023 of floor 2020 extends completely into receiving well 2027 and contacts connecting web 2025.

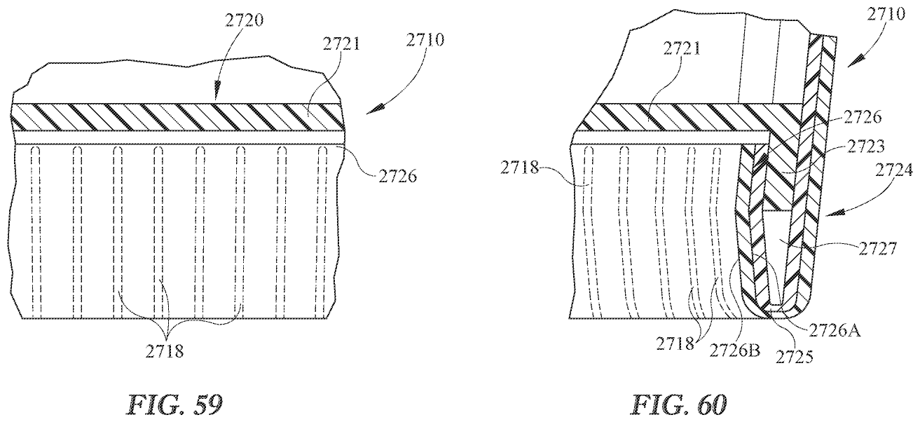

In another embodiment shown in FIGS. 59 and 60, a cup 2710 is similar to insulative cup 2010, but a floor 2720 includes a floor platform 2721 and a floor ring 2723 that is shorter than platform-support member 2023 of insulative cup 2010. Floor ring 2723 does not extend completely into a receiving well 2727 formed between a retaining flange 2726, connecting web 2725, and bottom portion 2724. This approach allows floor 2720 to be positioned during the cup-manufacturing process 2040 without need for closely holding the dimensional length of floor ring 2723 and reducing the chance for interference during cup-manufacturing process 2040.

As shown in FIGS. 24, 25, 37C, and 34, floor 2020 includes horizontal platform 2021 and a platform-support member 2023. Horizontal platform 2021 is, for example, a flat round disc which cooperates with side wall 2018 to define interior region 2014 therebetween. Platform-support member 2023 is coupled to a perimeter of horizontal platform 2021 and is arranged to extend in downward direction 2028 away from horizontal platform 2021 toward and into receiving well 2027. As a result, horizontal platform 2021 is spaced apart from any surface on which insulative cup 2010 rests.

The compressibility of the insulative cellular non-aromatic polymeric material of the multi-layer sheet 2080 used in accordance with the present disclosure to produce insulative cup 2010 allows the insulative cellular non-aromatic polymeric material to be prepared for the mechanical assembly of insulative cup 2010, without limitations experienced by other polymeric materials. The cellular nature of the insulative cellular non-aromatic polymeric material disclosed herein provides insulative characteristics as discussed below, while susceptibility to plastic deformation permits yielding of the insulative cellular non-aromatic polymeric material without fracture. The plastic deformation experienced when multi-layer sheet 2080 is subjected to a pressure load is used to form a permanent set in the insulative cellular non-aromatic polymeric material after the pressure load has been removed. In some locations, the locations of the permanent set are positioned in illustrative embodiments to provide, for example, controlled gathering of the insulative cellular non-aromatic polymeric material.

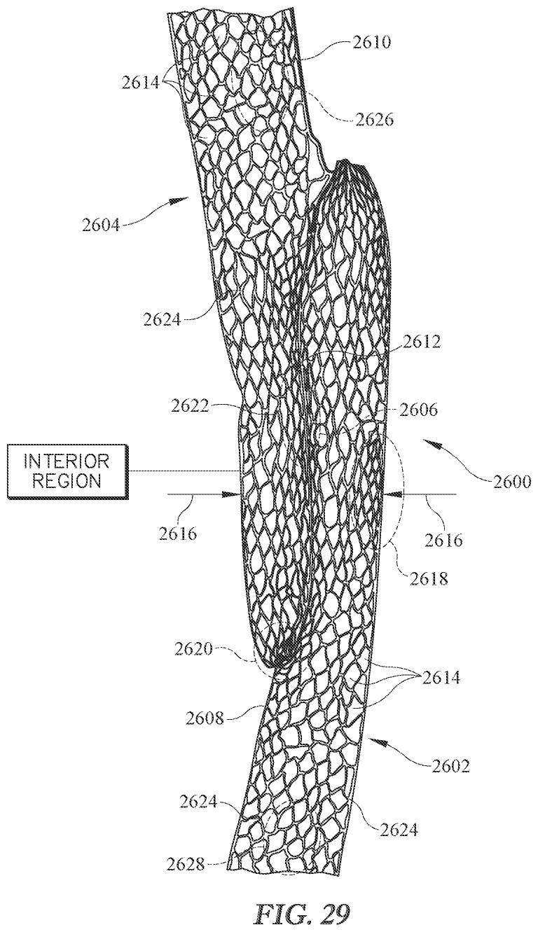

Plastic deformation may also be used to create fold lines in multi-layer sheet 2080 to control deformation of the material when being worked during a cup assembly process. When deformation is present, the absence of material in the voids formed by the deformation provides relief to allow the material to be folded easily at the locations of deformation. Referring now to FIGS. 28A and 29, an exemplary joint 2600 between two portions 2602 and 2604 of insulative cellular non-aromatic polymeric material includes an interface 2606. Interface 2606 includes contact between a surface 2608 of portion 2602 and a surface 2610 of portion 2604, where the surfaces have adhered to one another to create a seal and a mechanical interlock between portions 2602 and 2604. The interface includes a melt line 2612 where the non-aromatic polymeric material of each portion 2602 and 2604 have commingled to secure to one another.

Portion 2602 illustratively includes a structure of cells 2614 that are enclosed by a non-aromatic polymeric material 2624 with the cells 2614 closed to encapsulate a blowing agent comprising a gas such as CO2, for example. When pressure is applied at a location 2616, localized areas 2618, 2620, 2622 of reduced cell size are created as the cells 2614 are reduced in size and the non-aromatic polymeric material 2624 flows to alter the shape of the cells 2614. The flow of non-aromatic polymeric material 2624 results in more non-aromatic polymeric material 2624 being contained within a unit of volume than in undeformed areas such as areas 2626 and 2628, for example. Thus, when a sufficient load is applied, the thickness of the insulative cellular non-aromatic polymeric material is reduced and the density in localized areas is increased.

In some instances, plastic deformation is achieved with a combination of force and heat. Heating the insulative cellular non-aromatic polymeric material may reduce the force necessary to deform the material. Localized heating results in softening that permits plastic flow, at lower forces, to accomplish the desirable permanent set. This permits deformation of the cells to achieve a thinner, denser material in localized areas in the insulative cellular non-aromatic polymeric material.

In one illustrative embodiment, the present disclosure provides a strip 2652 of insulative cellular non-aromatic polymeric material having predominantly closed cells 2614 dispersed in the insulative cellular non-aromatic polymeric material 2624 that exhibits unexpected, desirable physical properties at a given material thickness. Such properties include, for example, insulative properties, strength/rigidity properties, and puncture resistance properties. The illustrative material may be provided in a form such as, for example, an insulative cellular non-aromatic polymeric material sheet, strip, tube, thread, pellet, granule or other structure that is the result of extrusion of a polymer-based formulation, as herein described, through an extruder die. As described herein, multi-layer sheet 2080 comprises a film layer 2056 and polymeric-lamination layer 2054 to establish multi-layer sheet 2080 as well as a variety of final products such as cups or insulative containers, wraps, wound rolls of material, and the like.

In one embodiment shown in FIG. 61, multi-layer sheet 2080 includes insulative cellular non-aromatic polymeric material 2082, a skin 2083 including film layer 2056 and ink layer 2066, and polymeric-lamination layer 2054 extending between and interconnecting skin 2081 and insulative cellular non-aromatic polymeric material 2082. As an example, ink layer 2066 may be printed on film layer 2056 prior to coupling the skin to insulative cellular non-aromatic polymeric material 2052. In the illustrative embodiment of FIG. 61, film 2056 comprises HDPE.

In another embodiment shown in FIG. 62, a sheet 2180 is similar to sheet 2080 but includes polymeric-lamination layer 2054, ink layer 2066, and film layer 2056 on both sides of a strip of insulative cellular non-aromatic polymeric material 2082. In other embodiments, ink layer(s) 2066 may be omitted on one or both sides.

In illustrative embodiments, an insulative cup is assembled from components that are formed from a material that is insulative. The insulative material includes a cellular non-aromatic polymeric structure that is tough and rigid. The insulative cellular non-aromatic polymeric material is deformable plastically under pressure load such that the material takes a permanent set after the pressure load has been removed to create structural features facilitating the formation of the insulative cup. In some embodiments, orderly gathering of the material when folded or deformed is facilitated by the structure of the insulative cellular non-aromatic material. In illustrative embodiments, the insulative cellular non-aromatic polymeric material is flexible to permit the cup to be used in sub-freezing temperatures without fracturing the material. As used herein, the term non-aromatic polymer refers to a polymer that is devoid of aromatic ring structures (e.g., phenyl groups) in its polymer chain.

Aromatic molecules typically display enhanced hydrophobicity when compared to non-aromatic molecules. As a result, it would be expected that changing from a polystyrene-based insulative cellular polymeric material to a polypropylene-based insulative cellular polymeric material would result in a change in hydrophobicity with a concomitant, but not necessarily predictable or desirable, change in surface adsorption properties of the resulting material. In addition, by virtue of the hydrocarbon chain in polystyrene, wherein alternating carbon centers are attached to phenyl groups, neighboring phenyl groups can engage in so-called pi-stacking, which is a mechanism contributing to the high intramolecular strength of polystyrene and other aromatic polymers. No similar mechanism is available for non-aromatic polymers such as polypropylene. Moreover, notwithstanding similar chemical reactivity and chemical resistance properties of polystyrene and polypropylene, polystyrene can be either thermosetting or thermoplastic when manufactured whereas polypropylene is exclusively thermoplastic. As a result, to the extent that surface adsorption properties, manufacturing options, and strength properties similar to those of polystyrene are sought, likely alternatives to polystyrene-based insulative cellular polymeric materials would be found in another aromatic polymer rather than in a non-aromatic polymer.

In illustrative embodiments, the insulative cellular non-aromatic polymeric material is used as a substrate in a composite sheet that includes a film laminated to the insulative cellular non-aromatic polymeric material. In some embodiments, the film is reverse printed before being laminated to the substrate so that the printing is visible through the film, with the film forming a protective cover over the printing. In some other embodiments, the ink layer 2066 forms outer surface 2106.

In illustrative embodiments, the insulative cellular non-aromatic polymeric material may include one or more polyethylene materials as a base material. The laminated film may also comprise polyethylene so that the entire cup may be ground up and re-used in the same process.

As an example, a polymeric formulation for forming insulative cellular non-aromatic polymeric material 2082 comprises a base resin blend comprising a high density polyethylene (HDPE), a low density polyethylene (LDPE), or a combination thereof. In some embodiments, the formulation may comprise cell-forming agents including a chemical nucleating agent, a physical blowing agent, or a combination thereof.

In some embodiments, the HDPE may be a homopolymer, a copolymer, an enhanced polyethylene, combinations thereof, or any suitable alternative. One exemplary HDPE described herein is DMDA 8007 by Dow Chemical.

In some embodiments, the LDPE may be a homopolymer. In another embodiment, the LDPE may be a copolymer. One exemplary LDPE described herein is LDPE 621i by Dow Chemical.

Process additives, such as slip agents, antiblock agents, or antistatic agents may be added to the formulations to improve the extrusion process and provide additional properties of multi-layer sheet 2080. Colorants in the form of masterbatches may also be added the formulation for each of the layers.

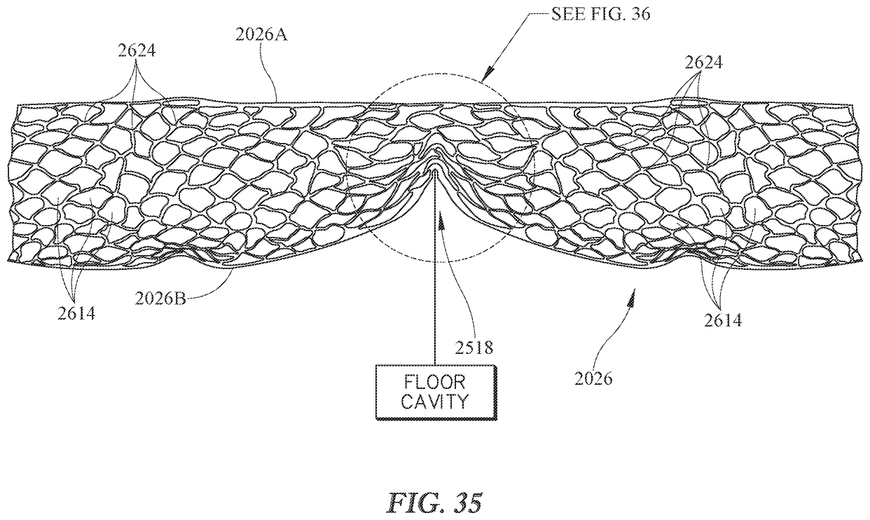

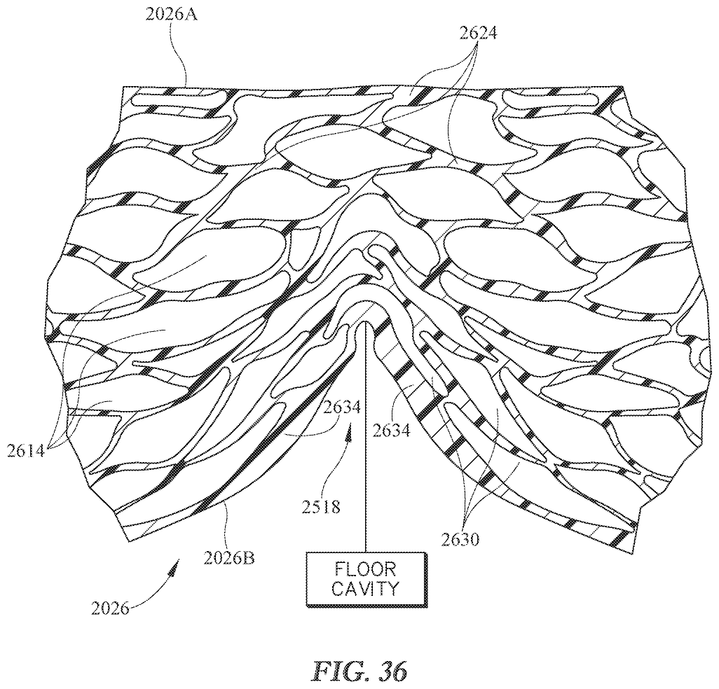

As suggested in FIGS. 35 and 36, the density of the insulative cellular non-aromatic polymeric material is indirectly proportional to the change in thickness of the material. As an example, if the material thickness is reduced by half, then the density in the compressed area would about double.

Strip 2082 of insulative cellular non-aromatic polymeric material is used form insulative cup 2010. Insulative cup 2010 includes, for example, body 2011 and floor 2020 as shown in FIG. 24. Body 2011 includes side wall 2018 and floor mount 2017, which is coupled to floor 2020 to support floor 2020 in a stationary position relative to sleeve-shaped side wall 2018. Floor mount 2017 includes floor-retaining flange 2026 coupled to floor 2020, web-support ring 2126 coupled to the lower end of sleeve-shaped side wall 2018 and arranged to surround floor-retaining flange 2026, and connecting web 2025 arranged to interconnect floor-retaining flange 2026 and web-support ring 2126 as suggested in FIG. 27C.

As shown in FIG. 32, floor-retaining flange 2026 includes an inner surface 2026A and an outer surface 2026B. Inner surface 2026A is arranged to face toward platform-support member 2023 and outer surface 2026B is arranged to face opposite inner surface 2026A. Floor-retaining flange 2026 is further formed to include a series of spaced-apart depressions 2518 formed in outer surface 2026B. As an example, each depression 2518 is linear having a longitudinal axis that overlies a ray emanating from a center 2510 as shown in FIG. 37A. In another example, depressions may be angular, diamond shaped, or one or more combinations thereof.

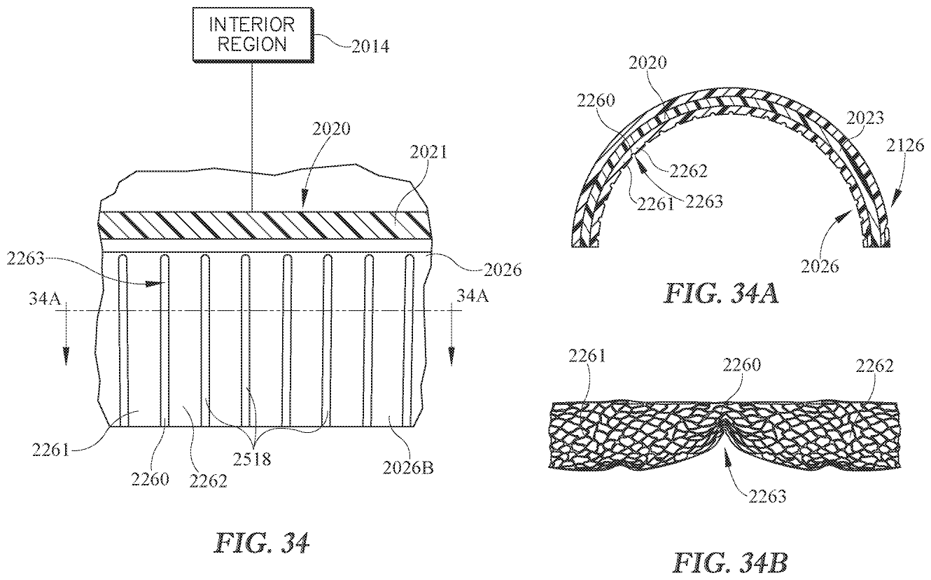

The resultant effect of the formation of depressions 2518 on the insulative cellular non-aromatic polymeric material is shown in FIGS. 34B, 35, 36, and 39. Depressions 2518 are formed in surface 2026B and some cells 2630 are reduced as the insulative cellular non-aromatic polymeric material is worked so that the insulative cellular non-aromatic polymeric material takes a permanent set to form the depressions 2518. The material 2624 flows in the area of material flow such that cell walls 2632 of cells 2630 are thinned while the skin 2634 thickens in some areas. In the illustrative embodiment of FIGS. 35 and 36, the tool forming depressions 2518 has been heated so that there is some melting of the material 2624, which causes the flow to thickened areas 2634.

As shown in FIGS. 24, 25, 26, and 27C, side wall 2018 is formed to include a side wall seam 2034 during an exemplary embodiment of cup-manufacturing process 2040 illustrated in FIG. 40. Side wall 2018 has a first wall thickness T1 which is present in both bottom portion 2024 and retaining flange 2026. Side wall 2018 has a second wall thickness T2 that is present at side wall seam 2034. As shown in FIG. 30, thickness T2 is about equal thickness T1 as a result of compression of edges (inner and outer tabs) 2514, 2512 (seen in FIG. 37A) during cup-manufacturing process 2040. As a result, each tab 2514, 2512 has a third wall thickness T3 that is about 50% of thicknesses T1, T2. Connecting web 2025 also has an illustrative third wall thickness T3 as a result of compression during cup-manufacturing process 2040. The connecting web 2025 may have a different thickness, other than thickness T3, in some embodiments. For example, the extent of the compression of connecting web 2025 may be different from the extent of the compression of edges 2512 and 2514. Likewise, the extent of compression of one or the other of edges 2512 and 2514 may be different, depending on application requirements.

In another exemplary embodiment, the side wall is not compressed about the first and second edges. As a result, a thickness T2 may be greater than thickness T1. In one example where compression does not occur, thickness T2 may be about twice thickness T1.

In another exemplary embodiment, just one edge is compressed. Further, in another embodiment, a portion of one or both edges is compressed.

Side wall seam 2034 continues up base 2012 and into rolled brim 2016 as shown in FIGS. 26 and 27B. As a result, rolled brim 2016 has a first brim dimension B1 and a relatively equal second brim dimension B2 at the side wall seam 2034. The thickness of the material at the brim B3 is about equal to both first wall thickness T1 and second wall thickness T2. As shown in FIG. 30, brim dimension B2 is about equal to brim dimension B1 as a result of compression of first and second edges 2512, 2514 during cup-manufacturing process 2040. As a result, each edge 2512, 2514 in rolled brim 2016 has a third brim thickness B3 that is about 50% of thicknesses B1, B2.

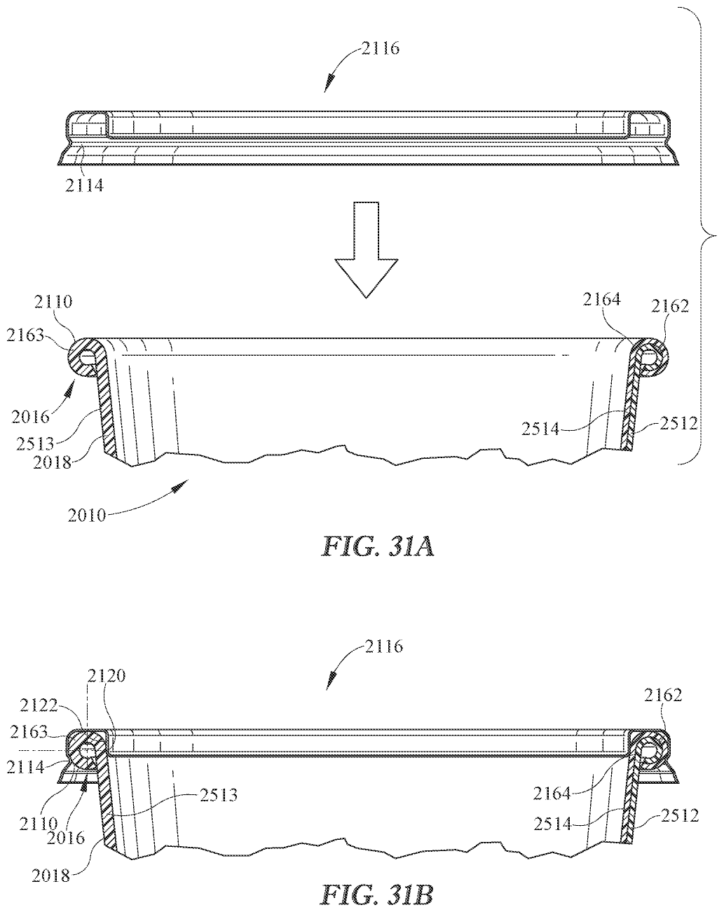

The compression of first and second edges 2512, 2514 permits brim dimension B2 to match brim dimension B1, regardless of the brim geometry. As will be discussed in further detail below, the shape of the brim may vary from the geometry of brim 2016 in other embodiments. Brim 2016 is configured to serve as both a drinking brim and a sealing brim. As seen in FIG. 30, an inner surface 2108 of side wall 2018 tangentially intersects an outer diameter 2110 of brim 2016 at a point 2112 while an outer surface 2106 terminates at brim 2016. Transition point 2112 provides a smooth transition for a flow of liquid if a user were to drink from insulative cup 2010, without spilling or disrupting flow over brim 2016. Referring now to FIGS. 31A and 31B, brim 2016 also serves to cooperate with a retainer 3114 of a lid 3116 to secure lid 3116 to insulative cup 10 with a liquid seal so that a user may use a drinking spout 2118 of lid 2316 without having liquid escape between lid 2116 and brim 2016. Retainer 2114 snaps over and engages diameter 2110 of brim 2016 so that a flange 2122 of lid 2116 engages diameter 2110 at a point 2120 to seal lid 2116 to insulative cup 2010.

Alternative embodiments of a rolled brim are disclosed in FIGS. 56-58 and each embodiment may be substituted for rolled brim 2016. For example, rolled brim 2016A shown in FIG. 56 has a constant thickness of insulative cellular non-aromatic polymeric material with dimensions X1, X2, and X3 being generally equal, but with a brim thickness B4 that is greater than the brim thickness B1 of insulative cup 2010. A larger brim thickness B4 provides clearance in the interior space 2900 of brim 2016A, improving the manufacturability of brim 2016A by allowing clearance during brim rolling.

A rolled brim 2016B has wall thickness X1 that is reduced and thinned during the brim rolling process that results in a reduction at X2 and a further reduction at X3 as shown in FIG. 57. Brim 2016B is relatively easier to manufacture than brim 2016A and provides a brim with a brim thickness B5 that is approximately the same as brim thickness B4, but has a brim height B6 that is larger than B5. This results in additional relief in an interior space 2904 of brim 2016B. Brim 2016B is more suitable for use with lids by providing additional contact area for sealing.

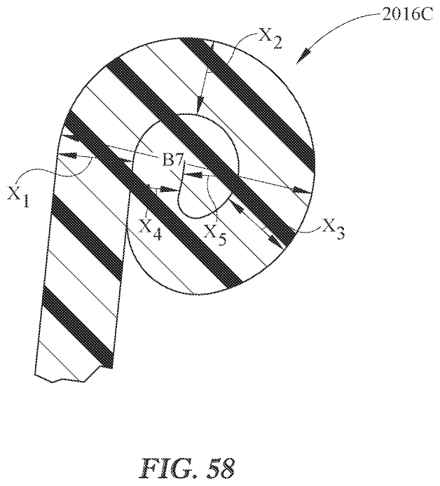

In still another embodiment, rolled brim 2016C approximates a solid brim with a first wall dimension X1 that is reduced to X2, further reduced at X3, and rolled about itself at X4 and X5 as shown in FIG. 58. With heating and or compression, brim 2016C provides a solid brim structure with a high rigidity due to the lack of relief in an interior space of brim 2016C. Such a brim is suitable for drinking and provides a rigidity that assists with maintaining a snap fit lid, such as lid 2116 in place during use. In the embodiment of FIG. 58, the brim thickness B7 is approximately equal to brim thickness B1 in insulative cup 2010.

Side wall 2018 is formed during cup-manufacturing process 2040 using a body blank 2500 as suggested in FIGS. 40-44. Body blank 2500 may be produced from multi-layer sheet 2080 as shown in FIG. 40 and discussed in further detail below, or a strip of insulative cellular non-aromatic polymeric material that has been printed on. Referring now to FIGS. 37A-C and 38, body blank 2500 is generally planar with a first side 2502 and a second side 3504 (seen in FIG. 69A-C). Body blank 2500 is embodied as a circular ring sector with an outer arc length S1 that defines a first edge 2506 and an inner arc length S2 that defines a second edge 2508. The arc length S1 is defined by a subtended angle Θ in radians times the radius R1 from an axis 2510 to the edge 2506. Similarly, inner arc length S2 has a length defined as subtended angle Θ in radians times the radius R2. The difference of R1-R2 is a length h, which is the length of two linear edges 2512 and 2514. Changes in R1, R2, and Θ can result in changes in the size of insulative cup 2010. First linear edge 2512 and second linear edge 2514 each lie on a respective ray emanating from center 2510. Thus, body blank 2500 has two planar sides, 2502 and 2504, as well as four edges 2506, 2508, 2512, and 2514 which define the boundaries of body blank 2500. The edges 2512 and 2514 may correspond to and have treatments as described below.

Fold line 2516 has a radius R3 measured between center 2510 and a fold line 2516 and fold line 2516 has a length S3. As shown in FIG. 37A, R1 is relatively greater than R3. R3 is relatively greater than R2. The differences between R1, R2, and R3 may vary depending on the application.

Fold line 2516 shown in FIG. 37A is a selected region of a strip of insulative cellular non-aromatic polymeric material that has been plastically deformed in accordance with the present disclosure (by application of pressure—with or without application of heat) to induce a permanent set resulting in a localized area of increased density and reduced thickness. The thickness of the insulative cellular non-aromatic polymeric material at fold line 2516 is reduced by about 50% as shown in FIG. 37A. In addition, the blank is formed to include a number of depressions 2518 or ribs 2518 positioned between the arcuate edge 2508 and fold line 2516 with the depressions 2518 creating a discontinuity in a surface 2531. Each depression 2518 is linear having a longitudinal axis that overlies a ray emanating from center 2510. As discussed above, depressions 2518 promote orderly forming of floor-retaining flange 2026. The insulative cellular non-aromatic polymer material of reduced thickness at fold line 2516 ultimately serves as connecting web 2025 in the illustrative insulative cup 2010. As noted above, connecting web 2025 promotes folding of floor-retaining flange 2026 inwardly toward interior region 2014. Due to the nature of the insulative cellular non-aromatic polymeric material used to produce illustrative body blank 2500, the reduction of thickness in the material at fold line 2516 and depressions 2518 owing to the application of pressure—with or without application of heat—increases the density of the insulative cellular non-aromatic polymeric material at the localized reduction in thickness.

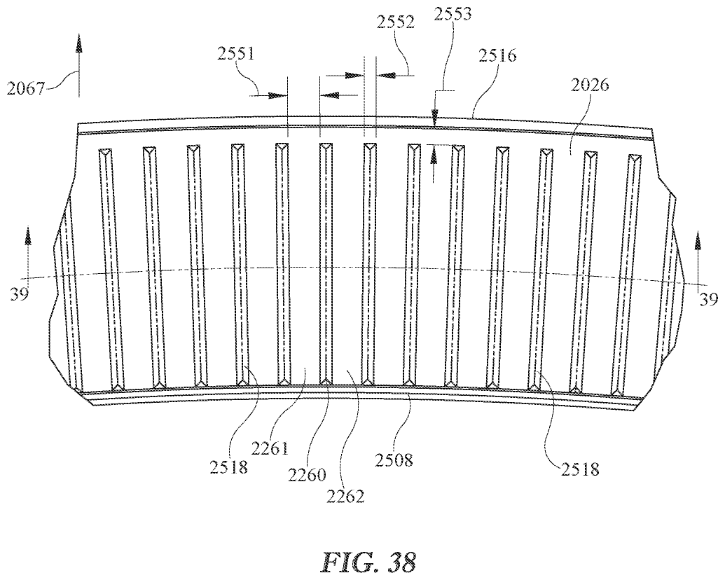

As shown in FIG. 38, each depression 2518 is spaced apart from each neighboring depression a first distance 2551. In an illustrative example, first distance 2551 is about 0.067 inches (1.7018 mm). Each depression 2518 is also configured to have a first width 2552. In an illustrative example, first width 2552 is about 0.028 inches (0.7112 mm). Each depression 2518 is also spaced apart from fold line 2516 a second distance 3553. In an illustrative example, second distance 2553 is about 0.035 inches (0.889 mm).

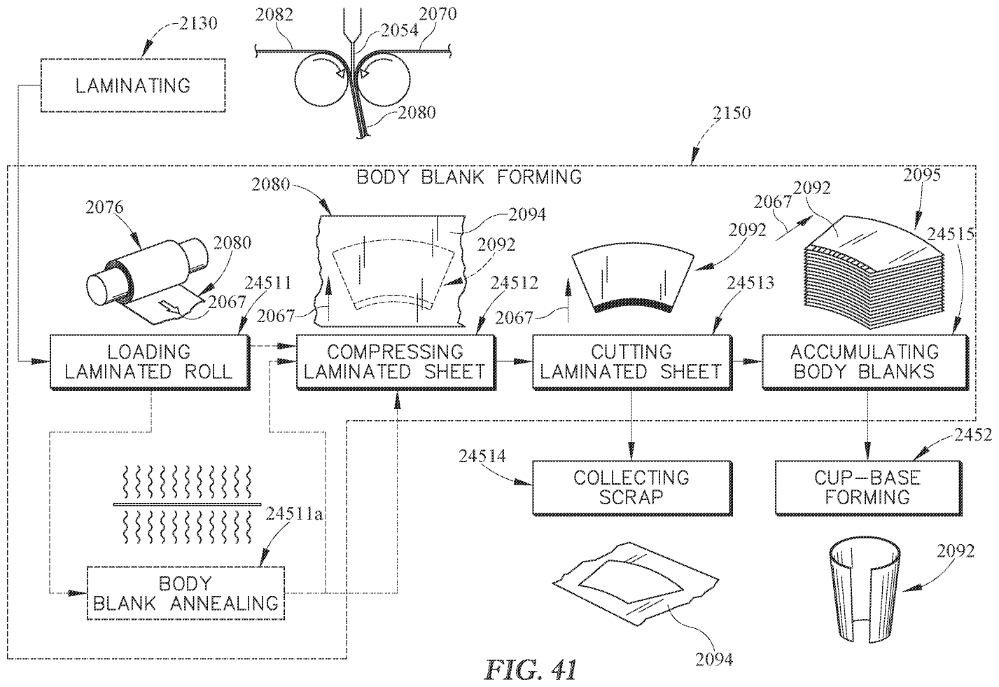

Depressions 2518 and fold line 2516 are formed by a die that cuts body blank 2500 from multi-layer sheet 2080, or a strip of printed-insulative cellular non-aromatic polymeric material and is formed to include punches or protrusions that reduce the thickness of the body blank 2500 in particular locations during the cutting process. The cutting and reduction steps could be performed separately as suggested in FIG. 41, performed simultaneously, or that multiple steps may be used to form the material. For example, in a progressive process, a first punch or protrusion could be used to reduce the thickness a first amount by applying a first pressure load. A second punch or protrusion could then be applied with a second pressure load greater than the first. In the alternative, the first punch or protrusion could be applied at the second pressure load. Any number of punches or protrusions may be applied at varying pressure loads, depending on the application.

As shown in FIGS. 32-36, depressions 2518 permit controlled gathering of floor-retaining flange 2026 supporting a platform-support member 2023 and horizontal platform 2021. Floor-retaining flange 2026 bends about fold line 2516 to form receiving well 2027 with fold line 2516 forming connecting web 2025. The absence of material in depressions 2518 provides relief for the insulative cellular non-aromatic polymeric material as it is formed into floor-retaining flange 2026. This controlled gathering can be contrasted to the bunching of material that occurs when materials that have no relief are formed into a structure having a narrower dimension. For example, in traditional paper cups, a retaining flange type will have a discontinuous surface due to uncontrolled gathering. Such a surface is usually worked in a secondary operation to provide an acceptable visual surface, or the uncontrolled gathering is left without further processing, with an inferior appearance. The approach of forming the depressions 2518 in accordance with the present disclosure is an advantage of the insulative cellular non-aromatic polymeric material of the present disclosure in that the insulative cellular non-aromatic polymeric material is susceptible to plastic deformation in localized zones in response to application of pressure (with or without application of heat) to achieve a superior visual appearance.

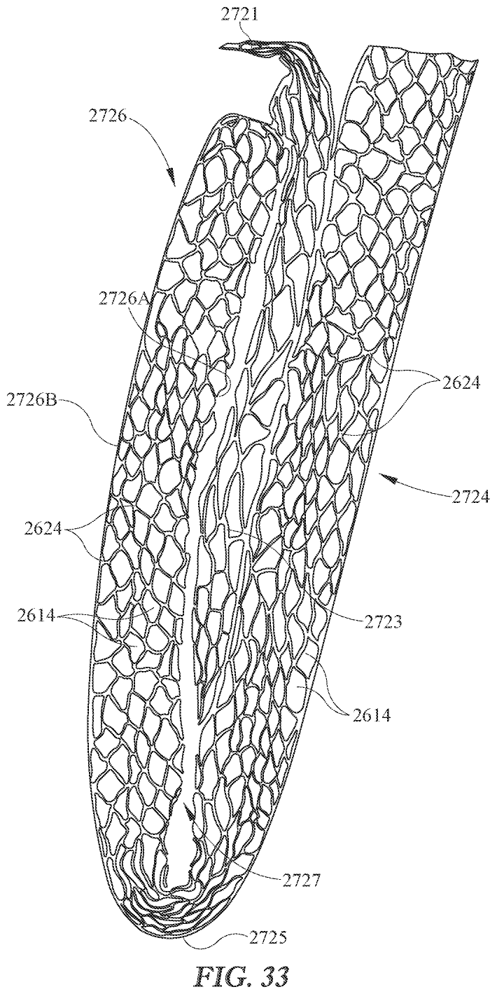

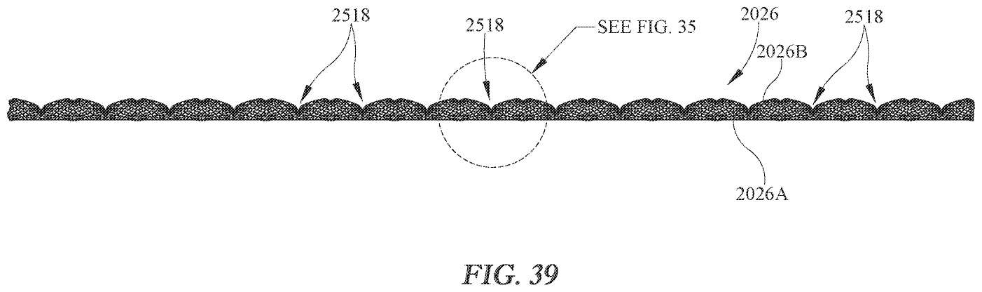

Referring again to the embodiment of FIGS. 39 and 40, cup 2710 is similar to insulative cup 2010, but cup 2710 is formed with depressions 2718 formed on a surface 2726A, which corresponds to the surface 2026A of insulative cup 2010. Depressions 2718 being formed on surface 2726A leaves a smooth, un-interrupted surface 2726B. Referring now to FIGS. 32A and 33, the interaction of retaining flange 2726 and bottom portion 2724 with floor ring 2723 is shown as photographed to show the thickening and thinning of non-aromatic polymeric material 2624 and distortion of cells 2614 as the cup 2710 is assembled.

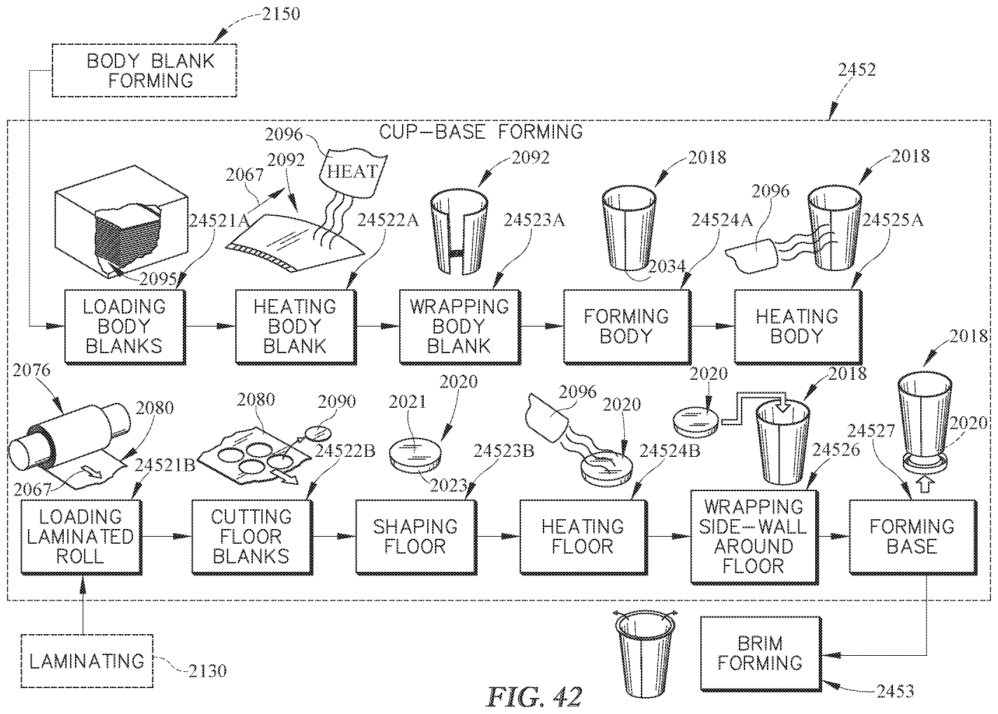

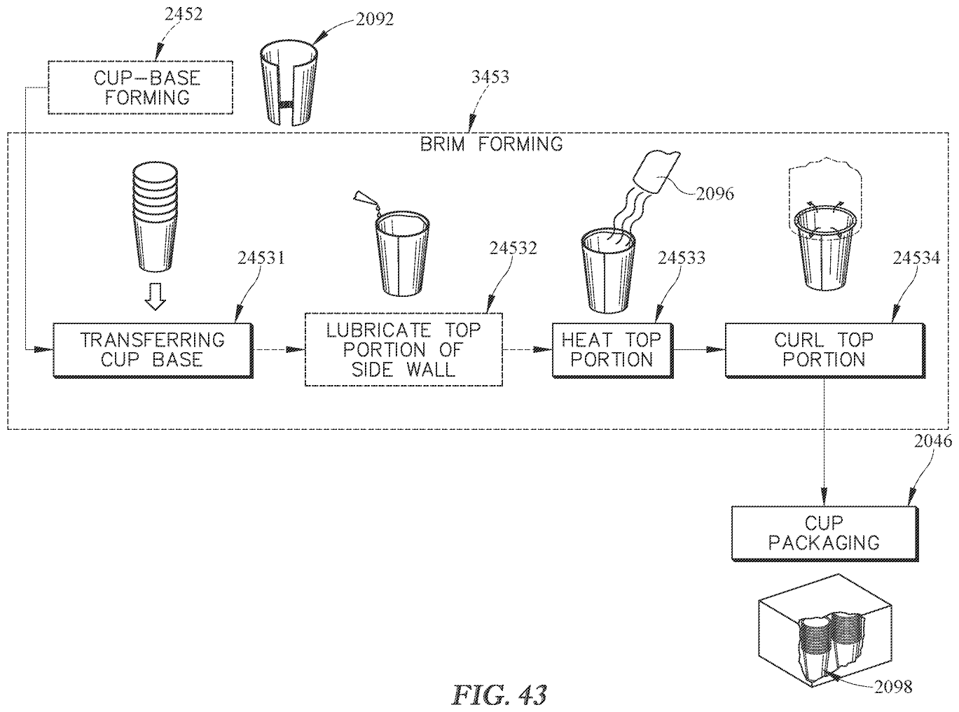

As one illustrative example of a method of manufacturing, insulative cup 2010 is made in accordance with cup-manufacturing process 2040 as shown in FIGS. 40-44. As shown in FIGS. 40 and 41, multi-layer sheet 2080 is a composite formed of a strip of insulative cellular non-aromatic polymeric material 2082 and film layer 2056 is laminated using polymeric-lamination layer 2054 at laminating stage 2130. Roll 2076 of laminated sheet 2080 is fed to the cup-forming stage 2170. Cup-forming stage 2170 illustratively includes a body blank forming step 2150, an optional body blank annealing step 2451a, a cup-base forming step 2452, and a brim-forming step 2453 as shown in FIG. 40. Body blank forming step 2150 uses laminated sheet 2080 to make a body blank 2500 as shown in FIG. 41. Cup-base forming step 2452 uses side wall blanks 2092 along with another laminated sheet 2080 provided by another laminated roll 2076 to form a floor blank 2090, form side wall 2018, and join side wall 2018 to floor 2020 to establish base 2012 as shown in FIG. 42. Brim-forming step 2453 rolls top portion 2022 of base 2012 to form rolled brim 2016 on base 2012 as suggested in FIG. 43.

An unexpected property of multi-layer sheet 2080 including a strip of insulative cellular non-aromatic polymeric material 2082 is its ability to form noticeably smooth, crease and wrinkle free surfaces when bent to form a round article, such as insulative cup 2010. Surface 2106 is smooth and wrinkle free as is surface 2108. The smoothness of the surfaces 2106 and 2108 of the present disclosure is such that the depth of creases or wrinkles naturally occurring when subjected to extension and compression forces during cup-manufacturing process 2040 is less than 100 micron and even less than 5 microns in most instances. At less than 10 microns, the creases or wrinkles are not visible to the naked eye.

Body blank forming step 2150 includes a laminated-roll loading step 24511, an optional annealing step 24511a, a compressing step 24512, a cutting step 24513, a collecting scrap step 24514, and an accumulating blanks step 24515 as shown in FIG. 41. Laminated-roll loading step 24511 loads laminated roll 2076 onto a cutting machine such as a die cutting machine or metal-on-metal stamping machine. As a result, laminated sheet 2080 is drawn into the cutting machine for processing. The optional annealing step 24511a heats laminated sheet 2080 as it moves to the cutting machine so that stresses in the non-aromatic polymer structure of laminated sheet 2080 are released to reduce creasing and wrinkling in surfaces 2106 and 2108 of insulative cup 2010. Compressing step 24512 compresses portions of laminated sheet 2080 to form a compressed sheet. As an example, compressing step 24512 forms fold line 2516 and depressions 2518 as shown in FIG. 37-C. Cutting step 24513 cuts compressed sheet to cause body blank 2092 to be cut from a blank-carrier sheet 2094. Collecting scrap step 24514 collects blank-carrier sheet 2094 after cutting step 24513 is complete so that blank-carrier sheet 2094 may be recycled, reprocessed, or reground. Accumulating blanks step 24515 accumulates each body blank 2500 to form a body blank stack 2095 for use in cup-base forming step 2452 as shown in FIG. 43.

Cup-base forming step 2452 includes a body blanks loading step 24521A, a heating body blank step 24522A, a wrapping body blank step 24523A, a forming side wall step 24524A, a laminated-roll loading step 24521B, a cutting floor blanks step 24522B, a shaping floor step 24523B, a heating floor step 24524B, a heating body step 24525A, a wrapping body step 24526, and a floor-seam forming step 24527 as shown in FIG. 42. Body blanks loading step 24521A loads body blank stack 2095 into a cup-forming machine for further processing. Heating body blank step 24522A applies heat 2096 to body blank 2500. Wrapping body blank step 24523A wraps heated body blank 2500 around a mandrel included in the cup-forming machine. Forming side wall step 24524A forms side wall 2018 by compressing portions of side wall 2018 using primary and auxiliary seam clamps included in the cup-forming machine. Primary and auxiliary seam clamps provide localize compression, which results in a portion of side wall 2018 having thickness T2 and another portion having thickness T1 as shown in FIG. 28. As an example, thickness T2 is about equal to thickness T1.

Laminated-roll loading step 24521B loads another laminated roll 2076 onto the cup-forming machine to cause laminated sheet 2080 to be drawn into cup-forming machine for processing. Cutting floor blanks step 24522B cuts laminated sheet 2080 to cause floor blank 2090 to be cut from a blank-carrier sheet 2094. Blank-carrier sheet 2094 may then be collected and recycled. Shaping floor step 24523B forms floor 2020 by inserting floor blank 2090 into the mandrel of the cup-forming machine. Heating floor step 24524B applies heat 2096 to floor 2020 at the same time heating body step 24525A applies heat 2096 to side wall 2018. Wrapping body 24526 wraps support structure 2019 around platform-support member 2023 of floor 2020. Floor-seam forming step 24527 compresses floor 2020 and side wall 2018 to establish a floor seam or seal between floor 2020 and side wall 2018 to establish base 2012 which is then ready for brim-forming step 2453 as shown in FIG. 43.

The cup-base forming step 2452 advantageously maintains the thickness T1 of the side wall 2018 as compared to a thermoforming process. Rather than heating an insulative cellular non-aromatic polymeric material and working it over a mandrel in the thermoforming process, subjecting portions of the wall of the resulting cup to thinning and potentially reducing the insulative and structural properties thereof, cup-base forming step 2452 is an assembly process that does not require the entire side wall 2018 to be subjected to melting temperatures. This provides the advantage of maintaining consistency in thickness T1 of side wall 2018 and, thereby, consistent and superior insulating properties as compared to vessels subjected to a deep draw thermoforming process.

Brim-forming step 2453 includes a transferring cup-base step 24531, an optional lubricating top-portion step 24532, heating top-portion step 24533, and rolling top-portion step 24534 as shown in FIG. 43. Transferring cup-base step 24531 transfers base 2012 from a cup-base forming machine to a brim-forming machine. Lubricating top-portion step 24532 lubricates top portion 2022 of base 2012. Heating top-portion step 24533 applies heat 2096 to top portion 2022 of base 2012. Curling top-portion step 23534 curls top portion 2022 away from interior region 2014 to establish rolled brim 2016 and form insulative cup 2010.

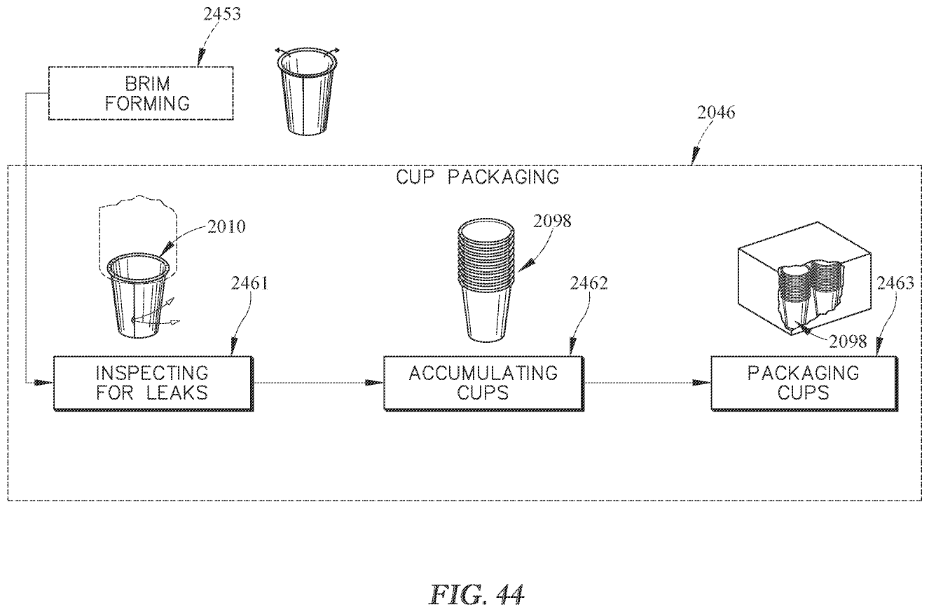

Cup-packaging stage 2046 includes a leak inspecting step 2461, an accumulating cups step 2462, and a packaging cups step 2463 as shown in FIG. 44. Leak inspecting step 2461 inspects each insulative cup 2010 formed during brim-forming step 2453 for leaks. Those cups failing the leak inspection are collected and recycled owing to the formation of those cups from the insulative cellular non-aromatic polymeric material. Those cups passing the leak inspection are accumulated in accumulating cups step 2462 to form a stack 2098 of insulative cups. Packaging cups step 2463 stores stack 2098 of insulative cups for storage, use, or transportation as shown in FIG. 44.

While the ability of insulative cellular non-aromatic polymeric material of the present disclosure to be subjected to plastic deformation under exposure to pressure loads (with or without application of heat) such that the material takes a permanent set has been discussed above, another embodiment of a body blank 2800 is shown in FIGS. 45 and 46. The body blank 2800 takes advantage of the properties of the disclosed insulative cellular non-aromatic polymeric material when two reduced areas 2802 and 2804 are formed in body blank 2800 to provide relief for the overlap of material when a brim, such as brim 2016 is rolled on a cup. Body blank 2800 is similar to body blank 2500, with the addition of the reduced areas 2802 and 2804. As shown in FIG. 45, areas 2802 and 2804 are reduced in thickness by about 50% so that when a cup is formed from body blank 2800, the thickness of the brim where areas 2802 and 2804 overlap is approximately the same as in areas where there is no overlap.

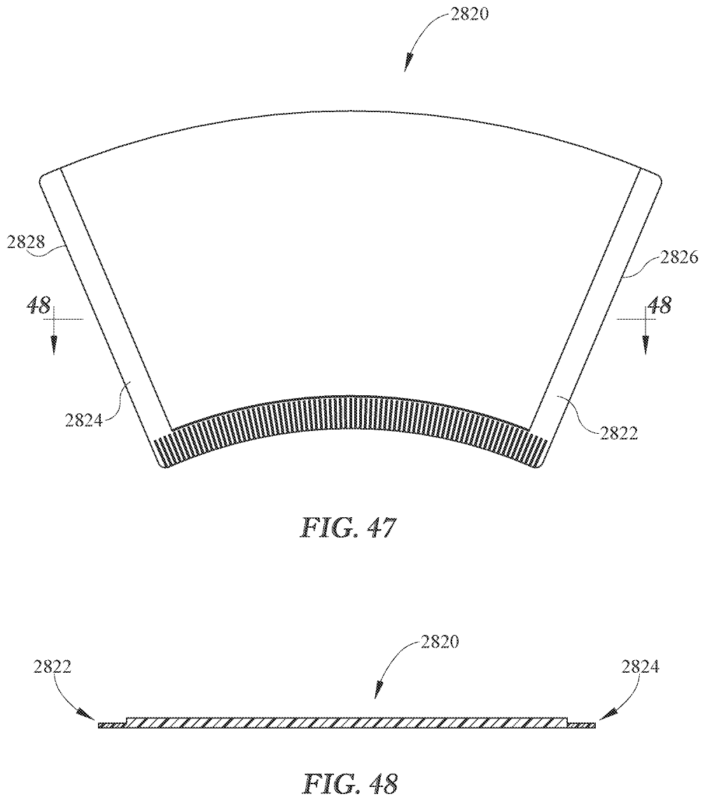

In another embodiment, a body blank 2820 includes reduced areas 2822 and 2824 along the linear sides 2826 and 2828 of the body blank 2820 as shown in FIGS. 47 and 48. Reduced areas 2822 and 2824 are reduced in thickness by about 50% so that when reduced areas 2822 and 2824 are overlapped during cup-manufacturing process 2040, the thickness at the overlapping seam is approximately the same as the remainder of the side wall of the cup formed from wall blank 2820.

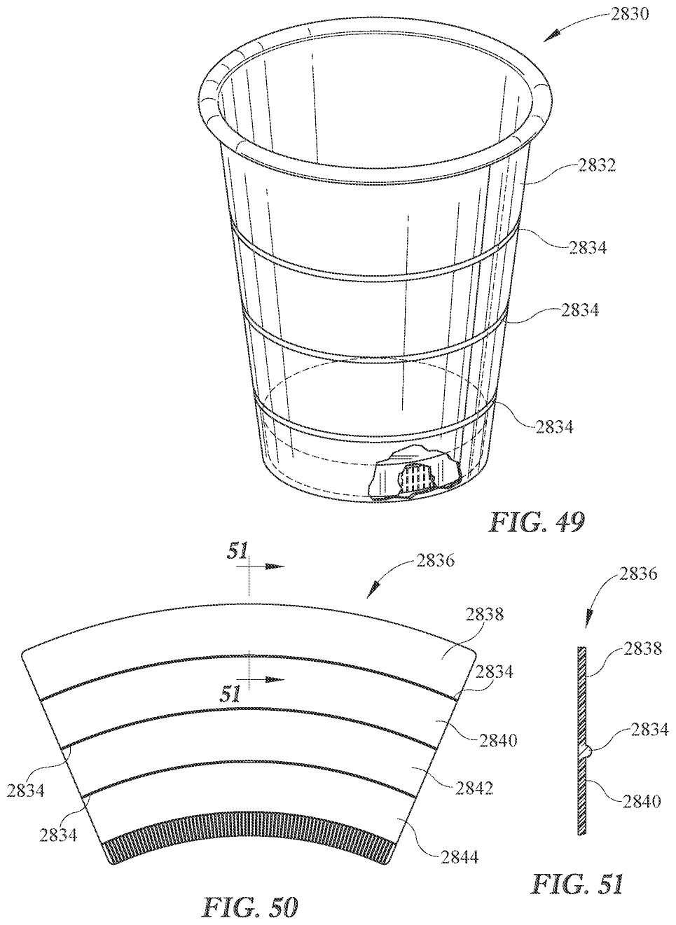

In yet another embodiment, a cup 2830 includes a side wall 2832, which is formed to include a number of ribs 2834 extending from a reduced area 2838 of side wall 2832 as shown in FIGS. 49-51. A body blank 2836 is reduced in areas 2838, 2840, 2842, and 2844 so that ribs 2834 extend away from the reduced areas 2838, 2840, 2842, and 2844. Ribs 2834 provide an air gap or spacing between a hand of user holding cup 2830 and the remainder of the side wall 2832, to reduce the contact area. Ribs 2834 may also be contacted by a sleeve (not shown) placed on cup 2830 to provide air gaps between the reduced areas 2838, 2840, 2842, and 2844 and the sleeve to insulate a user's hand.

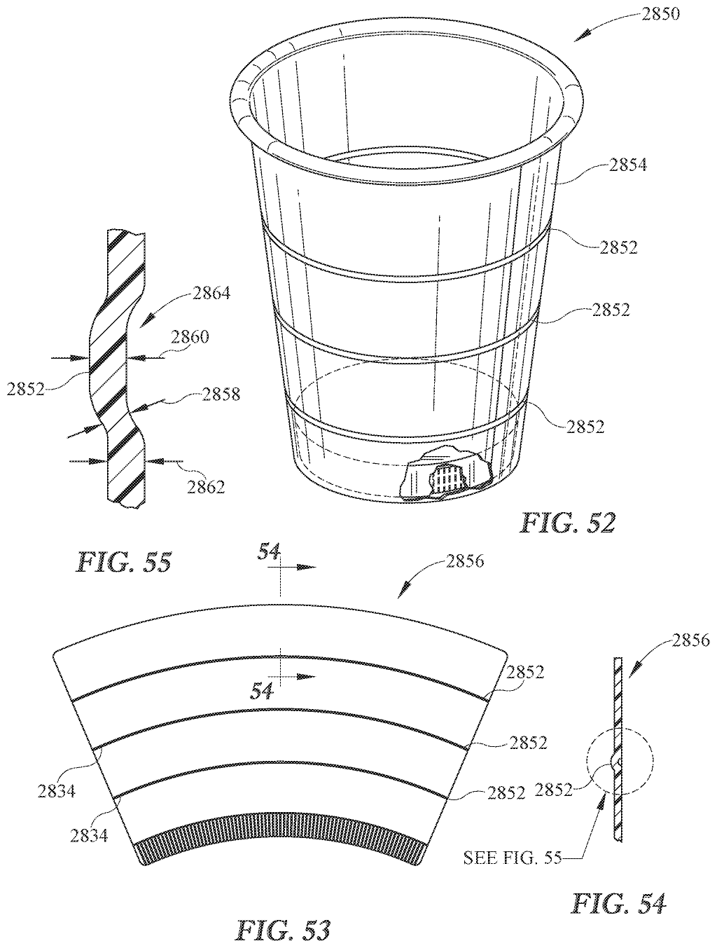

In still yet another embodiment, a cup 2850 shown in FIG. 52 includes ribs 2852 formed in a side wall 2854 through displacement of portions of a wall blank 2856, shown in FIG. 53, as suggested by FIGS. 54 and 55. In earlier embodiments, the insulative cellular non-aromatic polymeric material was plastically deformed to create a permanent set to reduce a thickness. In the illustrative cup 2850, the material is displaced by permitting relief when the strip of insulative cellular non-aromatic polymeric material is acted upon by pressure loads so that the material moves as suggested by FIGS. 54 and 55, the strip of insulative cellular non-aromatic polymeric material deforms to create depressions 2864 on one side and protruding ribs 2852 on the opposite side. The strip of insulative cellular non-aromatic polymeric material deforms such that some thinning occurs in an area 2858, while the thickness of the displaced wall 2860 remains approximately equal to the thickness 2862 of the side wall 2854. Protrusions 2852 serve a similar purpose as ribs 2834 discussed above with regard to cup 2830. The advantage of protrusions 2852 is that the thickness of side wall 2854 remains generally constant while continuing to provide the insulative properties of a full thickness wall and the advantages of ribs.

The embodiments discussed herein may be formed of a raw insulative cellular non-aromatic polymeric material or any variation of composites using the insulative cellular non-aromatic polymer material as disclosed herein. This includes embodiments that laminate one or both sides with a polymeric film.

In another exemplary embodiment of a cup-forming process, the cup-manufacturing process 2040 described hereinabove is modified by not laminating the film layer to the substrate. As a result, the film layer is entirely omitted and printing may done directly on the insulative cellular non-aromatic polymeric material layer.

The material of the present disclosure may also be formed into a deformable sheet, which can be wrapped around other structures. For example, a sheet of the present material may be formed and wrapped around a pipe, conduit or other structure to provide improved insulation.

A potential feature of an insulative cup formed of insulative cellular non-aromatic polymeric material according to exemplary embodiments of the present disclosure is that the cup has a low material loss.

Another potential feature of an insulative cup formed of insulative cellular non-aromatic polymeric material according to the present disclosure is that the cup can be placed in and go through a conventional residential or commercial dishwasher cleaning cycle (top rack) without noticeable structural or material breakdown or adverse effect on material properties. This is in comparison to beaded expanded polystyrene cups or containers, which can break down under similar cleaning processes. Accordingly, a cup made according to one aspect of the present disclosure can be cleaned and reused.

Another potential feature of an insulative cup formed of insulative cellular non-aromatic polymeric material according to various aspects of the present disclosure is that the insulative cup and scrap material can be recycled. Recyclable means that a material can be added (such as regrind) back into an extrusion or other formation processes without segregation of components of the material. As an example, an insulative cup formed the insulative cellular non-aromatic polymeric material does not have to be manipulated to remove one or more materials or components prior to re-entering the extrusion process.

In another example, an insulative cup formed from a sheet including a printed film skin laminated to an exterior of an insulative cellular non-aromatic polymeric material may be recyclable if one does not need to separate out the film layer prior to the insulative cup being ground into particles. In contrast, a paper-wrapped expanded polystyrene cup may not be recyclable because the polystyrene material could not practicably be used as material in forming an expanded polystyrene cup, even though the cup material may possibly be formed into another product.

As a further example, an insulative cup formed from a non-expanded polystyrene material having a layer of printed film adhered using an adhesive thereto may be considered non-recyclable because it would require the segregation of the film layer, which would not be desirable to introduce as part of the regrind into the extrusion process. Recyclability of articles formed using the insulative cellular non-aromatic polymeric material of the present disclosure minimizes the amount of disposable waste created. In comparison, beaded expanded polystyrene cups that break up into beads and thus ordinarily cannot be reused easily in a manufacturing process with the same material from which the article was formed. In addition, paper cups that typically have an extrusion coated plastic layer or a plastic lamination for liquid resistance ordinarily cannot be recycled because the different materials (paper, adhesive, film, plastic) normally cannot be practicably separated in commercial recycling operations.

A potential feature of an insulative cup formed of insulative cellular non-aromatic polymeric material according to one aspect (a non-laminate process) of the present disclosure is that the outside (or inside or both) wall surface of the insulative cellular polyethylene sheet (prior to being formed into an insulative cup, or during cup formation, depending on the manufacturing process employed) can accept printing of high-resolution graphics. In contrast, beaded expanded polystyrene cups have a surface which typically is not smooth enough to accept printing other than low-resolution graphics. Like beaded expanded polystyrene cups, uncoated paper cups also typically do not have a smooth enough surface for such high-resolution graphics. Paper cups have difficulty reaching insulation levels and require a designed air gap incorporated into or associated with the paper cup to achieve insulation. Such designed air gap may be provided by a sleeve slid onto and over a portion of the paper cup.

A potential feature of an insulative cup formed of insulative cellular non-aromatic polymeric material according to one aspect of the present disclosure is that it possesses unexpected strength as measured by rigidity and in particular rigidity at ambient temperature. Rigidity can be measured at elevated temperature (e.g., by filling the cup with a hot liquid), room temperature (e.g., by filling the cup with a room temperature liquid), or at a cool temperature (e.g., by filling the cup with a cold liquid). done at room temperature and at an elevated temperature and measuring the rigidity of the material. The strength of the cup material is important to minimize deformation of the cup as the cup is being handled by a user.

In some embodiments, cup 2010 sheet has a particular rigidity at ambient temperature when unfilled and unlidded. In some embodiments, cup 2010 has an ambient temperature rigidity of at least about 200 gf or at least 220 gf. In some embodiments, cup 2010 has a rigidity at ambient temperature of about 200 gf, about 210 gf, about 220 gf, about 230 gf, about 240 gf, about 250 gf, about 260 gf, about 275 gf, about 300 gf, about 325 gf, about 350 gf, about 375 gf, about 400 gf, about 425 gf, about 450 gf, about 475 gf, or about 500 gf. In some embodiments, the ambient temperature rigidity is within a range of about 200 gf to about 500 gf, about 200 gf to about 500 gf, about 200 gf to about 400 gf, or about 200 gf to about 300 gf. In a second set of ranges, the ambient temperature rigidity is about 200 gf to about 350 gf, about 220 gf to about 350 gf, about 240 gf to about 300 gf, or about 260 gf to about 300 gf.

When filled with a cold liquid, cup 2010 may minimize the amount of condensation formed on the outside of the cup. In some embodiments, the condensation gain percentage measured at 70° F./80% relative humidity for 30 minutes for an ice and soda filled cup 2010 is less than about 0.8%, less than about 0.6%, or less than about 0.5% by weight of the filled cup. The condensation weight gain may be about 0.1%, about 0.2%, about 0.3%, about 0.4%, about 0.5%, about 0.6%, or about 0.8% of the filled cup.

A potential feature of an insulative cup formed of insulative cellular non-aromatic polymeric material according to the present disclosure is that insulative cup is resistant to puncture, such as by a straw, fork, spoon, fingernail, or the like, as measured by standard impact testing, as described below. Test materials demonstrated substantially higher impact resistance when compared to a beaded expanded polystyrene cup. As a result, an insulative cup in accordance with the present disclosure may minimize the likelihood of puncture and leakage of liquid.

Insulative cup 2010 of the present disclosure satisfies a long-felt need for a vessel that includes many if not all the features of insulative performance, ready for recyclability, high-quality graphics, chemical resistance, puncture resistance, frangibility resistance, stain resistance, and resistance to leaching undesirable substances into products stored in the interior region of the drink cup as discussed above. Others have failed to provide a vessel that achieves combinations of these features as reflected in the appended claims. This failure is a result of the many features being associated with competitive design choices. As an example, others have created vessels that based on design choices are insulated but suffer from poor puncture resistance and leech undesirable substances into products stored in the interior region. In comparison, insulative cup 2010 overcomes the failures of others by using an insulative cellular non-aromatic polymeric material.

### EXAMPLES

### Example 1

### Formulation and Extrusion

A formulation comprised a base resin blend comprising DMDA 8007 HDPE available from Dow Chemical and 621i LDPE available from Dow Chemical. The base resin blend was combined with: Hydrocerol™ CF-40E™ as a chemical nucleating agent, HT60000 talc, available from Heritage Plastics, as a physical nucleating agent, and Ampacet 102823 as process aid. CO₂ was the physical blowing agent. Percentages were about:

| | |
|---|---|
| 75% | Dow DMDA 8007 HDPE |
| 23.55% | Dow 621i LDPE |
| 0.25% | Heritage Plastics HT60000 talc |
| 0.2% | Clariant CF-40E |
| 1% | AMPACET ™ 102823 |
| 0.73% | CO₂ physical blowing agent |

The formulation was added to an extruder hopper. The extruder heated the formulation to form a molten resin mixture. CO₂ was added to the molten resin mixture to expand the resin and reduce density. The formed mixture was extruded through a die head into a 0.05 inches thick strip.

A polymeric-lamination layer comprised Dow DMDA 8007 as a base resin. The base resin was blended with Ampacet J11 as the colorant.

Percentages by weight were:

| | |
|---|---|
| 95% | Dow DMDA 8007 HDPE |
| 5% | J11 colorant |

The formulation was added to an extruder hopper. The extruder heated the formulation to form a molten resin mixture. The molten mixture was extruded onto the extruded insulative cellular non-aromatic polymeric material described above to form a co-extruded sheet.

A 1 mil film comprising Dow Elite 5960G was coupled to the extruded polymeric-lamination layer of the co-extruded sheet to form a multi-layer sheet. Blanks were cut from the multi-layer sheet and used to form cups in accordance with the present disclosure.

### Example 2

### Material Properties

The extrusion laminated material from Example 1 was tested for density, closed cell count, rigidity, and condensation.

TABLE 1

| | | |
|---|---|---|
| Density | g/cm³ | 0.175 |
| Closed Cell | % | 85 |
| Cell Count | count/in³ | 2 MM |
| Ambient Unfilled - Unlidded | gf | 230 |
| Rigidity | | |
| Cold Filled - Lidded Rigidity | gf | 630 |
| Condensation (% Weight Gain) | % | 0.4 |
| [73° F., 34% RH] | | |

### Example 3

### Formulation and Extrusion

### Foam Formulation:

| | |
|---|---|
| 50% | Dow DMDA 8007 HDPE |
| 24.5% | Dow 621i LDPE |

| | |
|---|---|
| 25% | Regrind |
| 0.3% | Heritage Plastics HT60000 talc |
| 0.2% | Clariant CF-40E. |

The formulation was added to an extruder hopper. The extruder heated the formulation to form a molten resin mixture. CO₂ (1.2 wt % of the formulation) was added to the molten resin mixture to expand the resin and reduce density. The formed mixture was extruded through a die head into a 0.05 inches thick strip.

### Polymeric-Lamination Layer Formulation:

| | |
|---|---|
| 75% | Flint Hills |
| 25% | Dow 621i LDPE |

The formulation was added to an extruder hopper. The extruder heated the formulation to form a molten resin mixture. The molten mixture was extruded onto the extruded insulative cellular non-aromatic polymeric material described above to form a co-extruded sheet. A 1 mil film comprising Dow Elite 5960G was coupled to the extruded polymeric-lamination layer of the co-extruded sheet to form a multi-layer sheet.

The extrusion laminated material was tested for density, closed cell count, and aspect ratio.

TABLE 2

| Property | Unit | Sample 1 | Sample 2 |
|---|---|---|---|
| Density | g/cm³ | 0.21 | 0.21 |
| Closed Cell | % | 91.1 | 88.2 |
| Cell Count | count/in³ | 1,088,062 | 1,527,498 |
| Aspect Ratio | gf | ND | 2.45 |

### Example 4

### Foam Formulation:

| | |
|---|---|
| 75% | Dow DMDA 8007 HDPE |
| 24% | Dow 621i LDPE |
| 1% | colorant (white) |

The formulation was added to an extruder hopper. The extruder heated the formulation to form a molten resin mixture. CO₂ (1.2 wt % of the formulation) was added to the molten resin mixture to expand the resin and reduce density. The formed mixture was extruded through a die head into a 0.05 inches thick strip.

A 1-mil polymeric-lamination layer of Dow DMDA 8007 HDPE was extruded onto the extruded insulative cellular non-aromatic polymeric material described above to form a co-extruded sheet. A 1 mil film comprising Dow Elite 5960G was coupled to the extruded polymeric-lamination layer of the co-extruded sheet to form a multi-layer sheet.

### Example 5

### Foam Formulation:

| | |
|---|---|
| 75% | Dow DMDA 8007 HDPE |
| 24% | Dow 621i LDPE |
| 1% | colorant (white) |

The formulation was added to an extruder hopper. The extruder heated the formulation to form a molten resin mixture. CO₂ (1.2 wt % of the formulation) was added to the molten resin mixture to expand the resin and reduce density. The formed mixture was extruded through a die head into a 0.05 inches thick strip.

A 1-mil polymeric-lamination layer of Dow DMDA 8007 HDPE was extruded onto the extruded insulative cellular non-aromatic polymeric material described above to form a co-extruded sheet. A 1 mil film comprising Dow Elite 5960G was coupled to the extruded polymeric-lamination layer of the co-extruded sheet to form a multi-layer sheet.

### Example 6

### Foam Formulation:

| | |
|---|---|
| 75% | Dow DMDA 8007 HDPE |
| 24% | Dow 621i LDPE |
| 1% | colorant (white). |

The formulation was added to an extruder hopper. The extruder heated the formulation to form a molten resin mixture. CO₂ (1.2 wt % of the formulation) was added to the molten resin mixture to expand the resin and reduce density. The formed mixture was extruded through a die head into a 0.05 inches thick strip.

A 0.75 mil polymeric-lamination layer of Dow DMDA 8007 HDPE was extruded onto the extruded insulative cellular non-aromatic polymeric material described above to form a co-extruded sheet. A 1 mil film comprising Dow Elite 5960G was coupled to the extruded polymeric-lamination layer of the co-extruded sheet to form a multi-layer sheet.

### Example 7

The multi-layer sheets from Examples 4-6 were formed into cups and evaluated compared to a PP-foam cup. Each cup was be tested with 220 g ice then filled the remainder up to ¼″ of brim with soda conditioned at 73° F. The cups were lidded and straws placed into the cups. Each cup (and dish that holds cup) was be weighed (to the nearest mg) prior to placement in the environmental chamber. The cups were tested at 70° F./80% RH for 30 minutes. After the 30 minutes, the cups were be weighed again (to the nearest mg). The percent weight gain was tabulated. Results are shown below.

TABLE 3

| | Condensation weight |
|---|---|
| Sample | gain (%) |
| Control (PP foam) | 0.23 |
| Example 4 | 0.39 |
| Example 5 | 0.40 |
| Example 6 | 0.34 |

### Example 8

### Formulation and Extrusion

### Foam Formulation:

| | |
|---|---|
| 50% | Dow DMDA 8007 HDPE |
| 24.5% | Dow 621i LDPE |
| 25% | Regrind |
| 0.3% | Heritage Plastics HT60000 talc |
| 0.2% | Clariant CF-40E. |

The formulation was added to an extruder hopper. The extruder heated the formulation to form a molten resin mixture. CO₂ (1.1 wt % of the formulation) was added to the molten resin mixture to expand the resin and reduce density. The formed mixture was extruded through a die head into a strip.

A 1 mil polymeric-lamination layer of 96% polyethylene regrind of the laminate and 4% Milliken Ultrabalance Natural 1001 was extruded onto the extruded insulative cellular non-aromatic polymeric material described above to form a co-extruded sheet. A 1 mil film comprising Dow Elite 5960G was coupled to the extruded polymeric-lamination layer of the co-extruded sheet to form a multi-layer sheet. The multi-layer sheet had the properties shown in Table 4.

TABLE 4
Sheet Properties

| Density (g/cc) | Cell Count (count/in³) | Closed Cell (%) | Aspect Ratio |
|---|---|---|---|
| 0.170 | 1.09 × 10⁶ | 89.7 | 2.43 |

### Example 9

### Cup Formation

A cup was formed out of a multi-layer sheet similar to Example 8. The resulting cup had the properties shown in Table 5.

TABLE 5

| | | | | | Lid | |
|---|---|---|---|---|---|---|
| OD of | | | Rigidity | | Application | Cup Crush |
| the rim | Lid | Cup | (ambient) | Weight | Force | Force |
| (inches) | Leak | Leak | (gF) | (g) | (lbsF) | (lbsF) |
| 4.16 | Pass | Pass | 295.1 | 16.4 | 10.1 | 55.6 |

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint and that the range incorporates the endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods, equipment, and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods, equipment, and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

It will be apparent to those skilled in the art that various modifications and variations can be made without departing from the scope or spirit of the present disclosure. Other embodiments will be apparent to those skilled in the art from consideration of the specification and practice disclosed herein. It is intended that the specification and examples be considered as exemplary only.

It should further be noted that any publications and brochures referred to herein are incorporated by reference in their entirety.

1. A polymeric material comprising
a film layer,
an insulative cellular non-aromatic polymeric material comprising a high density polyethylene spaced apart from the film layer, and
a polymeric-lamination layer extending between and interconnecting the film layer and the insulative cellular non-aromatic polymeric material.
